(19) United States
(12) Patent Application Publication
(10) Pub. No.: US 2007/0087695 A1
(43) Pub. Date: Apr. 19, 2007

(54) Mobile directional antenna

(75) Inventors: Alexander J. Cohen, Mill Valley, CA (US); Edward K.Y. Jung, Bellevue, WA (US); Royce A. Levien, Lexington, MA (US); Robert W. Lord, Seattle, WA (US); John D. Rinaldo JR., Bellevue, WA (US); Clarence T. Tegreene, Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the state of Delaware

(21) Appl. No.: 11/396,367

(22) Filed: Mar. 31, 2006

Related U.S. Application Data
(63) Continuation-in-part of application No. 11/252,205, filed on Oct. 17, 2005.
(63) Continuation-in-part of application No. 11/252,206, filed on Oct. 17, 2005.
(63) Continuation-in-part of application No. 11/252,258, filed on Oct. 17, 2005.

(51) Int. Cl. H04B 1/00; H04B 15/00

(52) U.S. Cl. 455/63.4

(57) ABSTRACT

In one aspect, adjusting a directional antenna from a first state to a second state to improve a network operation of the directional antenna relative to a mobile node to at least partially compensate for motion of the mobile node. In another aspect, identifying a network operational characteristic; determining a desired directional antenna configuration to direct a directional antenna at least partially with respect to a first mobile node at least partially according to the network operational characteristic; and establishing a directional antenna directionality at least partially according to a desired directional antenna direction.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at http://www.uspto.gov/web/offices/com/sol/og/2003/week11/patbene.htm. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

A. For purposes of the USPTO extra-statutory requirements, the present application constitutes a continuation-in-part of United States patent application entitled SIGNAL ROUTING DEPENDENT ON A NODE SPEED CHANGE PREDICTION, naming Alexander J. Cohen; Edward K. Y. Jung; Robert W. Lord; John D. Rinaldo, Jr.; and Clarence T. Tegreene as inventors, U.S. application Ser. No. 11/252,258, filed Oct. 17, 2005 (Attorney Docket No. 0405-003-001A-000000).

B. For purposes of the USPTO extra-statutory requirements, the present application constitutes a continuation-in-part of United States patent application entitled SIGNAL ROUTING DEPENDENT ON A LOADING INDICATOR OF A MOBILE NODE, naming Alexander J. Cohen; Edward K. Y. Jung; Robert W. Lord; John D. Rinaldo, Jr.; and Clarence T. Tegreene as inventors, U.S. application Ser. No. 11/252,206, filed Oct. 17, 2005 (Attorney Docket No. 0405-003-001B-000000).

C. For purposes of the USPTO extra-statutory requirements, the present application constitutes a continuation-in-part of United States patent application entitled USING A SIGNAL ROUTE DEPENDENT ON A NODE SPEED CHANGE PREDICTION, naming Alexander J. Cohen; Edward K. Y. Jung; Robert W. Lord; John D. Rinaldo, Jr.; and Clarence T. Tegreene as inventors, U.S. application Ser. No. 11/252,205, filed Oct. 17, 2005 (Attorney Docket No. 0405-003-001C-000000).

This disclosure describes certain embodiments of a mobile directional antenna. In one implementation, the mobile directional antenna can be optimized and/or provide improved performance as a result of a change in the position or operational configuration of the mobile directional antenna (i.e., a directionality of the directional antenna). In addition to the foregoing, other communication aspects are described in the claims, drawings, and text forming a part of the present disclosure.

In addition to the foregoing, various other embodiments are set forth and described in the text (e.g., claims and/or detailed description) and/or drawings of the present description.

The foregoing contains, by necessity, simplifications, generalizations and omissions of detail; consequently, those skilled in the art will appreciate that the foregoing may be illustrative only depending on context, and is not intended to be in any way limiting. Other aspects, features, and advantages of the devices and/or processes described herein, as defined by the claims, will become apparent in the detailed description set forth herein.

### BRIEF DESCRIPTION OF THE FIGURES

FIG. 1 shows a generalized diagram of one embodiment of the communication network including at least one mobile node having a mobile directional antenna;

FIG. 2 shows a diagram of one embodiment of the mobile node including a mobile directional antenna;

FIG. 3 shows another diagram of one embodiment of the mobile node including a mobile directional antenna;

FIG. 4 shows yet another diagram of one embodiment of the mobile node including a mobile directional antenna;

FIG. 5 shows a diagram of one embodiment of the mobile node having a mobile directional antenna;

FIG. 6 shows a diagram of another embodiment of multiple mobile nodes that can provide a communication that be improved as described in this disclosure;

FIG. 7 shows a diagram of one embodiment of the communication network including a passive embodiment of the mobile directional antenna;

FIG. 8 shows a diagram of one embodiment of the communication network including an active embodiment of the mobile directional antenna;

FIG. 9 shows a diagram of one embodiment of a directional embodiment of the mobile directional antenna;

FIG. 10 shows a diagram of one embodiment of another directional embodiment of the mobile directional antenna;

FIG. 11 shows a diagram of one embodiment of yet another directional embodiment of the mobile directional antenna;

FIG. 12 shows a diagram of one embodiment of a scanning technique for the mobile directional antenna;

FIG. 13 shows a diagram of one embodiment of a discovery technique for the mobile directional antenna;

FIG. 14 shows one embodiment of a diagram of the directional antenna that can be adjusted;

FIG. 15 shows one embodiment of a flow chart of adjusting the directional antenna;

FIG. 16 shows one embodiment of a diagram of the directional antenna;

FIG. 17, that includes 17a and 17b, shows one embodiment of a flow chart of configuring the directional antenna according to a network operational characteristic;

FIG. 18 shows another embodiment of a diagram of the directional antenna;

FIG. 19 shows another embodiment of a flow chart of configuring the directional antenna according to a network operational characteristic;

FIG. 20 shows yet another embodiment of a diagram of the directional antenna;

FIG. 21 shows yet another embodiment of a flow chart of configuring the directional antenna according to a network operational characteristic;

FIG. 22 shows a schematic diagram of another embodiment of the communication network in which a subsystem is an embodiment;

FIG. 23 shows a schematic diagram of at least a portion of yet another embodiment of the communication network including a network subsystem;

FIG. 24 shows a flow chart having operations that facilitate a desirable form of data transfer;

FIG. 25 shows other flow chart embodiments that have operations that facilitate another desirable form of data transfer;

FIG. 26 shows other flow chart embodiments that have operations that facilitate another desirable form of data transfer;

FIG. 27 shows a device such as a computer program product including a signal bearing medium such as a conduit, a memory element, or a display medium;

FIG. 28 shows a relaying embodiment in schematic form;

FIG. 29 shows another embodiment of the communication network that includes a vehicle;

FIG. 30 shows a look-up table that can be used for determining a suitability value at least partly based on each of several operands;

FIG. 31 shows an embodiment of a map plotting each of several nodes based at least in part on the look-up table;

FIG. 32 shows another embodiment of the network subsystem in schematic form;

FIG. 33 shows another embodiment of a system embodiment;

FIG. 34 shows one embodiment of the flow chart of FIG. 24;

FIG. 35 shows one embodiment of the flow chart of FIG. 24 or of its variants shown in FIG. 13;

FIG. 36 shows one embodiment of the flow chart of FIG. 24 or its variants;

FIG. 37 shows one embodiment of the flow chart of FIG.24 or its variants;

FIG. 38 shows one embodiment of the flow chart of FIG. 24 or its variants;

FIG. 39 shows one embodiment of the flow chart of FIG. 24 or its variants;

FIG. 40 shows one embodiment of the flow chart of FIG. 24 or its variants;

FIG. 41 shows one embodiment of the flow chart of FIG. 24 or its variants;

FIG. 42 shows one embodiment of the flow chart of FIG. 24 or its variants;

FIG. 43 shows one embodiment of the flow chart of FIG. 24 or its variants;

FIG. 44 shows one embodiment of the flow chart of FIG. 24 or its variants;

FIG. 45 shows one embodiment of the flow chart of FIG. 24 or its variants;

FIG. 46 shows one embodiment of the flow chart of FIG. 24 or its variants;

FIG. 47 shows one embodiment of the flow chart of FIG. 24 or its variants;

FIG. 48 shows one embodiment of the flow chart of FIG. 24 or its variants;

FIG. 49 shows one embodiment of the flow chart of FIG. 24 or its variants;

FIG. 50 shows one embodiment of the flow chart of FIG. 24 or its variants;

FIG. 51 shows one embodiment of the flow chart of FIG. 24 or its variants;

FIG. 52 shows one embodiment of the flow chart of FIG. 24 or its variants; and

FIG. 53 shows one embodiment of the flow chart of FIG. 24 or its variants.

The use of the same symbols in different drawings typically indicates similar or identical items.

### DETAILED DESCRIPTION

I. Certain Embodiments of Mobile Directional Antennas

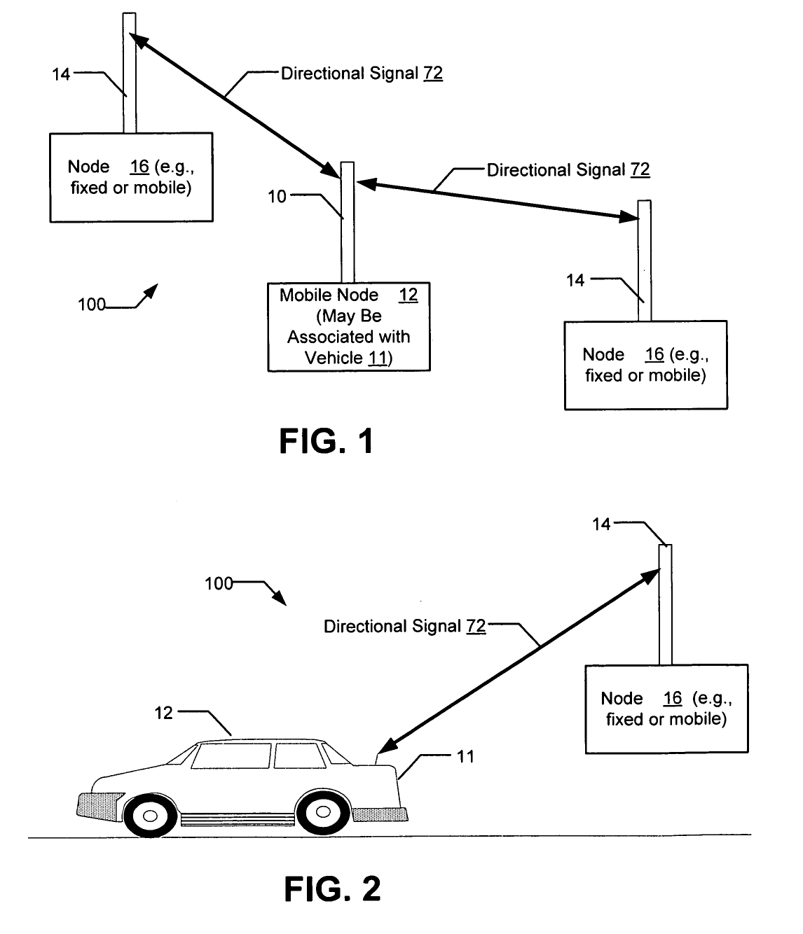

One aspect of this disclosure, depending on context, can relate to operation of at least one mobile directional antenna 10 that can be used within a communication network 100 as described in general with respect to FIG. 1. Certain embodiments of the mobile directional antenna can be integrated relative to virtually any type of mobile node 12. Certain embodiments of the mobile node(s) can include, but is not limited to, a vehicle 11 such as can include, but is not limited to: automobiles, trucks, trains, buses, aircraft, ships, satellites, robotic land vehicle devices, robotic sea vehicle devices, robotic air vehicle devices, etc. Within this disclosure, depending on context, the mobile directional antenna can transmit and/or receive radio signals, optical signals, wireless or cellular telephone signals, and/or any other type of electromagnetic radiation signal, information, and/or data that can be transmitted.

In certain embodiments, the directionality of the at least one mobile directional antenna 10 can at least compensate for motion of the vehicle or mobile node including or associated with the at least one mobile directional antenna 10. In certain embodiments, the directionality of the at least one mobile directional antenna 10 can at least compensate for motion of the vehicle or mobile node with which the at least one mobile directional antenna 10 is being used to communicate. By providing a variety of embodiments of the at least one mobile directional antenna 10 relative to the vehicle or mobile node, communication therebetween can be improved considerably. Additionally, certain embodiments of the vehicle or mobile node or vehicle including the mobile directional antenna 10 can interface to provide a network-type operation.

Certain embodiments of the operation of the mobile directional antenna 10 can vary, and may at least partially include an optimization that can be based on such illustrative factors as: number of nodes transmitted through, power output for at least one node, time for transmission, certainty of transmission, quality of transmission, etc. Certain embodiments of the mobile directional antenna 10 can be configured, depending on context, to either transmit and/or receive communication information. Certain embodiments of the mobile directional antennas can utilize position information. In certain embodiments, the communication information can include, but may not include, depending on such illustrative factors that are not limited to, information, signals, data, etc. that can extend between at least one mobile node 12 and another node 16. In certain embodiments, the other node 16 can include and/or act as a mobile node such as the vehicle 11. In other embodiments, the other node 16 can include and/or act as a fixed node such as a radio tower, a cellular tower, etc.

Within this disclosure, the term “optimization” can mean, depending on context, configuring, operating, transitioning, directing, turning, or positioning the mobile directional antenna 10 between a first state and a second state. In certain embodiments, the optimization can be towards a target state as to improve transmission and/or reception paramaters of the mobile directional antenna. A variety of configurations of the mobile directional antenna can be optimized, which can include but is not limited to active mobile directional antennas, passive mobile directional antennas, mobile directional antennas in a variety of configurations, single directional antennas, directional antenna arrays, etc. Certain embodiments of the mobile directional antenna can have its directionality, or other such operation, modified or improved at least partially with the use of a controller or computer. A variety of technologies at least partially including hardware, firmware, and/or software can be utilized for altering operations or positioning of the mobile directional antenna. The various parameters or functions of the mobile directional antenna that can be optimized are described in this disclosure, as well as obvious modifications thereof. Within this disclosure, certain directional embodiments of directional antennas (which may be associated with both mobile nodes or fixed nodes) can communicate with one or more directional as well as one or more non-directional (e.g. broadcast-based) antenna.

Certain embodiments of the directional antenna 10 or 14 can be included in, attached to, or integrated as a portion of the nodes 16 or 12. Certain embodiments of the node can be fixed, while certain embodiments of the node can be mobile. Certain embodiments of the mobile nodes can be included in, attached to, or secured to the vehicle 11 (e.g., robotic devices, automated devices, etc.). Within this disclosure, the term “robotic device” can, depending on context, indicte an embodiment of the vehicle 11 that may be guided at least partially automatically. The use of robotic vehicles is generally known, one illustrative example of such robotic vehicles as applied to vehicles includes remotely-operated aircraft drones. In other embodiments (such as large aircraft, ships, and land-moving vehicles), the vehicle 11 can be at least partially controlled using one or more actuating mechanism that can be actuated utilizing hydraulic, pneumatic, electronic control, and/or other such power assisted systems such as are known (with aircraft) as fly by wire systems. It is anticipated that as further complex or sophisticated computer, control, and power assist systems are applied to vehicle(s) 11, the acceptance and usage of the robotic vehicles will likely become even more common and accepted. As such, it is likely that many of the functions of operators or drivers of the vehicle(s) 11 might become more automated. For example, certain train, monorail, or shuttle systems can be completely controlled automatically, and could thereby be considered as one embodiment of a robotic vehicle. Certain automobile, bus, or truck navigation or streerage systems could likely become more automated and thereby reduce the effort and/or fatigue on certain drivers, operators, etc.

In certain instances, at least one directional antenna 10 or 14 can be associated with the mobile node 12 and/or the other node 16 (and can provide for the transmitting and/or receiving the communication information therebetween). In certain embodiments, the position information can be at least partially utilized by the at least one mobile directional antenna 10 or 14 that is associated with the first mobile node 12 to provide, or enhance, communications with at least one other mobile directional antenna 10 or 14 that can be associated with a different node 16.

Certain embodiments of the mobile node 12 and/or the associated mobile directional antenna 10 or 14 can be integrated in a variety of the at least one one vehicle 11, as described with respect to FIGS. 1, 2, 3, 4, 5, 6, and other locations throughout the disclosure. In certain embodiments, the mobile directional antenna 10 or 14 can also be situated at certain other locations within this disclosure such in the node(s) 16. In certain embodiments, the at least one vehicle 11 can include, but may not be depending on context limited to: a car, a bus, a truck, a train, an airplane, a ship, a robot, an automated mobile device, etc. Certain embodiments of the mobile directional antenna are configured to be directional such as to improve transmission and/or reception of the communication information with other directional antennas, which may also be associated with the vehicle 11 or not.

In certain embodiments, the mobile directional antenna can be configured to use a variety of technologies and/or mechanisms that can transmit and/or receive information can be situated with respect to relative to a second directional antenna such as to improve, enhance, ensure, and/or otherwise allow communications therebetween. Such position information may be derived using a variety of positions and/or systems techniques including, but not limited to, global positioning systems (hereinafter referred to as “GPS”), LORAN, RADAR, very high frequency omnidirectional range (VOR), optical positioning systems, electromagnetic positioning systems, etc. Certain embodiments of the positioning systems can utilize ranging technologies, such as are generally understood by those skilled in the art. Certain embodiments of the communication network 100 can include, depending on context, radio transmission and/or reception, signal transmission and/or reception, data transmission and/or reception, information transmission and/or reception, cellular phone signal transmission and/or reception, etc.

Another aspect of this disclosure, depending on the context, can relate to different embodiments of a mobile directional antenna design that could be utilized or be operated within the vehicle(s) 11, or portions thereof. Certain embodiments of the vehicle(s) 11 such as automobiles, trucks, robots, ships, aircraft, roadworking equipment, etc. can operate with associated, included, or attached mobile directional antennas. Certain embodiments of the mobile directional antenna can be configured to act as active and/or passive repeaters, such that received input signal, information, data, etc. can be amplified (and in some embodiments modified and/or modulated as appropriate) to produce a corresponding output signal, information, data, etc. Certain embodiments of the mobile directional antennas (and/or the associated node) can modify the signal, information, data, etc. either substantially such as considerable content-wise, or in some minor way such as providing different header information. Certain versions of the signal, information, data, etc. can be transmitted either sequentially and/or in parallel across multiple mobile directional antennas and/or their associated node. Certain embodiments of the optimization of the signal transmissions can be established between certain embodiments of the mobile directional antennas.

In certain embodiments, the vehicle(s) 11 that include or utilize the mobile directional antennas can be maintained in a stationary position (parked or stopped), turned on or turned off, and/or can be traveling along a roadway, track, airway, waterway, or other suitable path while allowing the operation. As such, the mobile directional antenna can provide operation to the vehicle 11 depending, upon a variety of factors, such as the type of the vehicle 11, the different embodiments of operation of the vehicle, the selection of the operator or owner of the vehicle, etc. Certain embodiments of the mobile directional antenna(s) can be active, passive, or some combination thereof.

With certain embodiments of the mobile directional antennas as described in this disclosure, the reception and/or transmission by certain embodiments of the vehicle(s) 11 can be improved. Such reception and/or transmission can be improved in the vehicles whether or not the vehicle(s) 11 can re-transmit received signals or not. As such, certain vehicles can include certain embodiments of the mobile directional antenna that can together act as a node, which can thereupon improve signal transmission and/or reception in a manner that could be understood by those skilled in radio transmission/reception, data transmission/reception, and/or networked device transmission/reception.

Certain embodiments of the mobile directional antenna 10 as described with respect to FIG. 1, that can be associated with a variety of the vehicle 11 as described with respect to FIGS. 2, 3, 4, 5, and at other locations in this disclosure, can be directable to provide, enhance, or otherwise improve communications with the at least one other directional antenna 14. Certain embodiments of the mobile directional antenna 10 or 14 can thereby utilize position information to improve or optimize communications across the communications network 100 utilizing a variety of the nodes 16 and/or the mobile nodes 12. In different embodiments, the position information can either describe the position of the associated mobile directional antenna or describe the position of at least one other mobile directional antenna wich is being communicated with. In different embodiments, one or more of the at least one other directional antenna 14 can be configured as a mobile directional antenna, a fixed directional antenna, a base station directional antenna, a repeater directional antenna, etc.

Certain embodiments of the mobile directional antenna 10 or 14 may be configured to communicate with the at least one other directional antenna, in those instances where the at least one other directional antenna 14 may be stationary (such as being integrated in a fixed base station, stationary repeater, etc.). In certain embodiments, the mobile directional antenna 10 or 14 can be correctable to compensate for its own motion relative to the fixed location of the at least one other directional antenna 14. As such, in certain embodimnents where the at least one other directional antenna 14 may be stationary, the position information derived for the mobile directional antenna 10 or 14 could be configured to compensate for the motion of the mobile directional antenna with respect to the at least one other directional antenna 14 but not necessarily any motion of the at least one other directional antenna 14.

Certain embodiments of the mobile directional antenna 10 or 14 may be configured to communicate with the at least one other directional antenna where the at least one other directional antenna 14 may be mobile (such as being configured as another mobile directional antenna in another vehicle 11, robot, displacement mechanism, actuation mechanism, etc.). In certain embodiments, the mobile directional antenna 10 or 14 should be configured to compensate for its own motion as well as the motion of the motion of the other directional antenna 14. As such, in certain embodimnents where the at least one other directional antenna 14 may be mobile, the position information derived for the mobile directional antenna 10 or 14 could be configured to compensate for the motion of the mobile directional antenna 10 or 14 with respect to the at least one other directional antenna 14 and also compensate for any motion of the at least one other directional antenna 14.

In certain embodiments of the communication network 100, communications can be established between the mobile directional antenna 10 or 14 and one or more of the other directional antennas 14. Effectiveness and/or quality of certain embodiments of the communications can be affected by how closely the respective transmitting/receiving mobile directional antenna may be aligned with another respective receiving/transmitting mobile directional antenna. Such alignment can be a result of the directionality of the mobile directional antennas. A number of optimization mechanisms and/or schemes can be utilized to select which one or more of the other directional antennas 14 the mobile directional antenna 10 or 14 will communicate with, to establish its communication. A number of factors can be included to operate the mobile directional antenna 10 or 14.

In certain embodiments, the operation of the mobile directional antenna 10 or 14 can be at least partially controlled by the hardware, software, and/or firmware that can be integrated within or associated with the mobile node 12, as described in this disclosure. For instance, position information can be derived within the mobile node 12 and/or the mobile directional antenna 10 or 14 that can provide, for example: the relative, actual, geographic, or other positions of the mobile directional antenna 10 or 14 and/or the at least one other directional antenna 14. As such, the derived position information can be utilized by the mobile node 12 and/or the mobile directional antenna 10 or 14 to enhance, provide, improve, and/or otherwise allow communications between the mobile directional antenna 10 or 14 and the at least one other directional antenna 14. In certain embodiments, the position information can also be derived by the at least one other directional antenna 14 and/or the at least one other node 16. In certain embodiments, at least one of the mobile directional antenna 10 or 14 and a mobile node 12, as well as at least one of the at least one other directional antenna 14 and a least one other node 16, can each generate, utilize, transmit, and/or receive position information.

This disclosure can provide a number of techniques providing for the optimization or the improvement of the transmission and/or reception of signals, information, and/or data across at least one other node 16 as described with respect to FIG. 1; in which each of the at least one node 16 can be associated with and/or include the at least one mobile directional antenna. Certain embodiments of the optimization of the transmission and/or reception of signals, information, and/or data can at least partially be based upon power utilized by the at least one mobile directional antenna 10 or 14 in transmitting or receiving the signals, information, and/or data. Certain embodiments of the optimization of the transmission and/or reception of signals, information, and/or data can at least partially be based upon reducing the number of nodes 16 that are being used to transmit signals between end points, and thereby perhaps reduce the signal latency in the combined sum of the nodes. Yet other embodiments of the optimization of the transmission and/or reception of signals, information, and/or data can at least partially be based upon reliability and/or accuracy of signal transmission and/or reception by the at least one mobile directional antenna(s) 10 or 14. As such, there are a number of embodiments of optimization of communications between a number of nodes 12 and/or 16 that are intended to be within the scope of the present disclosure, depending upon context.

In certain embodiments, the optimization or directionality of the mobile directional antenna can be at least partially based on the mobile directional antenna 10 or 14 and/or the other directional antenna 14 utilizing the position information to determine energy efficient transmission paths between certain mobile directional antennas. The optimization or signal transmission/reception efficiency might thereby, e.g., control a direction of transmission and/or reception of the one or more signals, information, data, etc. Such limiting the consumption of power can be particularly useful in certain embodiments of energy-restricted or battery-operated communication devices. The energy or power contained in one or more vehicle(s) 11, or batteries could provide power or control the operation of one or more vehicles, and the power could be controlled and/or monitored. More specifically, the operation of the at least one other directional antenna 14 can be at least partially controlled by the hardware, software, and/or firmware that can be integrated within or associated with each respective node associated with the other directional antenna.

In certain embodiments, the monitored power or energy that may be available to a particular mobile directional antenna can be at least partially used to determine the operational directionality of the mobile directional antenna. For example, a mobile directional antenna (e.g., that could utilize a considerable amount of power, and thereby generate and/or receive powerful signals) could be operated or directed to communicate with another node(s) (fixed or mobile). The other node(s) being selected to communicate with may be, depending on context, spaced by a relatively small distance in an attempt to reduce the number of signal hops or repeats, and thereby reduce total signal latency as compared to communicating via multiple nodes (which may be included in the vehicle(s) 11 or fixed) separated by a relatively greater distance, when the total signal travels over the same distance. By comparison, certain embodiments of the other node(s) with a mobile directional antenna could be configured or positioned closer to each other to utilize lesser transmission or reception power to transmit and/or receive its signal, data, and/or information traversing multiple nodes. Certain embodiments of the nodes may even be viewed as a repeater, which can increase or amplify the power of certain received signals into their output signal, or more precisely control the directing of its output signal, information, and/or data to be received by another node. As such, certain embodiments of the optimization of the mobile directional antenna can relate to or include reducing the energy or power utilized in transmitting or receiving signals, information, data, etc.

There can be variations in the type of communications for each of the different types of vehicle(s) 11, depending upon such illustrative but not-limiting factors as the type of vehicle(s) 11, the types of mobile node(s), the types of base node(s), the transfer rate and volume of data, information, etc. However, certain embodiments of the techniques, mechanisms, systems, etc. can be applied to the different embodiments of mobile nodes. As such, in this disclosure, any type of the vehicle 11 that is described is intended to be illustrative in nature and not-limiting in scope, unless specifically indicated.

FIG. 2 illustrates one embodiment of the mobile node 12 that could be configured as at least one land vehicle(s) such as an automobile, truck, bus, train, wheeled vehicle, tracked vehicle, military vehicle, earth-working vehicle, robot, automated vehicle, etc. Certain embodiments of the communication network 100 can include a variety of the land vehicle being configured to act as the mobile node 12 being configured as a land vehicle can thereby communicate either directly, or via other mobile node(s) or static node(s) to an existent or developed communication infrastructure. Certain embodiments of the mobile node(s) can utilize position information to determine their position relative to other node(s), and thereby a position that the mobile directional antenna should be positioned or configured to improve or optimize the transmission and/or reception of signals, information, and/or data.

Certain embodiments of the mobile node 12 that are configured as land vehicles, can utilize information, data, etc. relating to roadways, tracks, paths of travel, etc. For example, if a particular mobile node 12 can be communicating via its mobile directional antenna 10 or 14 to another mobile node 12; and it can be determined that the other mobile node 12 can be following a road or highway; (e.g., due to position of the node relative to the road or highway, or express information indicating the other node is on the road or highway) then it might depend on context that it is likely that the other mobile node 12 will continue to follow the road. In certain instances, the other node could be expected to exit the road such as onto an intersecting road, exit, street, house or services on the road, etc. By the vehicle 11 following the road, the vehicle should therefore travel in a somewhat continuous, regular, and/or predictable manner as dictated by the path of the road. As such, certain embodiments of the position information can be used to predict likely motion, direction, velocities, etc. of another mobile directional antenna that can be attached to, or integrated in the vehicle 11.

Additional illustrative information about the vehicle 11 can be considered, such as: roads or vehicle paths that the vehicle 11 can be currently or could be expected to follow, layouts of roads, typical speeds the vehicle could operate at, services on the different roads, etc. As such, in certain embodiments, the vehicle 11 would be unlikely to operate outside of certain such parameters such as by a land-constrained vehicle indicating that it is gaining significant distance above the ground, or a road-constrained vehicle indicating that it is operating off roads in environments that the vehicle 11 could not follow, etc. Therefore, with some basic knowledge and/or understanding of the vehicle 11, and how the vehicle can travel, as well as the recent operation and/or location of the vehicle, it could be relatively easy to determine a region where the vehicle and/or the mobile directional antenna will be in a relatively short time. Such basic knowledge and/or understanding could be stored in a database system or other memory, and be processed using logic, similar to as provided in a variety of GPS or other position-based navigation systems, or alternatively could be stored as data or other information in a variety of memory devices.

In certain embodiments, certain transmitting embodiments of the node and/or mobile node (either associated with the mobile directional antenna) should be able to utilize relatively simple position information such as could be modified within the database. Consider that certain embodiments of the data can, depending on context, be configured to search for those vehicle(s) 11 or fixed locations that are configured either as mobile node(s), or node(s), which can be used to receive signals, information, and/or data. Certain embodiments of the illustrative logic (including hardware, software, and/or firmware) that could be used to allow a communicating node to communicate with distant nodes can thereby include, but is not limited to, certain position information that can: a) determine the position of one or more distant node(s) and/or node(s); and/or b) determine the position and/or angle of the mobile node that may be attempting to communicate.

In certain embodiments, the mobile node 12 can utilize scan techniques to optimize the signals, or to search for improved signals. For instance, as described with respect to FIG. 12, the mobile node can perform one embodiment of a scan by, for example, initially scanning along one or more axis on a regular, sensible, or other technique. It may not, in certain instances, be sensible to scan along initial scan lines 1256 at certain directions that other antennas or nodes are likely to be, such as in a direction underneath the ground, since vehicle(s) 11 and base stations are unlikely to be situated there. Such common sense principles can be applied as position information to the nodes in the communication network 100. In other embodiments, it may make sense to attempt to scan certain other mobile directional antennas by scanning every certain fractions of a kilometer (or some fraction thereof) along a roadway or other structure, and thereupon monitor signals, information, and/or data having improved characteristics, optimal characteristics, high signal to noise characteristics, or other parameter characteristics. As soon as some antenna or node is located, the communications with the antenna or node can be monitered and/or maintained, such as to compensate for motion.

Certain embodiments of the scanning, as described with respect to FIG. 12, can be performed in one, two, or more stages, steps, or scans with each subsequent stage, step, or scan being more precise than the previous. For instance, a first scan can be performed along the initial scan lines 1256 for the entire area to be scanned at x increments (where x is some angular or distance measure). After those areas of the strongest scan characteristics are determined from along the initial scan lines 1256, then those areas can be scanned along lesser increments such as illustrated by the secondary scan lines 1258 (consider that the upper-left initial scan lines 1258 as illustrated in FIG. 12 returned the highest value returns). The distance of the secondary scan 1258 can thereupon be performed at each x/2, x/3, x/4, etc. increments. The process can thereupon be repeated at continually smaller increments. In certain embodiments, discovery techniques can be utilized in certain instances when the location of other mobile directional antennas can be uncertain such as during the start of operation or when signal strength may be, depending on context, reduced, or alternatively scan techniques can be utilized in an attempt to improve or optimize reception. The discover techniques as described in this disclosure are intended to be illustrative in nature, and not limiting in scope. Other types of scanning can be performed to, hopefully, return incrementally improved operation.

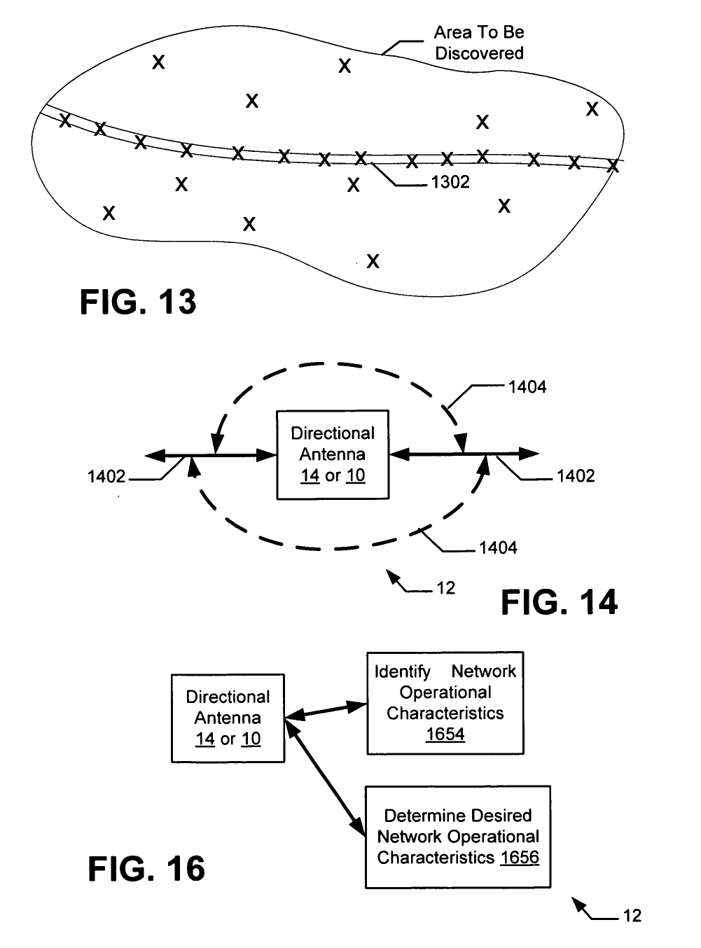

In certain embodiments, the mobile node 12 can utilize discovery as described with respect to FIG. 13 to determine a desirable position or configuration of operation for certain embodiments of the mobile directional antenna. For example, by discovery, the mobile directional antenna can search from a given point in each direction (e.g., at each one, two, five, or other degree increments). The discovery can be particularly focused at particular regions, such as along roadways, waterways, or airways 1302 that the vehicles 11 are likely to be situated. Following the preliminary discovery, the mobile directional antenna can continue discovery at lesser increments for those areas that have signals, information, and/or data having improved characteristics, optimal characteristics, high signal to noise characteristics, or other parameter characteristics, etc. In certain embodiments, a secondary discovery can be performed at lesser increments than the primary scan for those areas that provide strong results. Certain embodiments of the discovery can be performed along one, two, or three degrees. In certain embodiments after the mobile directional antenna can be adjusted from a first position to a second direction in an attempt to improve network operational characteristics using the discovery process, after which a subsequent discovery process can be performed.

A variety of searching, scanning, and/or discovery techniques as described in this disclosure, and modifications thereof, can be used to improve network operational characteristics.

Attempting to improve reception can be performed utilizing one or more technologies. For instance, a mobile directional antenna can be associated with a mounting that can physically displace the mobile directional antenna, such that the direction that they directional antenna may be corrected can be changed. In other embodiments, the directional antenna can be configured as, for example, uncontrollable directional antenna such that electronic, computer, hardware, software, firmware, and/or other techniques can be utilized to operate the mobile directional antenna such that can be actuated toward another direction. In another embodiment, sector directional antennas can be utilized that can be adjusted to be directed (e.g., along one, two, or three axes).

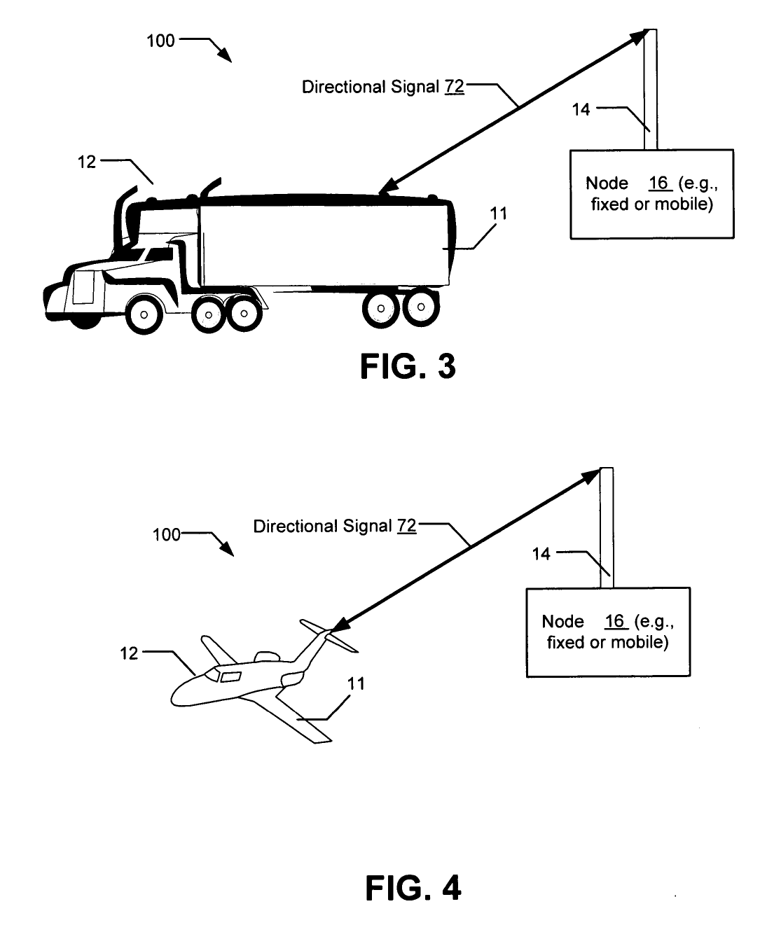

FIG. 3 shows another embodiment of the communication network 100 that utilizes a least one mobile node 12 that can be integrated or attached to a commercial vehicle such as, for example, a truck, a bus, a train, or another commercial vehicle. One aspect about providing mobile directional antennas on such commercial vehicles as trucks, buses, trains, etc. is that such commercial vehicles run on a regular schedule, and may thereby be regularly spaced along a roadway, highway, track, etc. In addition, such commercial vehicles have sufficient power such that the power utilized by the vehicle 11 would likely not represent a considerable drain on the vehicle's battery. In many instances, a considerable number of such commercial vehicles travel over relatively remote roads on a regular basis. In addition, in certain regions, countries, etc., there are a relatively small amount of traditional communication system infrastructure systems. As such, the mobile nodes in certain embodiments of vehicle(s) 11 could improve the communications. By providing the mobile directional antennas 10 or 14 on such commercial vehicles, it would likely increase the number of mobile directional antennas that could be accessed in many of these remote locations. As such, many embodiments of the communication network 100 can be configured to be more reliable as a result of the large number of mobile nodes 12 that are traversing such regions on a regular basis.

Many users of trucks, buses, trains, or other such vehicle(s) 11 understand the importance of communications, particularly for those that are traversing remote locations, especially for those vehicles carrying passengers. The possibility of a breakdown in a remote location can be dangerous, time consuming, and threatening. Certain users would gladly utilize the improved communication infrastructure allowed by certain embodiments of mobile nodes. It might be easier for commercial vehicles to justify the expense, energy use, and/or complexity of certain embodiments of mobile nodes 12 and/or mobile directional antennas. Such commercial vehicles also tend to be operated for a greater number of hours per day then most personal or family vehicles. It is also a common practice for certain truckers, bus drivers, etc. to keep their vehicle engines or motors running in certain periods (e.g., at night, or during rest stops) alongside the road, such as those instances that may be difficult or time-consuming to start the vehicle engine or motor if shut down. During such periods that the engine is idling, for example, a sufficient electric power can continue to be supplied from certain embodiments of the vehicle 11 to actuate certain active embodiments of the mobile directional antenna 10 or 14.

Position information (such as GPS-derived information, etc.) can be used at least partially by the mobile directional antenna 10 or 14 to search for additional nodes 16 including mobile nodes 12. As such, the duration or longevity that active embodiments of the mobile directional antenna can be active may in many instances be increased, and the direction and/or effectiveness of certain embodiments of the communication network 100 including the mobile directional antenna 10 or 14 can thereby be increased. For example, position information can be utilized to monitor a roadway that the first vehicle 11 is traversing for other vehicles which may be configured as, or operate as, mobile nodes 12 that may be able to act as or include the at least one mobile directional antenna(s). As such, certain embodiments of the vehicle 11 traversing a road or highway may utilize the directionality aspects of the mobile directional antenna to track other vehicles (or be tracked by other vehicles) along that road or highway. A variety of computer or controller communication techniques may be utilized to control the directionality of certain embodiments of the mobile directional antenna 10 or 14. In certain embodiments, a communication-service requested signal can be transmitted as a directional signal from the mobile directional antenna, and when received by another mobile directional antenna that one can respond with its position and/or velocity information. Based at least partially upon the position and/or velocity information, the vehicle 11 that transmitted the communication service requested signal can adjust its mobile directional antenna to receive, transmit, and/or otherwise track the other mobile directional antenna.

As described with respect to FIG. 4, certain embodiments of aircraft can include, and/or act as, certain embodiments of the mobile node 12. Certain conventional aircraft may utilize position information (such as GPS) for navigational purposes. More particularly, certain aircraft can be configured to navigate from point to point, make approaches to runways at airports, navigate within clouds are obscured conditions, etc. utilizing the position information. Certain embodiments of conventional aircraft, particularly smaller aircraft, have a modest energy supply and communications capability. Allowing the mobile directional antenna 10 or 14 aboard aircraft to act as repeaters for other aircraft could, in a number of instances, improve the signal transmission quality to certain aircraft, especially those that are remotely situated. Certain embodiments of conventional aircraft communication can rely on omni-directional broadcast techniques. Such directionality of directional antennas could improve the signal transmission and/or reception (e.g., improve signal to noise ratio, signal strength, signal consistency, etc.) with communications with the ground station.

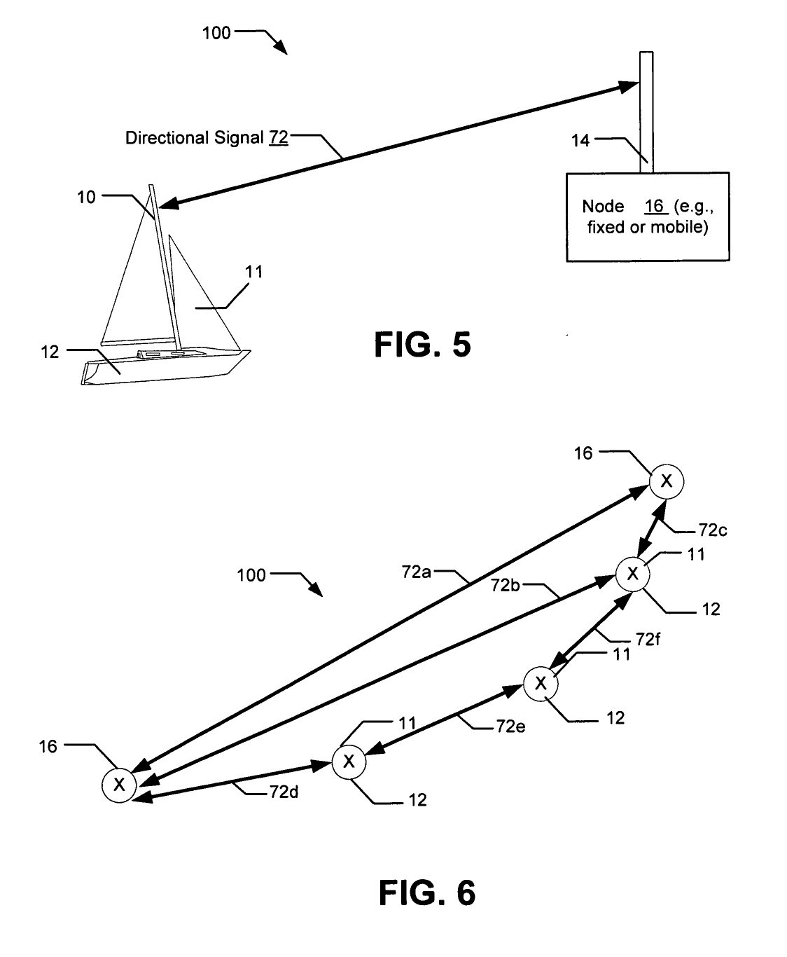

FIG. 4 thereby illustrates one embodiment of the communication network 100 that utilizes at least one mobile node 12 which can be configured as an aircraft. In certain embodiments, certain aircraft can utilize mobile directional antennas in other aircraft, as well as other land from air vehicles and/or water vehicles as illustrated in FIG. 5. Certain water-based vehicles can also utilize the position information. As such, it may not be necessary that each type of the vehicle 11 communicate only with other vehicles of its own type; and it may be desirable for vehicles of one type (such as that aircraft) to be able to communicate with vehicles of other types, such as land vehicles (at least in emergency situations). As such, it may be possible, in certain aspects and/or situations, anyway, for certain embodiments of the vehicles 11 to communicate with other types of vehicles, and thereby possibly utilize at least certain portions of certain communication network 100 that might have been established for other types of communication networks, but were thereupon expanded or enhanced using mobile nodes. Other embodiments of communication networks can be established primarily using mobile nodes.

II. Certain Embodiments of Directional Antenna Directionality

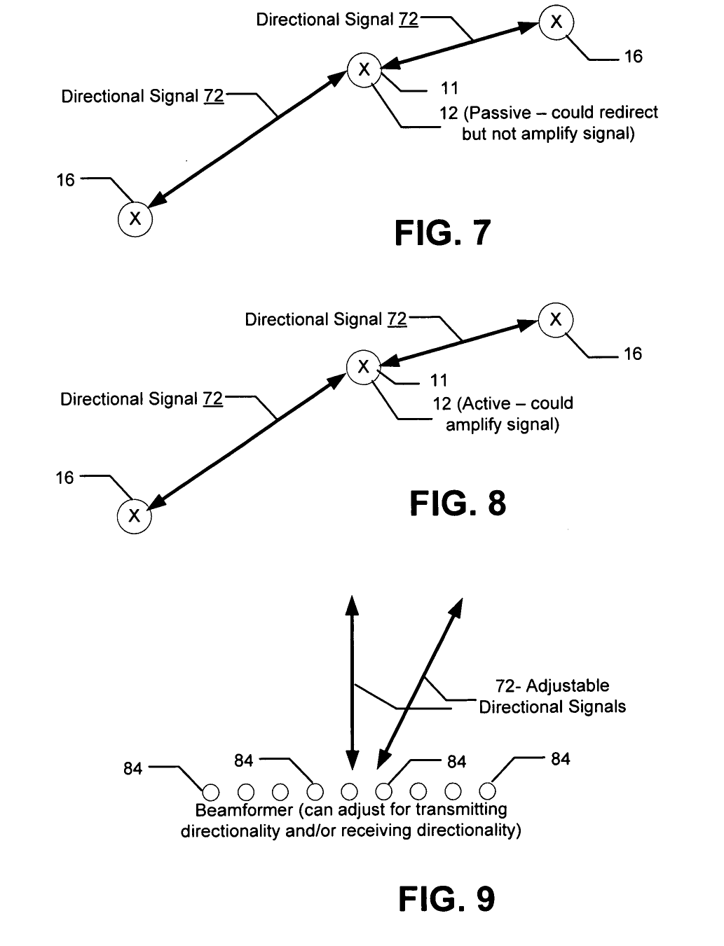

Certain embodiments of the mobile directional antenna 10 or 14 (certain embodiments being described with respect to FIGS. 1 to 6) can be configured to interface with one or more of the mobile node 12 and/or one or more of the node 16. Certain embodiments of the mobile directional antenna, as described with respect to FIG. 7, can be configured to be passive. With passive embodiments of the mobile directional antenna 10 or 14, the energy utilized to transmit or receive signals, information, and/or data that may be transmitted or received by the mobile directional antenna 10 or 14 can be applied directly to the mobile directional antenna. Such passive mobile directional antenna configurations can be applied to transmitting mobile directional antennas and/or receiving mobile directional antennas. Certain embodiments of the passive embodiments of the directional antenna and/or the node 12 can be utilized to redirect the signal between a number of nodes 16, as described with respect to FIG. 7. Passive nodes 12, in general, cannot amplify a signal since there is no power source to provide the amplification. Certain embodiments of the passive mobile directional antennas can include a steering mechanism, whereby certain passive embodiments of the mobile directional antenna can be steered in a desired direction as to transmit signals, information, and/or data to (and/or receive signals, information, and/or data from) a desired direction.

FIG. 8 shows one embodiment of the mobile directional antenna 10 or 14 that can be configured to be active. In the active embodiment of the mobile directional antenna 10 or 14, at least a portion of the energy that may be used to generate and/or transmit the signal, information, and/or data (as either generated and/or received by the mobile directional antenna) may be provided as a result of energy as applied by an energy source 820 at least partially to the mobile directional antenna. As such, the output signal for certain embodiments of an active version of the mobile directional antenna 10 or 14 (and/or the associated node) can be greater than the input signal, thereby providing an amplifier and/or repeater function. Certain embodiments of the active embodiments of the directional antenna and/or the node 12 can thereby be utilized to redirect the signal between a number of nodes 16, as described with respect to FIG. 8. Active nodes 12, in general, can amplify a signal since there is a power source to provide the amplification for the directional antenna, and therefore active nodes can act as repeaters.

In certain embodiments, both the passive embodiments of the mobile directional antenna 10 or 14, and/or the active embodiments of the mobile directional antenna 10 or 14 can be applied as dispersed over a relatively large area, or as a more directed beam that can be directed to a relatively small area. FIG. 9 shows an embodiment of multiple segments of the mobile directional antenna that can be combined into the unitary mobile directional antenna 10 or 14, and can be utilized to provide beamforming aspects. Certain embodiments of the antenna segments may be configured in a regular pattern, such as an antenna array. Such concepts as phased array can be utilized to “steer” output signals. Those regions relative to the directional antenna array at which the signals constructively interface may exhibit an increased signal strength. Those regions relative to the directional antenna array at which signals destructively interface will likely exhibit a decreased signal strength. Such positioning of the increased and decreased signal strength regions may be controllably displaced by controlling the relative phases of the segments of the mobile directional antenna. Such phased array or beamsteering directional antennas could be provided in a transmitting and/or receiving configuration.

Different embodiments of directional antenna types, many of which are generally known and/or commercially available, could be used and/or modified to act as the mobile directional antenna 10 or 14. Certain embodiments of directional antennas (such as patch directional antennas) might rely on integrated circuit technology, and may provide some precision as to directionality.

Certain embodiments of the mobile directional antenna can utilize a variety of directionality aspects. For example, the mobile directional antenna that may be associated with a mobile directional antenna can direct their mobile directional antenna along a length of a roadway to see if there are any other vehicles with their mobile directional antenna. Certain other mobile directional antennas (that are attached to or integrated with vehicles), and/or static directional antennas positioned along the roadway could respond with a response signal. With the response signal, certain embodiments of the mobile directional antenna 10 or 14 can indicate that the responding directional antenna could be available to be included as a portion of the communication network 100. A variety of techniques could thereupon be utilized to establish the communications utilizing the responding directional antenna. Certain embodiments of mobile directional antennas, can be positioned or configured to transmit and receive signals, information, and/or data from different directions. For example, certain mobile directional antennas can include at least one directional transmitting directional antenna, and at least one directional receiving directional antenna that can act independently.

The use of certain embodiments of the mobile directional antennas by certain embodiments of the mobile nodes (e.g., cars, trucks, buses, ships, boats, aircraft, etc.) could utilize some power to provide amplifying or repeating energy, such power could allow the mobile nodes to act somewhat as a repeater. However, certain users might desire such aspects of certain embodiments of mobile directional antennas as increased signal coverage (in cities, remote areas, etc.); increased signal strength in a variety of areas, increased uniformity of signals, increased probability of the communication system, etc.

Within cities with tall buildings, for example, communication signals such as are used for radio and/or cellular phones can bounce off or be deflected by the buildings, etc. Such signal deflection, bouncing, aberration, etc. can result in inconsistent signal reception. As such, allowing at least certain vehicle(s) 11 in the cities to act as a mobile directional antenna could provide such increased service to other vehicles, pedestrians, etc. In certain embodiments, one or more (e.g., a considerable number) of the vehicle(s) 11 could utilize their directional antennas to create a more uniform distribution of signals, information, or data throughout the area. In certain large cities, certain tall buildings can include a radio transmitter to transmit a radio signal. Certain vehicle(s) 11 such as aircraft, blimps, satellites, etc. could be provided with the mobile directional antenna to provide similar service, which may actually be improved as a result of the elevation of the directional antenna.

III. Certain Embodiments of Directional Antenna Motion Prediction

One aspect of the communication network 100 could utilize a variety of mobile nodes 12, such as could include at least one mobile directional antenna 10 or 14. It may be desired to have the at least one mobile directional antenna 10 or 14 configured to be able to operate as to monitor for optimized or improved signals, utilizing directionality of the mobile directional antenna 10 or 14. Certain embodiments of the directionality should thereby be able to have some predictability as to either the position, direction, or velocity (along 1, 2, or 3 axes) the mobile node 12 associated with the mobile directional antenna 10 or 14, or alternatively the directional antenna 10 or 14 associated with another node 12 or 16. Therefore, in certain embodiments, it is important to understand not only where the present node is situated and/or moving, but it is also important to be able to determine where at least one other node(s) 12 or 16 are situated and/or moving which the present node is communicating with, and/or is attempting to communicate with. Such position information on the present node and communicating nodes can be derived utilizing position-based technology, such as GPS.

Certain embodiments of mobile nodes that are associated with the vehicle(s) 11 can consider how such vehicles would normally move. As such, automobiles, trucks, buses, etc. can be considered as often following roads, highways, etc. As such, it may be desired to direct communicating signal(s), information, and/or data with such vehicle(s) 11 along a road or highway along which the automobiles, trucks, buses, etc. are following. If, for example, such automobiles, trucks, buses, etc. have diverted from the road or highway to follow a road, service, home, etc., then the new road, service, home, etc. might be considered, if it is desired to maintain communications. For instance, if another vehicle 11 is providing position information indicating that it is stopping at a home or service, then certain embodiments of the vehicle 11 might be ceasing transmissions from their mobile directional antenna. Other embodiments of the vehicle(s) 11, by comparison, might be continuing to transmit, such as trucks or buses that may continue to operate their engines when the vehicle 11 is stopped. As such, a continuing-to-transmit signal or a ceasing-transmissions suitable may be provided by certain embodiments of the mobile directional antenna 10 or 14, as desired or as conventional for the particular communication network 100.

Certain embodiments of motion prediction can also be utilized to indicate motion of the mobile directional antenna 10 or 14 that is associated with the monitoring mobile node 12. For instance, such information as one mobile node velocity, position, acceleration, etc. can be utilized as position information to indicate likely motion along the highway, roadway, etc. In certain embodiments, the vehicle operator, driver, passenger, etc. also provide input to indicate that the vehicle 11 is stopped. Alternatively, the engine condition of the vehicle 11 could be monitored to consider further vehicle operation, motion, acceleration, etc. Each of these could be considered as certain embodiments of position information that can be utilized to predict further position or velocity of the vehicle 11 or mobile node 12. Such position information can also be transmitted to other vehicle(s) 11 or nodes 10 or 14 as signals, data, or information, which can be utilized to predict motion of the vehicle remotely.

As such, certain embodiments of the communication network 100 can thereby be configured to be highly modifiable, based on such factors as motion and position of certain mobile nodes 12 and/or nodes 16, as well as their respective directional antennas 10 and 14. Certain embodiments of the communication network 100 can provide an improved quality, signal strength, signal to noise ratio, and other aspects of signals transmitted by and/or received by the directional antennas 10 and/or 14.

For certain types of communications, it may be desired to provide some security to communications. Certain users of certain embodiments of the communication network 100 might be less likely to use communication networks if they believed that the communications among the nodes 12, 16 are less than secure and/or private. Consider that certain communication networks 100 can utilize a particular first mobile directional antenna to act as, for example, a repeater. In certain embodiments, the repeater may act such that the signal, information, and/or data may be received by the first mobile directional antenna (if not desired to be received thereby), but may instead be received by an intended recipient second mobile directional antenna via the first mobile directional antenna. In certain embodiments, coded techniques such as code division multiple access (CDMA) can be utilized with some degree of certainty to assure that only desired recipients are capable receiving transmitted information, signals, and/or data. In certain embodiments, users in vehicles 11 that are associated with mobile directional antennas can receive and/or utilize signals, information, and/or data intended for them, and not signals, information, and/or data intended to be transmitted to another node.

IV. Certain Embodiments of Optimization or Improving Signal Transmission and/or Reception

FIG. 6 illustrates one embodiment of the communication network 100 utilizing a number of mobile nodes 12 as well as a number of nodes 16 (which may be fixed or mobile). Within this disclosure, certain embodiments of the improved or optimization can rely on which ones of the nodes 16 and/or mobile nodes 12 to utilize in establishing communications across the communication network 100. For example, consider a communication between the nodes 16 in the left and the right of FIG. 6, a number of signal pathways can be utilized as illustrated by a first signal path including signal 72a; second signal path including signals 72b and 72c; or a third signal path including signals 72d, 72e, 72f, and 72c. Within this disclosure, the improvement or optimization can relate to selecting which of these signal path provides an improved or optimized signal transmission or reception.

There can be a variety of measures used to determine improved or optimization. For example, if transmission speed is the selected measure, then perhaps the first signal path including signal 72a would be the improved or optimal signal path since this signal path does not traverse any directional antennas and/or nodes.

By comparison, if necessary signal transmission power, or reduced power usage, is the selected measure, then perhaps the third signal path including signals 72d, 72e, 72f, and 72c provide the improved or optimal signal transmission or reception. Consider that the third signal path travels between relatively closely positioned mobile nodes. Yet still, if transmission utilizing a mobile node positioned closer to a remote node is the selected measure, then perhaps the second signal path including signals 72b and 72c could provide the improved or optimal signal transmission or reception.

In certain embodiments of the communication network 100, perhaps more than one signal path can be utilized, and signals, data, or information relating to duplicate signal path can be ignored. Since many embodiments of the communication network 100 utilize variable mobile node positions, velocities, etc.; it may be desired to configure the communication network to be adaptable. By utilizing a variety of embodiments of the directional antennas in combination with the mobile nodes 12 and/or the nodes 16, in many embodiments a variety of improved and/or optimized communications may be established between the at least one mobile nodes 12 and/or the at least one nodes 16.

Within this disclosure, depending upon context, the term “directionality” as applied to mobile directional antennas 10 and/or directional antennas 14 can mean, but is not limited to, adjusting a direction of controlled signal transmission (which may be considered along one, two, or three axes). Several embodiments of mechanisms, techniques, devices, etc. that can provide directional antenna directionality are now described that can utilize or be designed or operated utilizing hardware, software, and/or firmware.

One embodiment of the directional antenna 10 or 14 is described with respect to FIG. 9. In the directional antenna 10 or 14, a number of directional antenna segments 84 are provided that can utilize phased array technology and/or beamforming technology. The use of phased arrays and/or beamformers are generally understood in the directional antenna technology, and are in common usage. Depending upon the actuation of the directional antenna segments (e.g. by which the phases of the directional antenna segments 84 are relatively controlled), the directions of the resultant signals can be adjusted. For example, the angle and position of the adjustable directional signals 72 can be displaced to correspond to those locations where the phases as produced by the directional antenna segments constructively interfere. By comparison, those regions where the signals from the directional antenna segments 84 constructively interfere to correspond to regions outside of the adjustable directional signal 72.

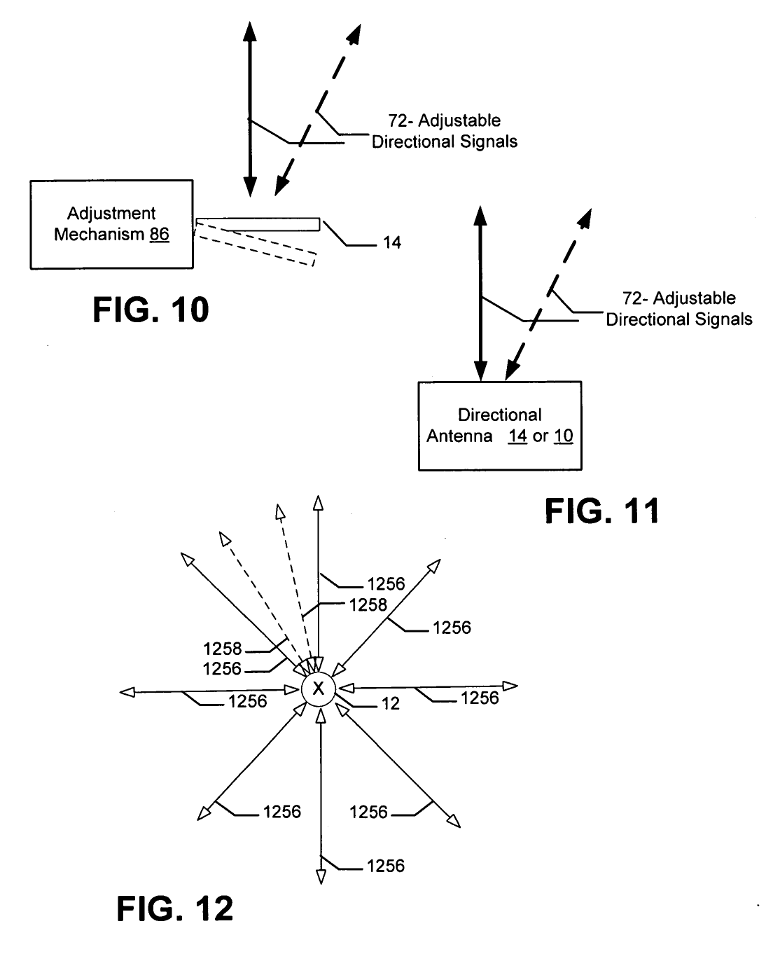

Another embodiment of the directional antenna 10 or 14 is described with respect to FIG. 10. For example, an adjustment mechanism 86 can be provided to physically adjust an angle of the directional antenna 10 or 14. By adjusting the physical angle of the directional antenna 10 or 14, a direction of the adjustable directional signals 72 can be altered.

Another embodiment of the directional antenna 10 or 14 may be described with respect to FIG. 11, in which a configuration of the directional antenna 10 or 14 can be adjusted using a variety of techniques that cam include, but are not limited to: electromagnetic, electromechanical, piezo-electrical, and/or micro-electromechanical (MEMS). In certain embodiments, directional antenna 10 or 14 can utilize solid-state configuration, such as with patch directional antennas which are commercially available and generally understood in the directional antenna art. In certain embodiments, the physical configuration of the creditable directional antenna 10 or 14 it self could be modified, such as to be capable of producing an altered adjustable directional signal 72. In other embodiments, a field (e.g., electromagnetic, acoustic, optical, or other) can be applied across the directional antenna 10 or 14, to thereby alter the direction of propagation of the adjustable directional signals 72.

Certain embodiments of the directional antenna 10 or 14, as described with respect to FIGS. 9, 10, and/or 11, are intended to be illustrative in nature and not limiting in scope. Different mechanisms or devices, as are known in the art, which can be utilized to provide adjustable directional signals 72 are within the intended scope of the present disclosure.

V. Certain Embodiments of the Flow Charts or Diagrams

Within the disclosure, flow charts of the type described in this disclosure apply to method steps as performed by a computer or controller. The flow charts can also apply to apparatus devices, such as an antenna or a node associated therewith that can include, e.g., a general-purpose computer or specialized-purpose computer whose structure along with the software, firmware, electromechanical devices, and/or hardware, can perform the process or technique described in the flow chart.

FIG. 14 shows one embodiment of the directional antenna 10 or 14 whose direction(s) of improved network operation 1402 that can be adjusted as indicated by 1404 (e.g., from a first state to a second state, or by repositioning the directional antenna, etc.) to improve a network operation of the directional antenna. In certain embodiments, the directional antenna can be associated with, attached to, or integrated in the mobile node 12 as described in this disclosure. Certain embodiments of the adjustment of the directional antenna 10 or 14 can be performed at least partially within the directional antenna and/or at least partially within a mobile node (not illustrated in FIG. 14). Certain embodiments of the adjustment of the directional antenna can include, but is not limited to, adjusting the position, power, signal quality, signal to noise ratio, etc. of the directional antenna. Certain embodiments of the directional antenna can be configured to be transmitting and/or receiving directional antennas.

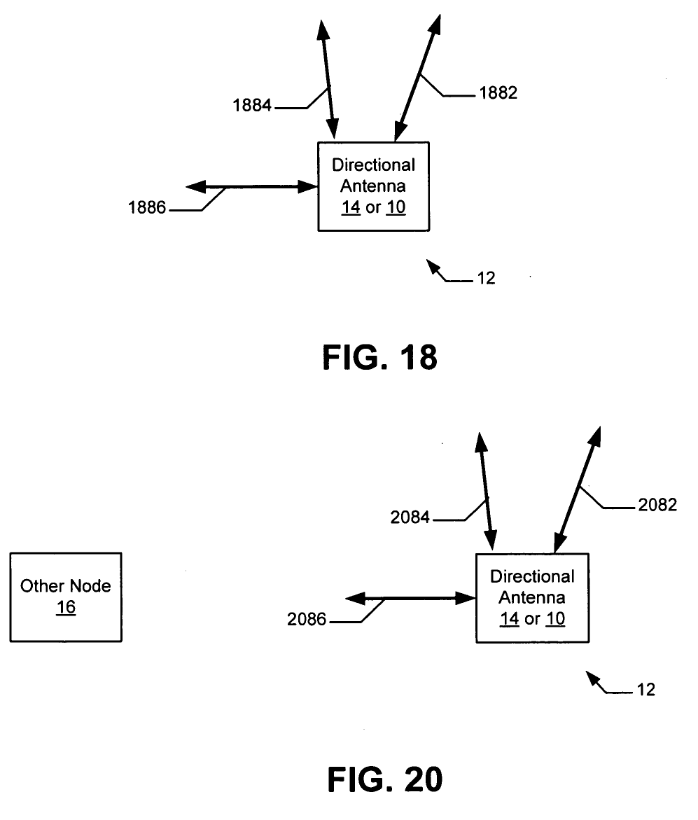

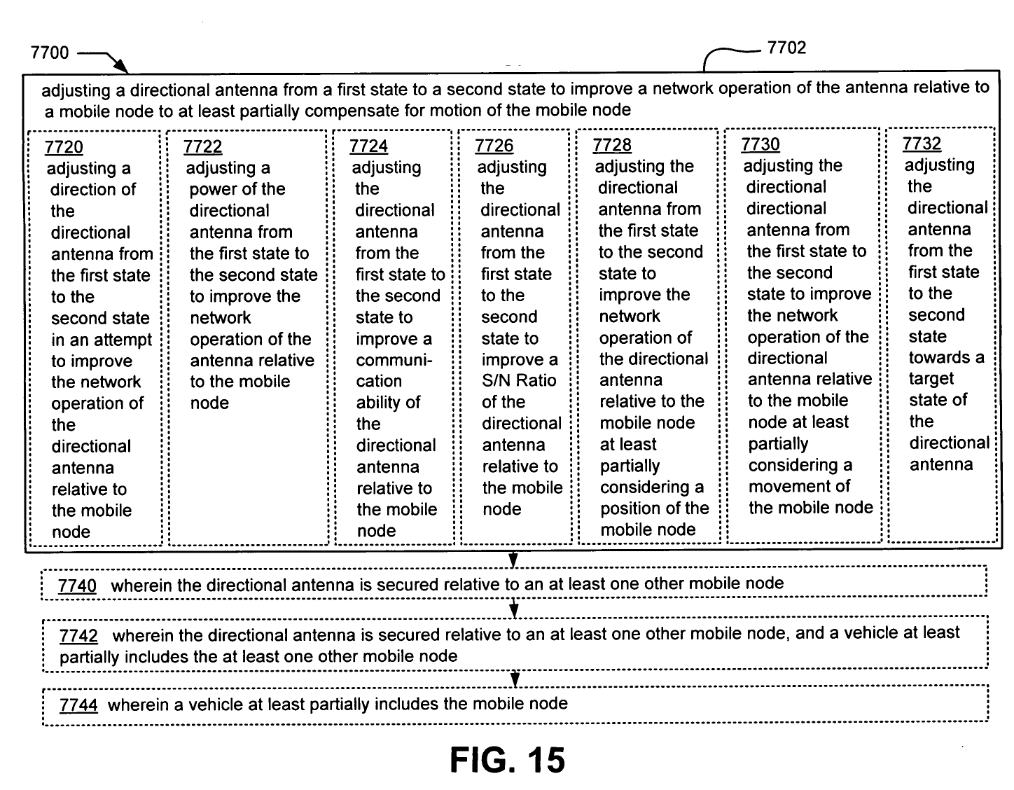

One embodiment of a high-level flow chart of the resolution conversion technique 7700 that is described with respect to FIG. 15 and which includes operations 7702, 7740, 7742, and 7744; in addition to optional operations 7720, 7722, 7724, 7726, 7728, 7730, and 7732. The high-level flow chart of FIG. 15 should be considered in combination with the mobile directional antenna, as described with respect to FIG. 14. One embodiment of operation 7702 can include, but is not limited to, adjusting a directional antenna from a first state to a second state to improve a network operation of the directional antenna relative to a mobile node to at least partially compensate for motion of the mobile node. For example, a directional antenna 10 or 14 as described in this disclosure can be positionably or configurably adjusted, and thereby produce adjustable directional signals. One embodiment of the adjusting a directional antenna from a first state to a second state to improve a network operation of the directional antenna relative to a mobile node to at least partially compensate for motion of the mobile node of operation 7702 can include operation 7720, which can include but is not limited to, adjusting a direction of the directional antenna from the first state to the second state in an attempt to improve the network operation of the directional antenna relative to the mobile node. For example, the directional antenna 10 or 14 can be adjusted to improve a network operation, such as to increase throughput, reduce signal to noise ratio, improve signal quality and/or consistency, etc. One embodiment of the adjusting a directional antenna from a first state to a second state to improve a network operation of the directional antenna relative to a mobile node to at least partially compensate for motion of the mobile node of operation 7702 can include operation 7722, which can include but is not limited to, adjusting a power of the directional antenna from the first state to the second state to improve the network operation of the directional antenna relative to the mobile node. For example, a power of the directional antenna can be adjusted such as within a solid-state directional antenna 10 or 14, and/or the associated node, which may include but is not limited to a patch directional antenna. One embodiment of the adjusting a directional antenna from a first state to a second state to improve a network operation of the directional antenna relative to a mobile node to at least partially compensate for motion of the mobile node of operation 7702 can include operation 7724, which can include but is not limited to, adjusting the directional antenna from the first state to the second state to improve a communication ability of the directional antenna relative to the mobile node. For example, the directional antenna 14 or 10, and/or the associated node, can be adjusted, repositioned, or configured to improve the communication ability, such as by altering the direction of the adjustable directional signals 72 of FIGS. 9 to 11. One embodiment of the adjusting a directional antenna from a first state to a second state to improve a network operation of the directional antenna relative to a mobile node to at least partially compensate for motion of the mobile node of operation 7702 can include operation 7726, which can include but is not limited to, adjusting the directional antenna from the first state to the second state to improve a S/N Ratio of the directional antenna relative to the mobile node. For example, One embodiment of the adjusting a directional antenna from a first state to a second state to improve a network operation of the directional antenna relative to a mobile node to at least partially compensate for motion of the mobile node of operation 7702 can include operation 7728, which can include but is not limited to, adjusting the directional antenna from the first state to the second state to improve the network operation of the directional antenna relative to the mobile node at least partially considering a position of the mobile node. For example, a position of the mobile node (e.g., as at least partially set forth by position information) can be utilized to adjust the position or configuration of the directional antenna to improve the network operation of the directional antenna. One embodiment of the adjusting a directional antenna from a first state to a second state to improve a network operation of the directional antenna relative to a mobile node to at least partially compensate for motion of the mobile node of operation 7702 can include operation 7730, which can include but is not limited to, adjusting the directional antenna from the first state to the second state to improve the network operation of the directional antenna relative to the mobile node at least partially considering a movement of the mobile node. For example, a movement of the mobile node (e.g., as at least partially set forth by position information) can be utilized to adjust the position or configuration of the directional antenna to improve the network operation of the directional antenna. One embodiment of the adjusting a directional antenna from a first state to a second state to improve a network operation of the directional antenna relative to a mobile node to at least partially compensate for motion of the mobile node of operation 7702 can include operation 7732, which can include but is not limited to, adjusting the directional antenna from the first state to the second state towards a target state of the directional antenna. For example, a target state of the mobile node (e.g., as at least partially set forth by position information) can be utilized to adjust the position or configuration of the directional antenna to improve the network operation of the directional antenna. One embodiment of operation 7740 can include, but is not limited to, wherein the directional antenna is secured relative to an at least one other mobile node. For example, the directional antenna is secured to, or integrated in, the least one other mobile node. One embodiment of operation 7742 can include, but is not limited to, wherein the directional antenna is secured relative to an at least one other mobile node, and a vehicle at least partially includes the at least one other mobile node. For example, the directional antenna can be secured relative to at least one other mobile node is communicating with the mobile node. One embodiment of operation 7744 can include, but is not limited to, wherein a vehicle at least partially includes the mobile node. For example, the mobile node is included in, integrated in, secured to, or forms a portion of, the vehicle 11. The order and/or arrangement of the operations within FIG. 15 are intended to be nonlimiting in scope.

FIG. 16 shows one embodiment of a directional antenna that can have a network operational characteristic identified at least partially by 1654. In certain embodiments, a desired directional antenna configuration can be determined according to the network operational characteristic (e.g., to improve a network operation of the directional antenna) at least partially by 1656. In certain embodiments, a directional antenna directionality can be established at least partially according to a desired directional antenna direction. In certain embodiments, the directional antenna can be associated with, attached to, or integrated in the mobile node as described in this disclosure. Certain embodiments of the adjustment of the directional antenna can be performed at least partially within the directional antenna and/or at least partially within a mobile node (similar to as described with respect to FIG. 14). Certain embodiments of the adjustment of the directional antenna can include, but is not limited to, adjusting the position, power, signal quality, signal to noise ratio, etc. of the directional antenna. Certain embodiments of the directional antenna can be configured to be transmitting and/or receiving directional antennas.

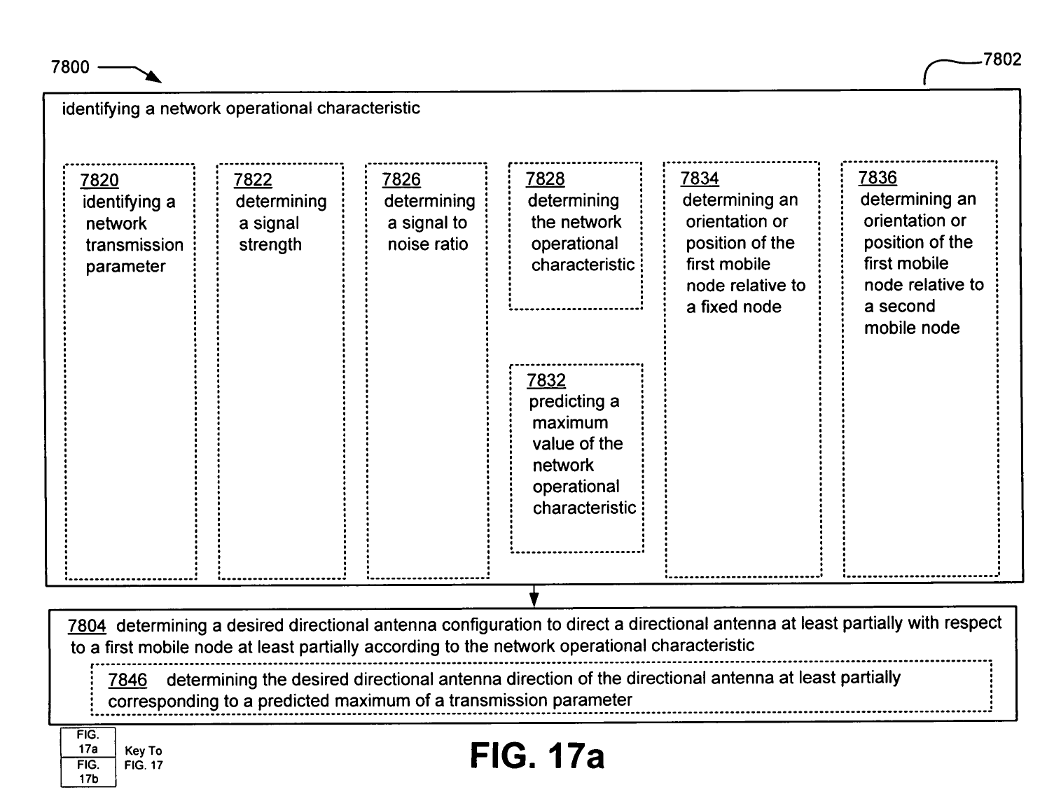

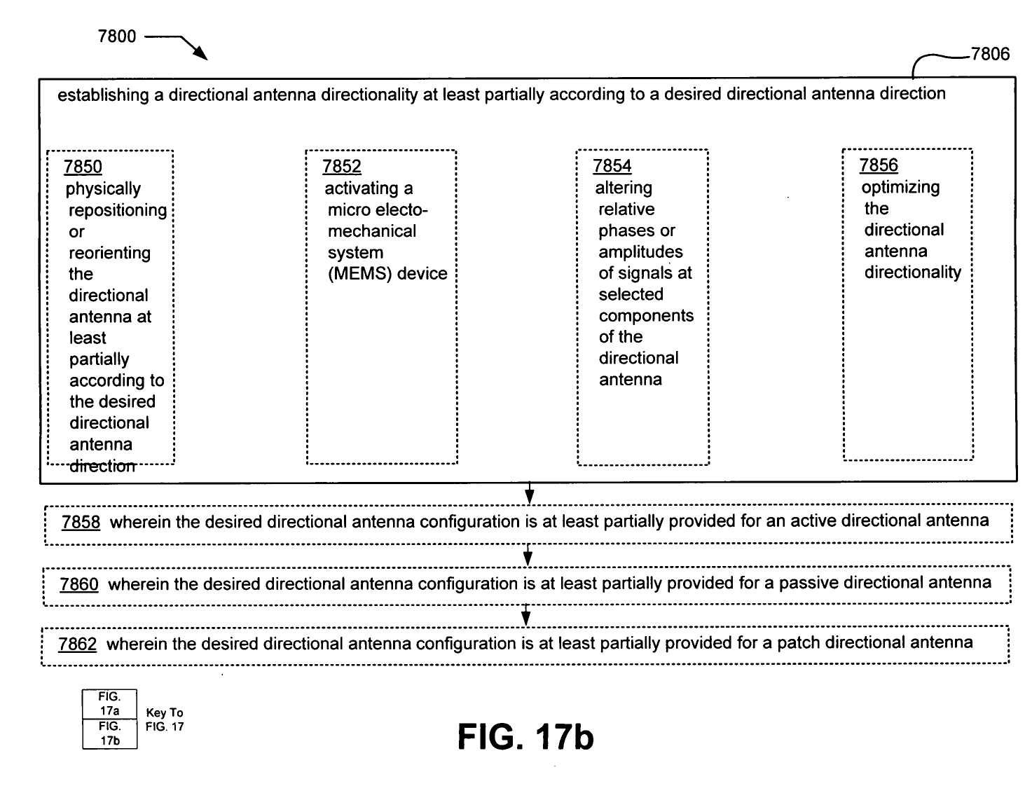

One embodiment of a high-level flow chart of the resolution conversion technique 7800 that is described with respect to FIGS. 17a and 17b and which includes operations 7802, 7804, and 7806; in addition to optional operations 7820, 7822, 7826, 7728, 7832, 7834, 7836, 7846, 7850, 7852, 7854, 7856, 7858, 7860, and 7862. The high-level flow chart of FIGS. 17a and 17b should be considered in combination with the mobile directional antenna, as described with respect to FIG. 16. One embodiment of operation 7802 can include, but is not limited to, identifying a network operational characteristic. For example, at least one network operational characteristic is identified. One embodiment of operation 7804 can include, but is not limited to, determining a desired directional antenna configuration to direct a directional antenna at least partially with respect to a first mobile node at least partially according to the network operational characteristic. For example, determining the desired directional antenna configuration. One embodiment of operation 7806 can include, but is not limited to, establishing a directional antenna directionality at least partially according to a desired directional antenna direction. For example, the directional antenna directionality is adjusted using the mechanisms or techniques as described with respect to FIGS. 9, 10, and/or 11. Certain embodiments of the identifying a network operational characteristic of operation 7802 can include operation 7820, which can include but is not limited to, identifying a network transmission parameter. For example, the network operational characteristic can include the network transmission parameter. Certain embodiments of the identifying a network operational characteristic of operation 7802 can include operation 7822, which can include but is not limited to, determining a signal strength. For example, the network operational characteristic can include a signal strength. Certain embodiments of the identifying a network operational characteristic of operation 7802 can include operation 7826, which can include but is not limited to, determining a signal to noise ratio. For example, the network operational characteristic can include the signal to noise ratio. Certain embodiments of the identifying a network operational characteristic of operation 7802 can include operations 7828 and 7832. Certain embodiments of the operation 7828 can include but is not limited to, determining the network operational characteristic. For example, the network operational characteristic can be identified by being determined. Certain embodiments of the operation 7832 can include, but is not limited to, predicting a maximum value of the network operational characteristic. For example, the network operational characteristic can be identified by being predicted. Certain embodiments of the identifying a network operational characteristic of operation 7802 can include operation 7834, which can include but is not limited to, determining an orientation or position of the first mobile node relative to a fixed node. For example, the network operational characteristics can be identified by determining the orientation or position of the first mobile node relative to the fixed node. Certain embodiments of the identifying a network operational characteristic of operation 7802 can include operation 7836, which can include but is not limited to, determining an orientation or position of the first mobile node relative to a second mobile node. For example, the network operational characteristic can be identified by determining the orientation or position of the first mobile node relative to the second mobile node. Certain embodiments of the determining a desired directional antenna configuration to direct a directional antenna at least partially with respect to a first mobile node at least partially according to the network operational characteristic of operation 7804 can include operation 7846 that can include, but is not limited to determining the desired directional antenna direction of the directional antenna at least partially corresponding to a predicted maximum of a transmission parameter. For example, the determining the desired directional antenna configuration can include determining the desired directional antenna direction. Certain embodiments of the establishing a directional antenna directionality at least partially according to a desired directional antenna direction of operation 7806 can include operation 7850 that can include, but is not limited to, physically repositioning or reorienting the directional antenna at least partially according to the desired directional antenna direction. For example, the establishing the directional antenna directionality can include physically repositioning or reorienting the directional antenna. Certain embodiments of the establishing a directional antenna directionality at least partially according to a desired directional antenna direction of operation 7806 can include operation 7852 that can include, but is not limited to, activating a micro electomechanical system (MEMS) device. For example, the establishing the directional antenna directionality can include activating the MEMS devices. Certain embodiments of the establishing a directional antenna directionality at least partially according to a desired directional antenna direction of operation 7806 can include operation 7854 that can include, but is not limited to, altering relative phases or amplitudes of signals at selected components of the directional antenna. For example, the establishing the directional antenna directionality can include altering the relative phases or amplitudes of signals of selected components of the directional antenna, such as by using beamforming or phased-array techniques, as described with respect to FIG. 9. Certain embodiments of the establishing a directional antenna directionality at least partially according to a desired directional antenna direction of operation 7806 can include operation 7856 that can include, but is not limited to, optimizing the directional antenna directionality. For example, the optimizing the directional antenna's directionality is described with respect to FIGS. 9, 10, and 11. Certain embodiments of the operation 7858 can include, but is not limited to, wherein the desired directional antenna configuration is at least partially provided for an active directional antenna. For example, the directional antenna includes the active directional antenna. Certain embodiments of the operation 7860 can include, but is not limited to, wherein the desired directional antenna configuration is at least partially provided for a passive directional antenna. For example, the directional antenna includes the passive directional antenna. Certain embodiments of the operation 7862 can include, but is not limited to, wherein the desired directional antenna configuration is at least partially provided for a patch directional antenna. For example, the directional antenna includes the patch directional antenna. The order and/or arrangement of the operations within FIGS. 17a and 17b are intended to be nonlimiting in scope.

FIG. 18 shows one embodiment of a directional antenna that is at least partially associated with a mobile node, the directional antenna can have it's directionality directed from a first position 2082 to a second position 2084, in an attempt to achieve a target position 2086 by which a network operational characteristic of a communication between the mobile node to at least a node can be improved. Adjustment techniques can be similar to as described in this disclosure. In certain embodiments, a desired directional antenna configuration can be determined according to the network operational characteristic (e.g., to improve a network operation of the directional antenna). In certain embodiments, a directional antenna directionality can be established at least partially according to a desired directional antenna direction. In certain embodiments, the directional antenna can be associated with, attached to, or integrated in the mobile node as described in this disclosure. Certain embodiments of the adjustment of the directional antenna can be performed at least partially within the directional antenna and/or at least partially within a mobile node (not illustrated in FIG. 18). Certain embodiments of the adjustment of the directional antenna can include, but is not limited to, adjusting the position, power, signal quality, signal to noise ratio, etc. of the directional antenna. Certain embodiments of the directional antenna can be configured to be transmitting and/or receiving directional antennas.

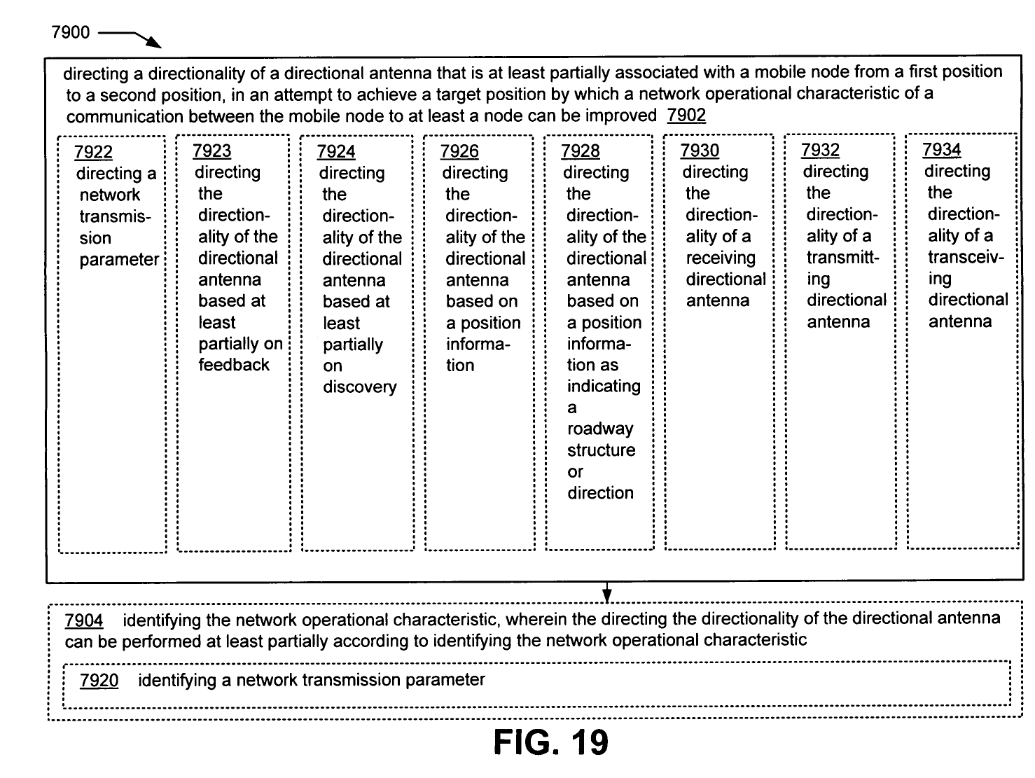

One embodiment of a high-level flow chart of the resolution conversion technique 7900 that is described with respect to FIG. 19 and which includes operation 7902 and optional operation 7904. One embodiment of the operation 7902 should include optional operations 7922, 7923, 7924, 7926, 7928, 7930, 7932, and/or 7934. One embodiment of operation 7904 could include optional operation 7920. The high-level flow chart of FIG. 19 should be considered in combination with the mobile directional antenna, as described with respect to FIG. 18. One embodiment of the operation 7902 can include, but is not limited to, directing a directionality of a directional antenna that is at least partially associated with a mobile node from a first position to a second position, in an attempt to achieve a target position by which a network operational characteristic of a communication between the mobile node to at least a node can be improved. For example, the directionality of the directional antenna is directed from the first position to the second position at least partially in the attempt to achieve the target position, at which the network operational characteristic is improved. One embodiment of the operation 7904 can include, but is not limited to, identifying the network operational characteristic, wherein the directing the directionality of the directional antenna can be performed at least partially according to identifying the network operational characteristic. For example, identifying the network operating characteristics. One embodiment of the identifying the network operational characteristic, wherein the directing the directionality of the directional antenna can be performed at least partially according to identifying the network operational characteristic of operation 7904 can include operation 7920, that can include but is not limited to identifying a network transmission parameter. For example, identifying the network transmission parameter, such as signal strength, signal power, signal-to-noise ratio, etc. One embodiment of the directing a directionality of a directional antenna of operation 7902 can include operation 7922, that can include but is not limited to directing a network transmission parameter. For example, directing the transmission parameter for a transmitting directional antenna. One embodiment of the directing a directionality of a directional antenna of operation 7902 can include operation 7923, that can include but is not limited to directing the directionality of the directional antenna based at least partially on feedback. For example, directing the directionality of the directional antenna based at least partially on feedback, similar to as described with respect to FIG. 12. One embodiment of the directing a directionality of a directional antenna of operation 7902 can include operation 7924, that can include but is not limited to directing the directionality of the directional antenna based at least partially on discovery. For example, directing the directionality of the directional antenna based at least partially on discovery, similar to as described with respect to FIG. 12. One embodiment of the directing a directionality of a directional antenna of operation 7902 can include operation 7926, that can include but is not limited to directing the directionality of the directional antenna based on a position information. For example, directing the directionality of the directional antenna based at least in part on the position information. One embodiment of the directing a directionality of a directional antenna of operation 7902 can include operation 7928, that can include but is not limited to directing the directionality of the directional antenna based on a position information as indicating a roadway structure or direction. For example, utilizing the position information such as direction of a roadway or highway to at least partially direct the directionality of the directional antenna. One embodiment of the directing a directionality of a directional antenna of operation 7902 can include operation 7930, that can include but is not limited to directing the directionality of a receiving directional antenna. For example, directing the directionality of the receiving directional antenna. One embodiment of the directing a directionality of a directional antenna of operation 7902 can include operation 7932, that can include but is not limited to directing the directionality of a transmitting directional antenna. For example, directing the directionality of the transmitting directional antenna. One embodiment of the directing a directionality of a directional antenna of operation 7902 can include operation 7934, that can include but is not limited to directing the directionality of a transceiving directional antenna. For example, directing the directionality of the transceiving directional antenna, that can both receive and transmit signals. A variety of flow charts are now described that describe various operations that can be performed using certain embodiments of the mobile directional antenna 10 or 14. The order and/or arrangement of the operations within FIG. 19 are intended to be nonlimiting in scope.

FIG. 20 shows one embodiment of a directional antenna 11 that is at least partially associated with a mobile node 12, the directing a directionality of a directional antenna from a first position 2082 to a second position 2084 can be in an attempt to achieve a target position 2086 by which a network operational characteristic of at least one communication between the first mobile node (which may or may not be the mobile node) to a second mobile node (which may or may not be the mobile node) can be improved. In certain embodiments, a desired directional antenna configuration can be determined according to the network operational characteristic (e.g., to improve a network operation of the directional antenna). In certain embodiments, a directional antenna directionality can be established at least partially according to a desired directional antenna direction. In certain embodiments, the directional antenna can be associated with, attached to, or integrated in the mobile node as described in this disclosure. Certain embodiments of the adjustment of the directional antenna can be performed at least partially within the directional antenna and/or at least partially within a mobile node (not illustrated in FIG. 20). Certain embodiments of the adjustment of the directional antenna can include, but is not limited to, adjusting the position, power, signal quality, signal to noise ratio, etc. of the directional antenna. Certain embodiments of the directional antenna 11 can be configured to be transmitting and/or receiving directional antennas.

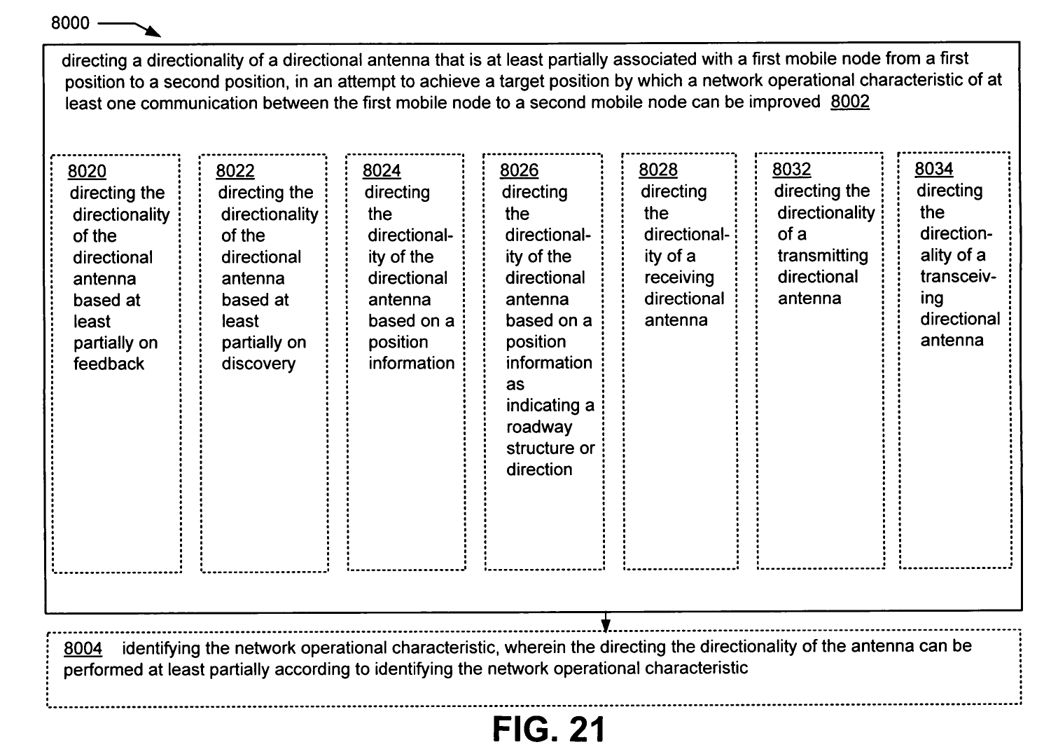

One embodiment of a high-level flow chart of the resolution conversion technique 8000 that is described with respect to FIG. 21 and which includes operations 8002 and 8004; in addition to optional operations 8020, 8022, 8024, 8026, 8028, 8032, and 8034. The high-level flow chart of FIG. 21 should be considered in combination with the mobile directional directional antenna, as described with respect to FIG. 20. One embodiment of operation 8002 can include, and is not limited to, directing a directionality of a directional antenna that is at least partially associated with a first mobile node from a first position to a second position, in an attempt to achieve a target position by which a network operational characteristic of at least one communication between the first mobile node to a second mobile node can be improved. For example, improving the network operational characteristic by directing the directionality of the directional antenna, as described with respect to FIGS. 9 to I1. One embodiment of operation 8004 can include, but is not limited to, identifying the network operational characteristic, wherein the directing the directionality of the directional antenna can be performed at least partially according to identifying the network operational characteristic. For example, identifying the network operational characteristic such as quality of signal, signal-to-noise ratio, transmit data, information, and/or a signal, etc. One embodiment of the directing a directionality of a directional antenna of operation 8002 can include operation 8020, that can include but is not limited to, directing the directionality of the directional antenna based at least partially on feedback. For example, directing the directionality of the directional antenna based at least partially on the feedback. One embodiment of the directing a directionality of a directional antenna of operation 8002 can include operation 8022, that can include but is not limited to, directing the directionality of the directional antenna based at least partially on discovery. For example, directing the directionality of the directional antenna based at least partially on the discovery. One embodiment of the directing a directionality of a directional antenna of operation 8002 can include operation 8024, that can include but is not limited to, directing the directionality of the directional antenna based on a position information. For example, at least partially utilizing the position information to direct the directionality of the directional antenna. One embodiment of the directing a directionality of a directional antenna of operation 8002 can include operation 8026, that can include but is not limited to, directing the directionality of the directional antenna based on a position information as indicating a roadway structure or direction. For example, considering the direction of the road or highway as the position information. One embodiment of the directing a directionality of a directional antenna of operation 8002 can include operation 8028, that can include but is not limited to, directing the directionality of a receiving directional antenna. For example, the directional antenna includes the receiving directional antenna. One embodiment of the directing a directionality of a directional antenna of operation 8002 can include operation 8032, that can include but is not limited to, directing the directionality of a transmitting directional antenna. For example, the directional antenna includes the transmitting directional antenna. One embodiment of the directing a directionality of a directional antenna of operation 8002 can include operation 8034, that can include but is not limited to, directing the directionality of a transceiving directional antenna. For example, the directional antenna includes the transceiving directional antenna, that can both receive and/or transmit. A variety of flow charts are now described that describe various operations that can be performed using certain embodiments of the mobile directional antenna 10 or 14.

A number of embodiments of flow charts are now described which describes a variety of the operations of the mobile directional antenna. These operations are intended to be illustrative in nature, but not limiting in scope. Certain ones of the flow charts and general vehicle or mobile directional antenna configurations, as now described, relate to a variety of the illustrative but non-limiting communication techniques and/or mechanisms that could be provided by a variety of the nodes (either mobile or fixed), which could include certain ones of the mobile directional antenna 10 or 14.

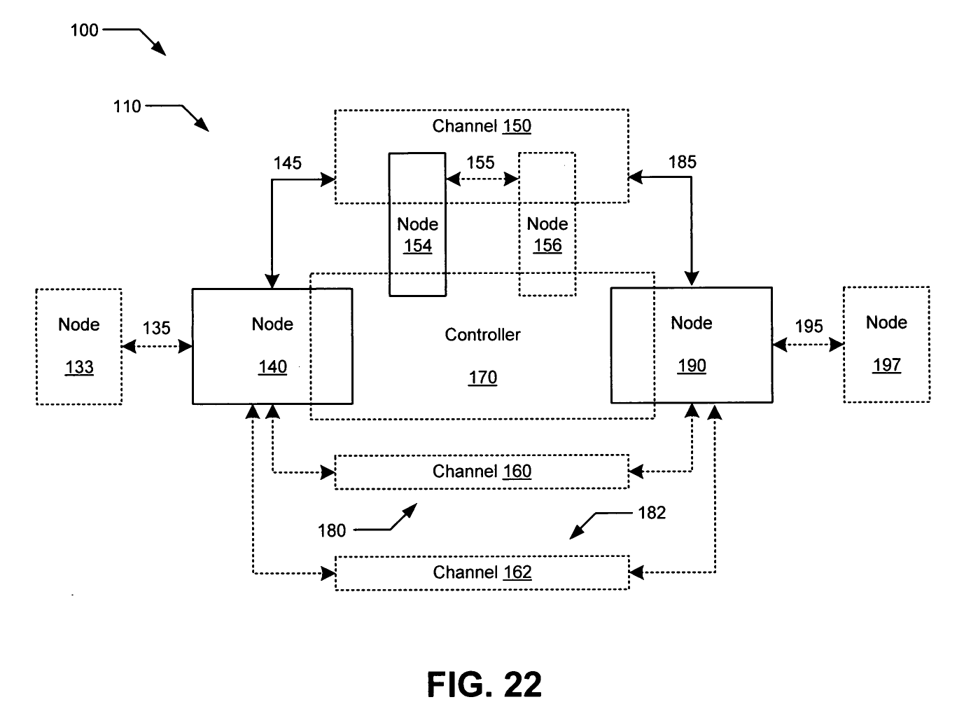

A generalized embodiment of the communication network 100 is now described. FIG. 22 shows a schematic diagram of a communication network 100 having a subsystem 110 with data routed via a route 180 between a node 140 and a node 190, which can be physically separated or remote from one another (separated by some fraction of a meter, or more). The route 180 can include channel 150 or one or more parallel channels 160 that could transport at least one signal 72 as described with respect to FIG. 1. In certain embodiments, the channel 150 that could transport at least one signal 72 can be arranged in series with an upstream wireless link 145 and a downstream wireless link 185. In certain embodiments, the channel 150 that could transport at least one signal 72 can include a node 154 through which the channel 150 passes or extends. Certain embodiments of the channel 150 that could transport at least one signal 72 may also include one or more of the in-channel links 155, and one or more additional channel nodes 156. In certain embodiments, the subsystem 110 can optionally include a channel controller 170 that can include a circuitry of the node 140, the node 190, or the in-channel node(s) 154, 156 as shown and described in this disclosure. In certain embodiments, the channel controller 170 can be composed partially, or entirely, outside of all intermediate nodes available for routing the data

As described in this disclosure, certain embodiments of the route 180 can also include a linkage 135 that is communicationally associated with one or more source nodes 133. In certain embodiments, the one or more source nodes 133 can be operationally situated outside of the communication network 100. In certain embodiments, the route 180 can likewise include a linkage 195 that can be communicatingly associated with a one or more destination node(s) 197. In certain embodiments, the one or more destination node(s) can be situated operationally outside of the communication network 100. In certain alternate or additional embodiments, the node 140 can communicate with the node 190 at least in part by one or more other routes 182 such as by a channel 162.

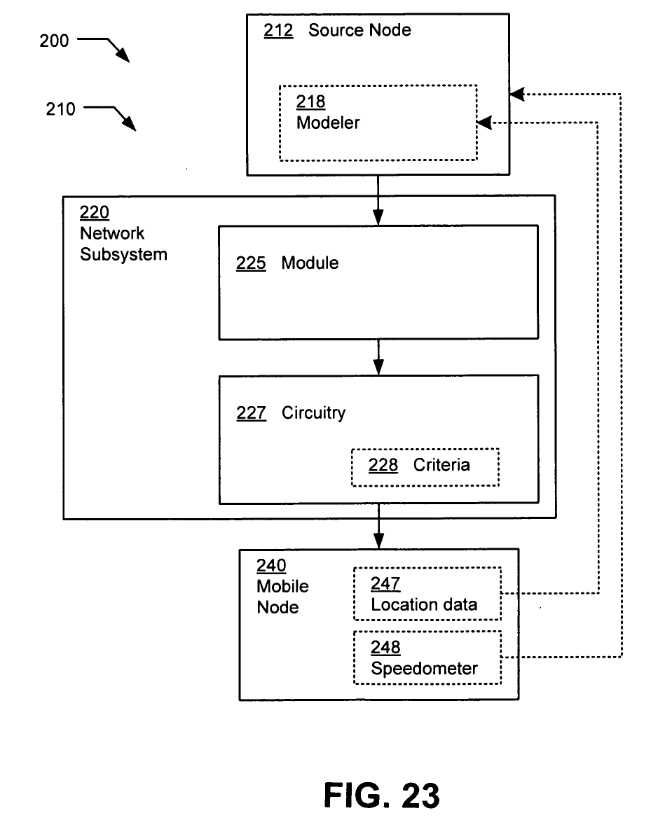

Referring now to FIG. 23, one embodiment of the communication network 100 in a schematic form, can include a network subsystem 220 that can interact with, or become part of, a signal route 210. In certain embodiments, the signal route can extend from a source node 212 to a mobile node 240. In certain embodiments, the source node 212 can be configured to receive information from an information input source that can include, but is not limited to, a speedometer 248, a GPS unit, a radar unit, or another information indicator of the mobile node 240. In certain embodiments, the mobile node 240 can also provided location data to a modeler 218 that can be least partially integrated within the source node 212. As such, a modeler 218, including the source node 212, can receive location data 247 from the mobile node 240. Certain embodiments of the network subsystem 220 can include a module 225 that can be configured to receive data directly or indirectly from the source node 212 and to provide information to the circuitry 227. Certain embodimets of the circuitry 227 can optionally be configured as to apply one or more criteria 228 to the data in determining how, when, or where to transmit the data, as explained below.

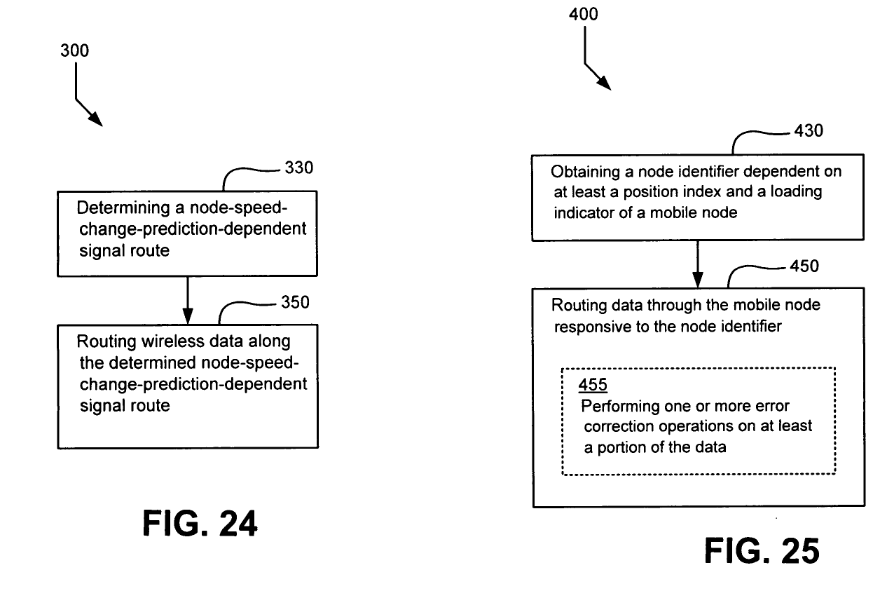

In certain embodiments of the communication network 100, information can be transferred between one or more source node(s). For example, FIG. 24 shows an embodiment of a flow chart 300 that facilitate a desirable form of information transfer such as data transfer. Certain embodiments of the operational flow chart 300 can include a determining operation 330 and a routing operation 350. In certain embodiments, the flow chart 300 may include a “prediction” or predictive value may be utilized that can include a variety of information such as information or data relating to one or more of a time-dependent function, a quantity, an identifier, a single Boolean value, a prose description, a probabilistic model of future or other uncertain attributes or behaviors, and/or some other characterization of a prediction. As described below, certain embodiments of the operation 330 and/or the operation 350 can be performed at least partially by the source node 212, or alternately by the network subsystem 220 as described with respect to FIG. 23. More generally, flow charts described herein need not occur in the prescribed order, and in certain cases may warrant some interspersion or other overlap with other operations.

FIG. 25 shows an alternative embodiment of a flow charts 400 that can be configured to facilitate another desirable form of data transfer. Certain embodiments of the flow charts 400 can include an obtaining operation 430 and to a routing operation 450. As described below, certain embodiments of operation 430 and/or operation 450 can be performed by the source node 212 or alternately by the network subsystem 220 as described with respect to FIG. 23. Certain embodiments of the operations 430 and/or 450 can likewise be performed by controller 170 or by any of several nodes as described with respect to FIG. 22. Certain embodiments of the node 190 can perform a variant of the flow chart 400, for example, by including as a portion of the routing operation 450 an operation 455 that can include performing one or more error correction operations on at least a portion of the data. In our correction operations may be desired to ensure that the data and/or information which can be transmitted by at least one transmitting node that corresponds to the data and/or information that is received by at least one receiving node.

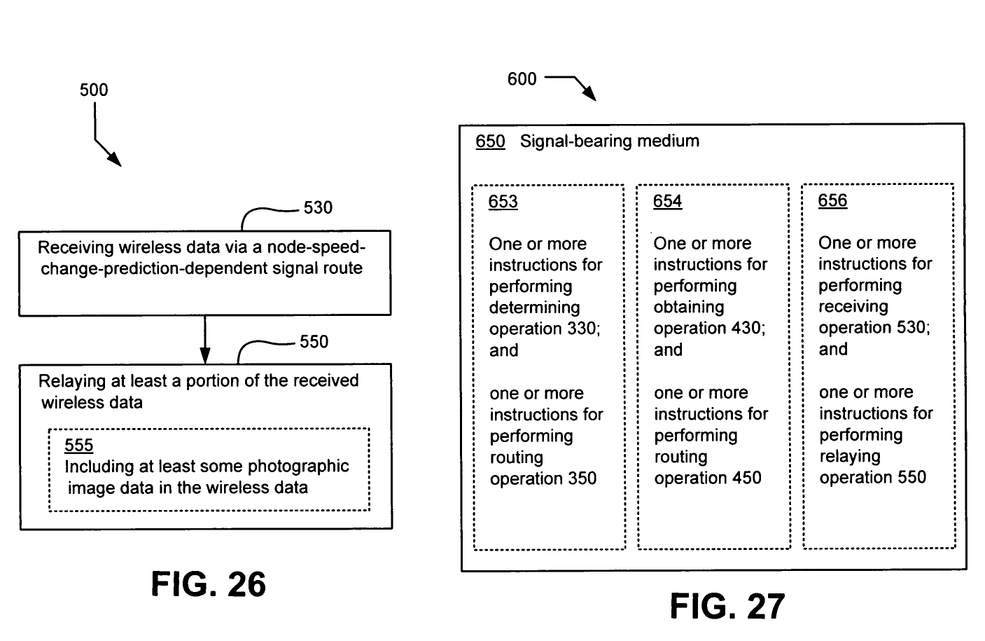

Certain embodiments of the mobile directional antennas as described in this disclosure with respect to FIGS. 1, 6, etc. can be configured to enhance, allow, improve, optimize, and/or provide a data transfer between multiple nodes, and in certain embodiments at least some of the nodes being directional. FIG. 26 shows another embodiment of an alternative flow chart 500 having operations that facilitate another desirable form of data transfer. Certain embodiments of the flow chart 500 can include a receiving operation 530 and a relaying operation 550. As described below, certain embodiments of the operation 530 and operation 550 can be performed by the source node 212 or alternately by the network subsystem 220 as described for example with respect to FIG. 23. Certain embodiments of the operations 530 and/or 550 can likewise be performed by controller 170, by certain of several nodes of FIG. 22, or by a combination of more than one of these. Certain embodiments of the controller 170 can perform a variant of flow chart 500 by including as at least a portion of the relaying operation 550 a photographic operation 555, which operates by including at least some information and/or data, that can in certain embodiments be in the form of wireless-transmitted data.

Certain embodiments of the communication network 100, as described with respect to FIGS. 22 and 23, can utilize a look-up mechanism but which data or information that may be at least partially contained in a memory, database, or other memory storage element associated with the communication network 100 can be accessed and/or looked-up. The particular embodiment(s) of look-up circuitry, table(s), mechanism(s), operation(s), and/or technique(s) as described in this disclosure are intended to be illustrative in nature, and not limiting in scope. Certain embodiments of look-up mechanisms are commercially available. Certain embodiments of a circuitry 770 can include a controller 778 having a memory 779 operable to contain one or more instructions that when executed cause the controller 778. For example, certain embodiments of the instruction(s) can include machine code for transferring a portion of the wireless data to or from a register. Certain embodiments of the circuitry 770 can likewise include one or more circuitry 771 for implementing a look-up table having a speed as an operand, circuitry 772 for implementing a time-dependent traffic model, circuitry 774 for implementing a location-dependent speed model, or circuitry 775 for implementing a vehicle-dependent speed model. In one embodiment, the circuitry 772 for implementing a time-dependent traffic model includes circuitry 773 for implementing a look-up table having a time as an operand. More generally, circuitry 770 can include logic 776, such as logic 777 for implementing a look-up table. For example, logic 777 can include logic for accessing a storage element containing part of or the entire table.

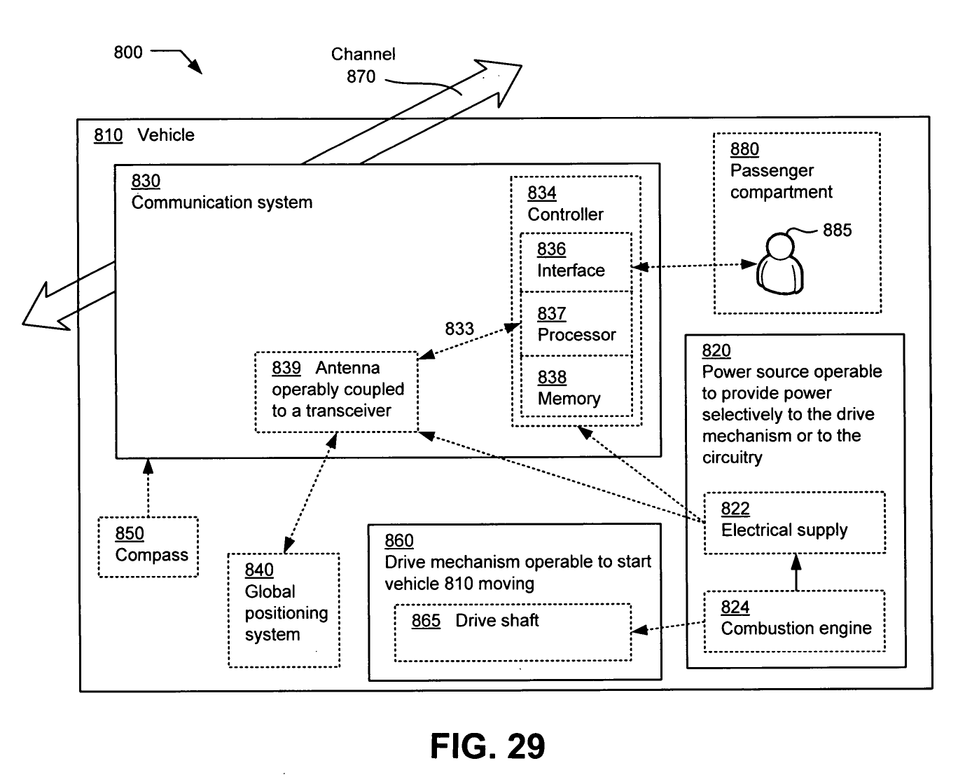

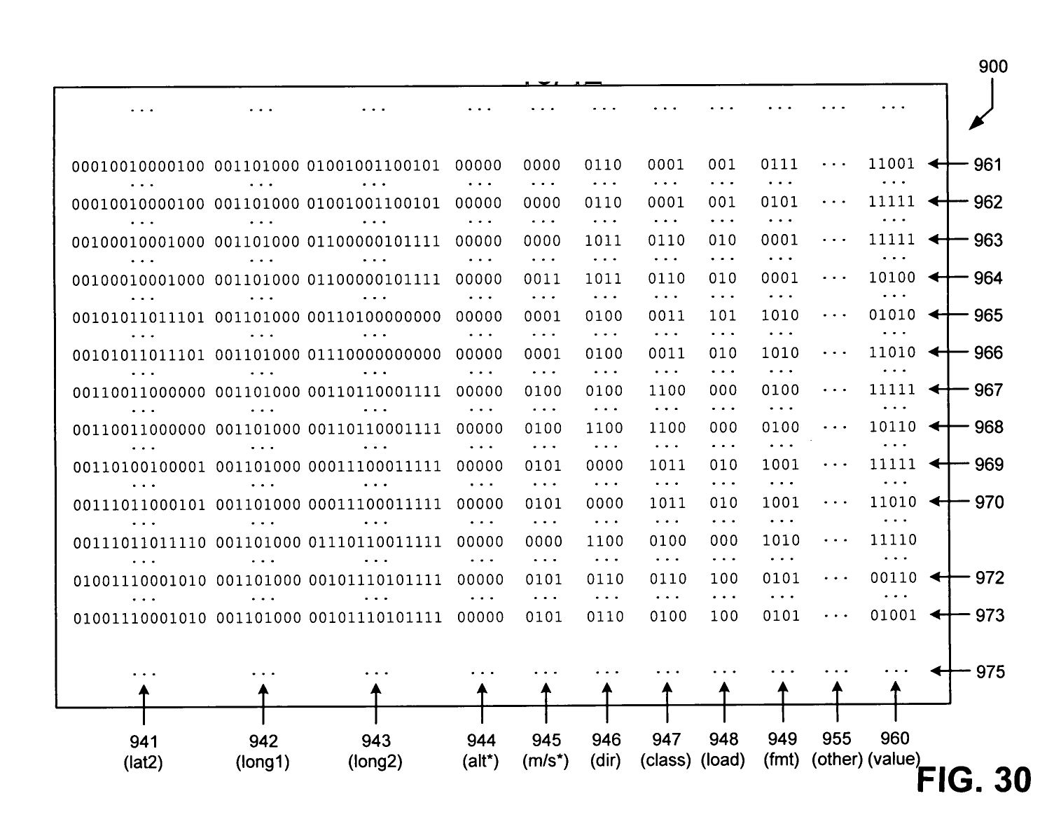

Certain embodiments of the mobile directional antenna 10 or 14 can be configured to transmit and/or receive information, data, signals, etc. as described with respect to FIGS. 22 and 23, and also as described with respect to FIG. 29. FIG. 29 illustrates an embodiment of the vehicle 11. Any or all of the nodes of FIG. 22 can be embodied as the vehicle 11, for example. The vehicle 11 includes a communication network 830, a drive mechanism 860 operable to start the vehicle 11 moving, and a common power source 820. Power source 820 can be operable to provide power selectively to drive mechanism 860 (optionally via drive shaft 865) or to the circuitry such as the communication system 830. For example, certain embodiments of the power source 820 can include a combustion engine 824 that can be operable to provide power to the drive shaft 865 and to an electrical supply 822 of the power source 820. Certain embodiments of the electrical supply 822 can selectively provide power to the controller 834 and/or to the mobile directional antenna 10 or 14, (which one embodiment can include the vehicle directional antenna operably coupled to a transceiver). Certain embodiments of the controller 834 can include a processor 837 that can be operably coupled to an interface 836 and a memory 838. Certain embodiments of the mobile directional antenna 10 or 14 can be operably coupled to the controller 834 (e.g., to the processor 837 within the controller) such as at leat partially via a conduit 833.

Certain embodiments of the interface 836 can be accessible to a user 885 that can travel within the vehicle, e.g., a driver, operator, passenger, pilot, etc. within a passenger compartment 880 of the vehicle 11. Certain embodiments of the interface 836 may be configured to allow the vehcile's operator, driver, passenger, etc. to at least partially operate, drive, monitor, or perform other operations with respect to the vehicle 11. Certain embodiments of the interface 836 can be configured as a graphical user interface, a driver's interface, etc. Other embodiments of the interface 836 can be configured with more traditional gauges, meters, electromechanical-based, optical-based, computer-based (relying on hardware, software, and/or firmware), mechanical-based, chemical-based, and/or other known interface device(s) that have been used to indicate operations of the vehicle 11.

Certain embodiments of the vehicle 11 may be operated by and/or controlled by a variety of users 885 depending upon the type of the vehicle. In certain embodiments, the user 885 can be a driver, a pilot, an operator, a captain, or a passenger. Certain embodiments of the memory 838 can be configured as the signal-bearing medium 650, in any of the illustrative but non-limiting configurations as described with respect to FIG. 27. Certain embodiments of the processor 837 can thus perform one or more of the flow charts 300, 400 or 500 as described herein. Certain embodiments of the controller 834 can include at least one general purpose and/or specific purpose computers, such as are generally known and are commercially available that may utilize at least one of software, hardware, and/or firmware.

Certain embodiments of the flow chart 800 can include the mobile directional antenna 10 or 14 for receiving communication information such as from a signal route (e.g., at least partially over the channel 870); and circuitry (e.g., at least partially utilizing the controller 834) that can be configured for relaying at least a portion of the communication information. There are a variety of embodiments of the mobile directional antennas that are generally understood by those skilled the art, and may be commercially available. For example, certain embodiments of the mobile directional antenna 10 or 14 can include passive and/or active aspects. Certain embodiments of the mobile directional antenna 10 or 14 can be operable in association with a transmitter to transmit signals, information, data, etc. Certain embodiments of the mobile directional antenna 10 or 14 can be operable in association with a receiver to receive signals, information, data, etc. Certain embodiments of the mobile directional antenna 10 or 14 are operable with a transceiver to both transmit and receive signals, information, data, etc. Additionally, a variety of types, powers, configurations, operational characteristics, etc. of directional antennas are commercially available such as could be selected by a designer based, at least in part, on such factors as the vehicle's 11 size, directional antenna operations, supportable directional antenna dimensions, etc.

In general, the vehicle(s) 11 (whether configured to operate on land, in air, in space, or in water) as described with respect to FIGS. 1, 2, 3, 4, 5, 6, or elsewhere in this disclosure, can move by definition. Many embodiments of the vehicle 11 can at least partially utilize a motive mechanism to propel the vehicle; while other embodiments of the vehicle 11 can be at least partially human, solar, and/or other energy powered. Certain embodiments of the power source 820 that can provide at least some of the power to move the vehicle 11 (e.g., the motive force) can be operable to provide power selectively to the drive mechanism 860. In certain embodiments, the drive mechanism may be connected to a drive shaft 865 and/or to the circuitry of the controller 834. Certain embodiments of the vehicle 11 can further include a combustion engine 824, (and/or other motive source) to at least partially provide motive power to the vehicle 11. Certain embodiments of the drive mechanism can be operatively coupled, via electrical supply 822, e.g., to provide power to the circuitry.

In certain embodiments, a positioning mechanism can be provided such as a GPS 840, a compass 850, radar, etc. In certain embodiments, the positioning mechanism can be operably coupled (e.g., via a short range wireless connection to mobile directional antenna 10 or 14, a direct wired-based connection, and/or another connection) such as to transmit position information to another location of the vehicle 11. In certain embodiments, a direct and/or indirect output of the positioning mechanism may be provided as a signal to the processor 837 as to be computed by the processor. In certain embodiments, the positioning mechanism can be at least partially included in the vehicle 11, while in others it can be at least partially remote or outside of the vehicle and transmit its indications to the vehicle.

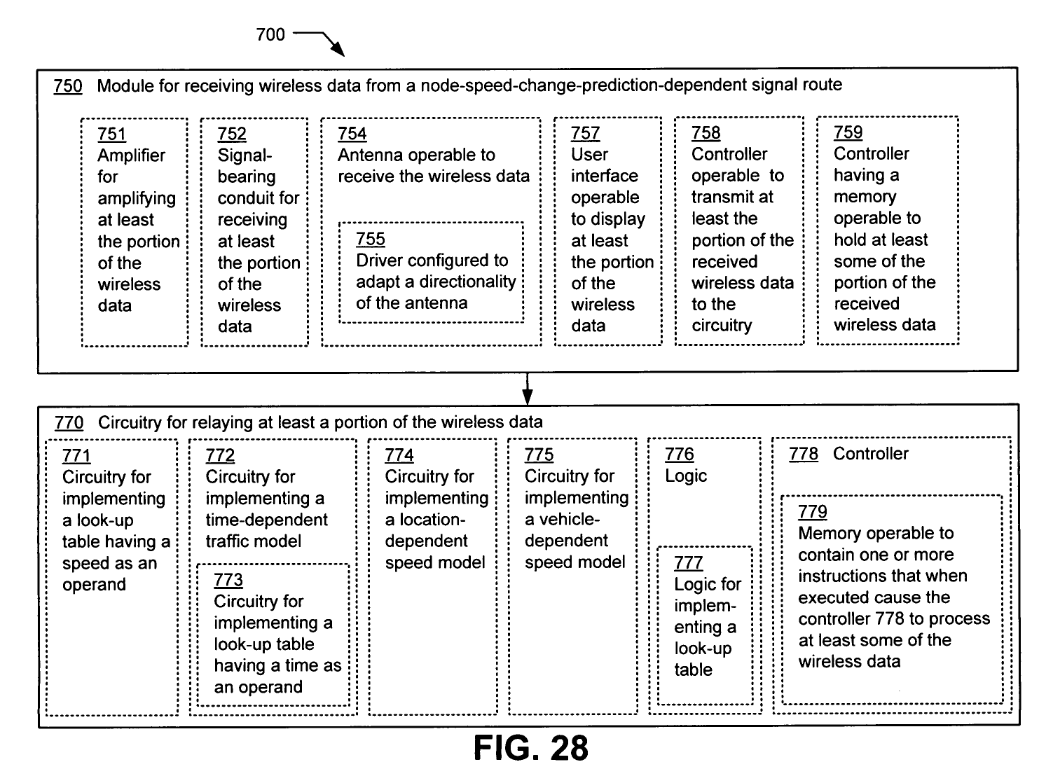

Certain embodiments of a look-up table can be configured to provide values, information, and/or data that corresponds to operands, as described in this disclosure. FIG. 30 shows one embodiment of the look-up table 900 and its associated operands that can be accessed, e.g., by the circuitry 771 as described with respect to FIG. 28. Certain embodiments of the look-up table can be used for determining a suitability value 960 at least partly based on each of several operands including operand 941 through operand 949. The configuration, operand values, operand structures, and other aspects of the look-up table as described with respect to FIG. 30 are intended to be illustrative in nature, and not limiting in scope. Certain embodiments the table 900 can be implemented at least partially by the logic 777 as described with respect to FIG. 28, which can be in the form of firmware, software, and/or hardware. Alternatively, in certain embodiments of the vehicle 11, as described with respect to FIG. 29, the table 900 can be maintained and/or stored in the memory 838 such as a hard drive, a floppy drive, a storage device, and/or a flash memory.

Certain embodiments of the operand 941 as described with respect to FIG. 30 can represent, e.g., a fractional-degree portion of a latitude coordinate. Certain embodiments of the operand 942 can represent, e.g., a whole-degree portion of the longitude coordinate. Certain embodiments of the operand 943 can represent a fractional-degree portion of the longitude coordinate complementing operand 941. Certain embodiments of the operand 944 can represent an altitude expressed in meters relative to ground or sea level, providing for those embodiments of the vehicle(s) 11 that can include altitude-dependent suitability indicators, such as aircraft or certain land or sea vehicles. Certain embodiments of the operand 945 can represent a speed or velocity of a node, which can be measured either relatively to some other vehicle 11 or network device, or absolutely relatively to the Earth or some loction thereon, or relative to some other structure or location. Certain embodiments of the operand 944 and/or the operand 945 can be operable with certain embodiments of computers of controllers, and can in certain embodiments be marked in some manner recognizable by computers or controllers (e.g., with asterisks). In certain instances, such marking can indicate an exponential scale in which each binary number may be taken to be a power of 2. For the operand vector of row 973, for example, the indicated altitude can therefore be approximately 2 to the power of 0 (=1) as measured in meters above the ground, and the indicated speed can be approximately 2 to the power of 6=64 meters per second.

Certain embodiments of the operand 946 can be representative of a node heading in which (magnetic) North=0000 and the other compass points increase clockwise to 1111 (NNW), or some other directional convention. Certain embodiments of the operand 946 can be, for example, ignored, however, for rows in which operand 945=0000. In certain embodiments, speeds of 1 meter per second or less are treated as being stationary, in this model. Certain embodiments of the operand 949 can be an information format indicator, which can be encoded to indicate video, audio, proprietary, encoded, or any of the other format-indicative descriptors used in this document as a matter of design choice in light of present teachings. Additional operands 955 can also be used in determining suitability value 960.

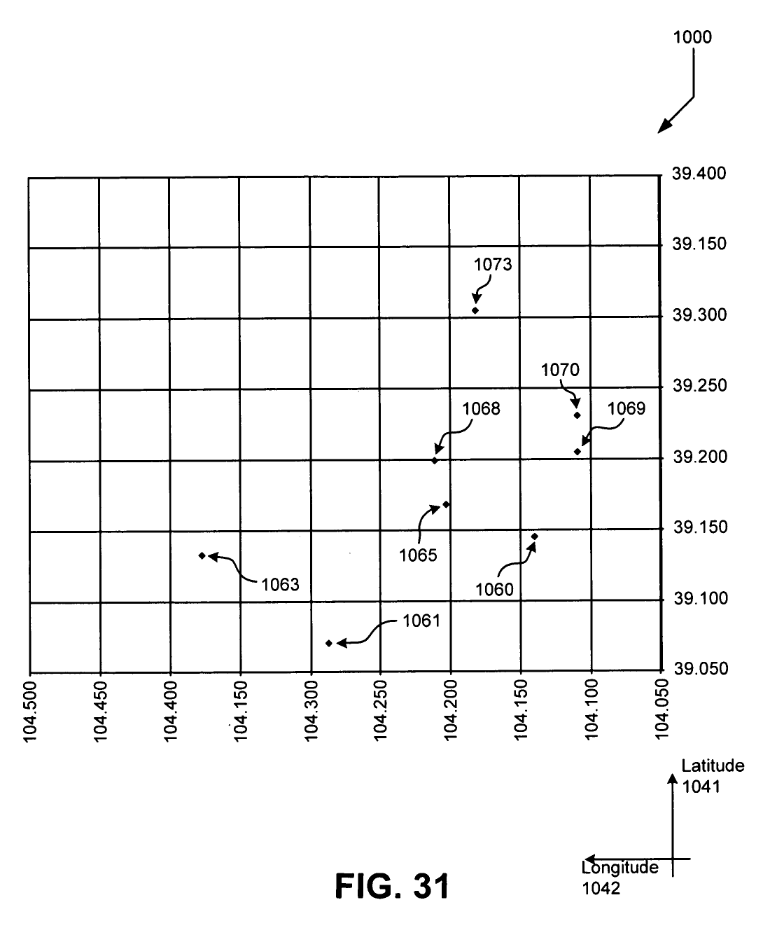

Certain embodiments of the vehicles 11, such as described with respect to FIG. 29, can provide or display position information to the driver, passenger, pilot, or other occupants of the vehicle. Referring now to FIG. 31 in light of FIG. 30, certain embodiments of FIG. 31 can depict a map 1000 that can be utilized to plot latitude 1041 against longitude 1042. A location of each of node 1060 through node 1073 as described with respect to FIG. 31 can also be plotted on the map 1000, some or all of the nodes are suitable for relaying such information as position information. In certain embodiments, the position information can be associated with the vehicle 11 to provide information as to where each vehicle (or some equipment associated therewith) may be situated. One illustrative node 1061, for example, is shown at 39.070 degrees North, 104.287 degrees West, for example, in this detailed illustration. Referring again to FIG. 30, row 961 corresponds to operands that describe illustrative node 1061. Node 1061 can therefore be essentially stationary, as indicated by the 0000 in the column of operands 945.

Row 962 can be similar to row 961 except for the data format (at column 949, e.g.) and the suitability value (at the column of values 960). Row 961 can have a suitability value of 11001, a binary number that indicates a high suitability. Row 962 can indicate an even higher suitability, though, illustrating that the model implemented in table 900 has a format-dependent suitability indicator at the column of values 960.

Row 963 of FIG. 30 can correspond to illustrated operands that describe node 1063 of FIG. 31. Row 963 and row 964 illustrate that the model implemented in table 900 has a speed-dependent suitability indicator (in the column of values 960), having operand values that are similar except for illustrated speed (in the column of operands 945). Therefore the suitability indicator of node 1063 as illustrated might decrease (from 11111 to 10100, according to table 900) if the illustrated speed of node 1063 were about 8 meters per second rather than being about 1 meter per second.

Row 965 of FIG. 30 might correspond to illustrated operands that describe node 1065 of FIG. 31. Operand 948 can as illustrated be a binary load indicator such that 000 indicates no loading and 111 indicates saturation, in terms of a fractional usage of a critical resource such as a maximum data transfer rate and/or a reduction of available space in a memory such as memory 838 in the embodiment of FIG. 29 described above. Row 965 and row 966 illustrates that the model implemented in table 900 has a load-dependent suitability indicator, and can have operands that are similar except for, e.g., load (in the column of operands 948). Therefore the suitability indicator of node 1065 would increase (from 01010 to 11010, according to table 900) if the load indicator of node 1065 were 010 rather than being 101.

Row 968 of FIG. 30 can in certain embodiments correspond to operands that describe node 1068 of FIG. 31. Row 967 and row 968 illustrate that the model implemented in table 900 has a heading-dependent suitability indicator (in the column of values 960), having operand values that are similar except for heading (in the column of operands 946). Therefore the suitability indicator of node 1068 could increase (from 10110 to 11111, according to table 900) if the heading of node 1068 were eastward (dir=0100) rather than westward (dir=1100).

Rows 969 & 970 of FIG. 30 can as illustrated correspond respectively to operands that describe nodes 1069 & 1070 of FIG. 31. Rows 969 & 970 illustrate that the model implemented in table 900 could have a position-index-dependent suitability indicator (in the column of values 960), having illustrated operand values that are similar except for latitude (in the column of operands 941). Node 1069 and node 1070 as illustrated are both traveling north at about 32 m/s. The suitability indicator of node 1069 is higher than that of node 1070, according to table 900, just because it is not as far north.

Row 973 of FIG. 30 can correspond to operands that describe node 1073 of FIG. 31. Operand 947 may be a node class indicator corresponding to attributes of a given node that affect its ability to provide service. Operand 947 can indicate some combination of a nominal directional antenna range, a nominal transmitter power, a nominal bandwidth, a nominal gain-bandwidth product, a nominal data rate, a wireless protocol, a service provider, or a service level, for example. In one implementation, operand 947=0011 uniquely indicates a combination of node attributes that include a nominal operating frequency of 900 MHz and/or 1,800 MHz and an unlimited-duration service. Other values of operand 947 shown indicate no such nominal operating frequency and/or limited-duration service, for example, when table 900 may be used in any of the above-described flow chart.

Row 972 and row 973 illustrate that certain embodiments of the model, as implemented in table 900, could include a load-dependent suitability indicator, having operand values that are similar except for node class (in the column of operands 947). Therefore certain embodiments of the suitability indicator of node 1073 could decrease (e.g., from 01001 to 00110, according to table 900) if the class of node 1073 were 0110 rather than being 0100.

The contents and/or configurations of the rows are intended to be illustrative in nature. Table 900 can be of any consiguration such as large, small, regular, irregular, etc. In fact, in some contexts it would be convenient to use a simpler model as the table. One embodiment of a mechanism to establish the table could be to implement a table in a stationary router for a given area of land, and to utilize a local model that assumes a local value of one or more position indices within a zone (by omitting column of operands 942, for example). Part of the model can be executed before looking up the suitability value, alternatively or additionally, such as by using a route that includes one or more predicted speeds to predict a location at a given future point in time. By using a prediction that has been computed in a prior computational operation, for example, the heading or speed operands can be omitted from the look-up operation.

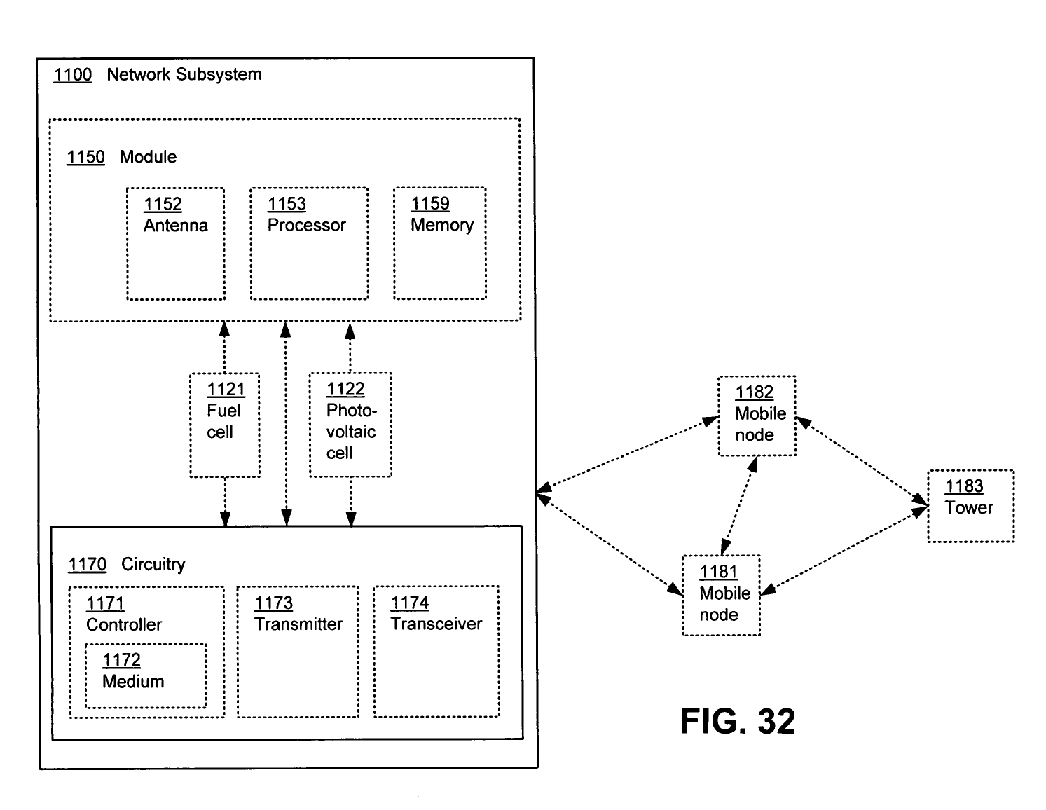

Certain embodoments of the network subsystem can be utlilized. For example, FIG. 32 illustrates a schematic embodiment of the network subsystem 1100 that can include a module 1150 and circuitry 1170. Module 1150 can be configured for receiving and/or transmitting information (which may include communication information and/or position information), from certain embodiments of a signal route and can include certain embodiments of circuitry 1170. Certain embodiments of the module 1150 can be configured for relaying at least a portion of the information. Certain embodiment of the subsystem 1100 can further include a power source (or a partial, additional, or accessory power source) such as a fuel cell 1121 or photovoltaic cell 1122 that could be operatively coupled to provide power to the components of circuitry 1170 or module 1150. Certain embodiments of the module 1150 can include, but may not not limited to: an directional antenna 1152, a processor 1153, or a memory 1159.

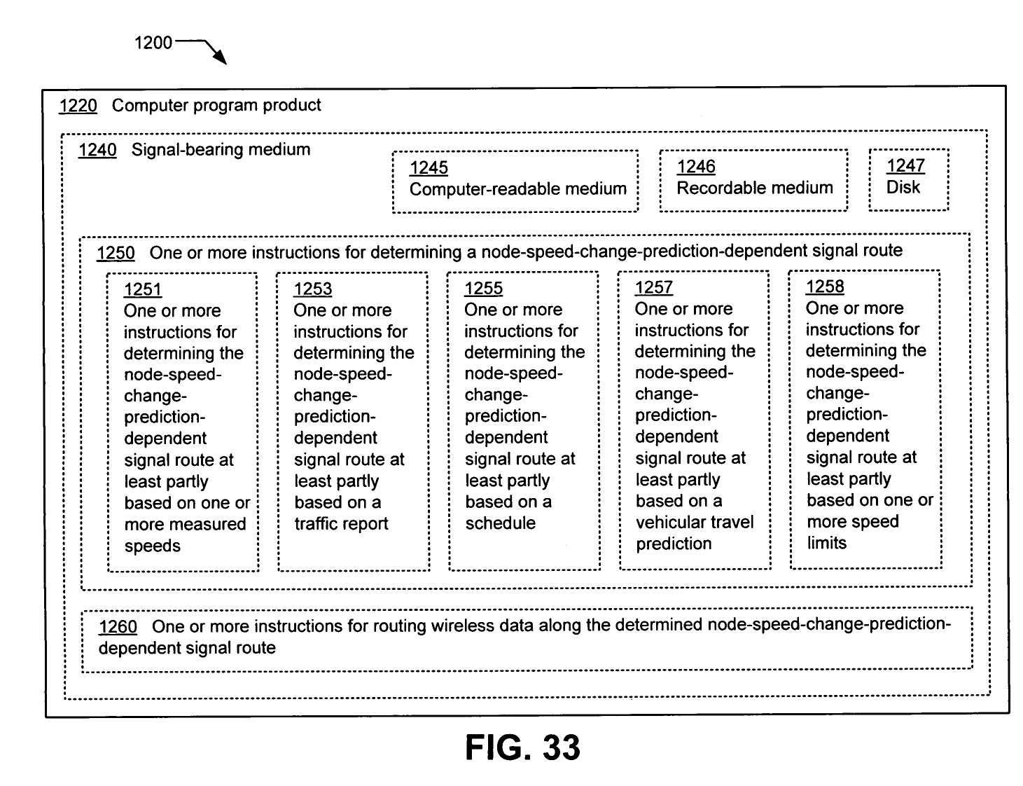

Certain embodiments of the circuitry 1170 can include a transmitter 1173 and/or transceiver 1174, and can be operable to communicate with at least one of the mobile node 1181 and/or 1182. For example, certain embodiments of the transceiver can receive the position index and the loading indicator, which processor 1153 can use to generate the node identifier of whichever of the available nodes (of mobile node 1181 and mobile node 1182, e.g.) may be suitable for relaying a signal to a stationary node (tower 1183, e.g.). Certain embodiments of the circuitry 1170 can also include a controller 1171, which can optionally have access to a medium 1172 configured similarly or identical to medium 1240 of FIG. 33. Alternatively, certain embodiments of the medium 1172 can be a transmission medium or a reception medium (such as a conduit) or a medium of communication (such as a display, e.g.).

Referring now to FIG. 33, there is shown a system 1200 (which can, e.g., be configured as the network subsystem 1100 or a computer program product 1220) that can include at least a signal-bearing medium 1240. Certain embodiments of the signal bearing medium 1240 can, for example, include one or more of an optical, electromagnetic, magnetic, and/or other media that can be configured in hardware, firmware, or software as a computer-readable medium 1245, a recordable medium 1246, and/or a disk 1247. Certain embodiments of the computer-readable medium 1245, the recordable medium 1246, and/or the disk 1247 can store, recall, access, retrive, or otherwise maintain one or more determining instruction(s) 1250, or one or more routing instruction(s) 1260. Certain embodiments of the determining instruction(s) 1250 can be one or more instructions for determining a node-speed-change-prediction-dependent signal route. Certain embodiments of the instruction set can include one or more of instruction(s) 1251, instruction(s) 1253, instruction(s) 1255, instruction(s) 1257, or instruction(s) 1258, which are intended to be illustrative nature and not limiting scope. Certain embodiments of the instruction(s) 1251 refer to one or more instructions that can be utilized for determining the node-speed-change-prediction-dependent signal route at least partly based on one or more measured speeds. Certain embodiments of the instruction(s) 1253 can refer to one or more instructions for determining the node-speed-change-prediction-dependent signal route at least partly based on a traffic report. Certain embodiments of the instruction(s) 1255 can refer to one or more instructions for determining the node-speed-change-prediction-dependent signal route at least partly based on a schedule. Certain embodiments of the instruction(s) 1257 can refer to one or more instruction(s) for determining the node-speed-change-prediction-dependent signal route at least partly based on a vehicular travel prediction. Certain embodiments of the instruction(s) 1258 refers to one or more instructions for determining the node-speed-change-prediction-dependent signal route at least partly based on one or more speed limits. One or more routing instruction(s) 1260 can refer to one or more instruction(s) for routing wireless data along the determined node-speed-change-prediction-dependent signal route.

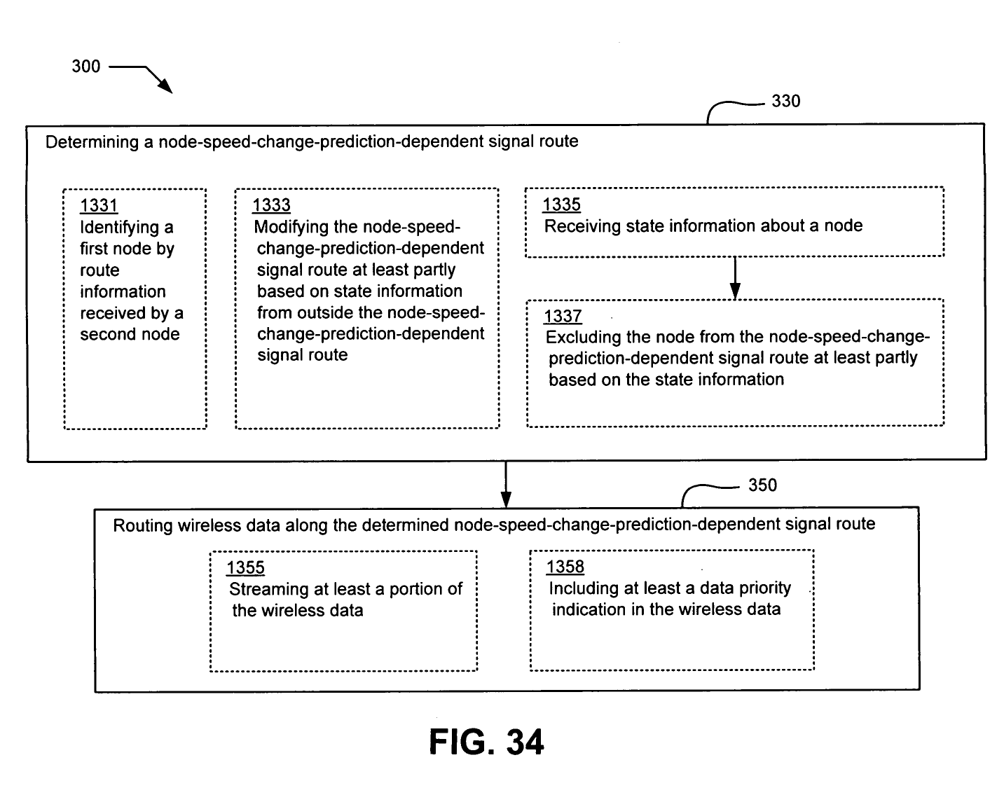

Referring now to FIG. 34, there are shown several variants of flow chart 300 of FIG. 24. For example, the operation 330 of the flow chart 300 can include one or more of operation 1331, operation 1333, operation 1335, or operation 1337. Operation 1331 includes identifying a first node by route information received by a second node. Operation 1333 includes modifying certain embodiments of the node-speed-change-prediction-dependent signal route at least partly based on state information. In this disclosure, an item “outside” a route or set may not be limited to permanently excluded items, but also could refer to candidates for inclusion within the route or set., e.g. Certain embodiments of a flow chart is also shown including operation 1335 of receiving state information about a node and operation 1337 of excluding the node from the node-speed-change-prediction-dependent signal route at least partly based on the state information.

At least certain ones of the features as described in this disclosure can optionally be used in combination with any of the variants of the operation 350. Certain embodiments of the operation 350 can include an operation 1355 of streaming at least a portion of the wireless data. The data streaming may not be limited to directing unidirectional data flow chart in a single channel, but can include any technique for handling data at one or more stages in a steady and continuous stream, typically facilitated by buffering and/or multiplexing at least some of the data. Alternatively or additionally, operation 350 can include an operation 1358 of including at least a data priority indication in the wireless data. A high priority may indicate that the data may be of a time-sensitive nature, that the data may be likely to be relatively small, or that the sender, owner or receiver has a high status relative to that of some other messages.

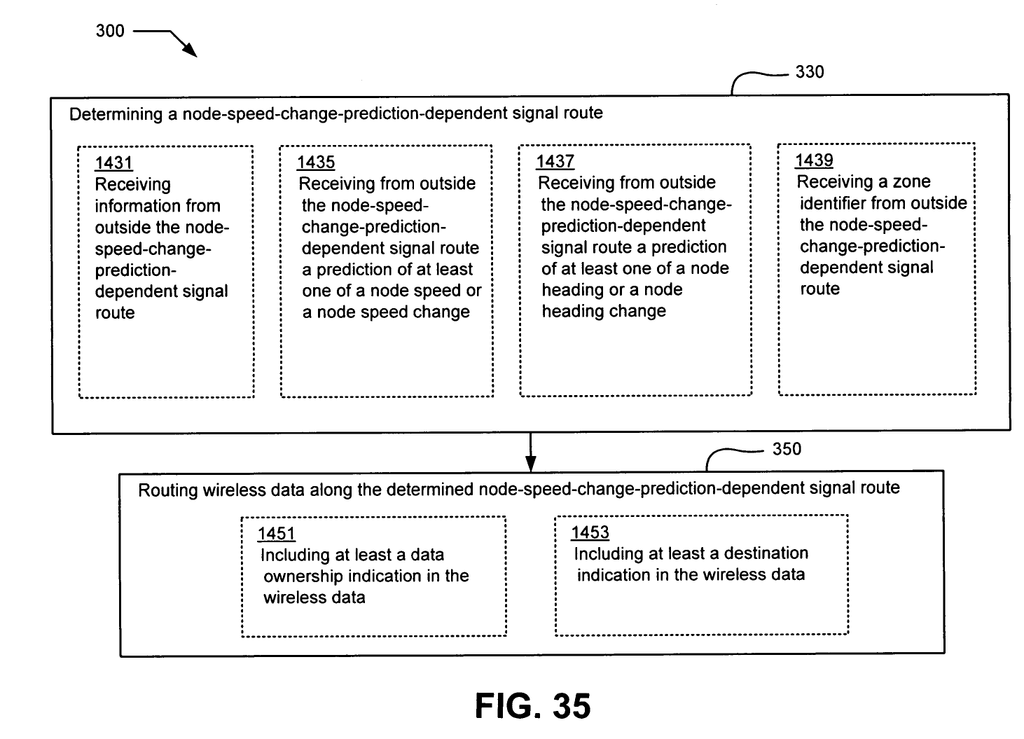

Referring now to FIG. 35, there are shown several other variants and optional features of flow chart 300 of FIGS. 24 & 34. For example, the operation 330 of the flow chart 300 can include one or more of certain embodiments of operation 1431, operation 1435, operation 1437, or operation 1439. Operation 1431 includes receiving information from outside the node-speed-change-prediction-dependent signal route. In performing flow chart 300, node 140 can receive state information from node 154 in FIG. 22, for example, indicating that node 154 may be expected to be stopped and unavailable for service imminently. If certain embodiments of the node 140 receives a transmission along the route 180 that only includes a linkage 135 from source node 133 to intermediate node 140, for example, node 140 can then respond by appending a channel such as channel 160 to the route 180 responsive to the node speed change prediction from node 154.

Alternatively or additionally, node 140 can receive from outside the node-speed-change-prediction-dependent signal route a prediction of at least one of a node speed or a node speed change (by operation 1435, e.g.) or of a node heading or a node heading change (by operation 1437, e.g.). Certain embodiments of the node 140 can use one or more of these items of information to predict a node speed change from which to determine at least part of the route 180.

In lieu of any of receiving operations 1431, 1435, and 1437, node 140 can instead receive a zone identifier from outside the node-speed-change-prediction-dependent signal route (such as the route 180, by operation 1439, e.g.). For example, node 140 can receive the zone identifier as an indication of where node 154 will be at a given moment, based on a speed change prediction. Node 140 can use this zone identifier in determining to append channel 150 in lieu of channel 160 (by operation 330, e.g.).

In combination with any of the above-described variants of operation 330, the routing operation 350 can also comprise operation 1451 or operation 1453. Operation 1451 comprises including at least a data ownership indication in the wireless data. This may not be limited to a copyright notice but can also be an anonymous indication that the data is proprietary. Certain embodiments of the operation 1453 can include at least a destination indication in the wireless data. For example, the destination indication can include an identifiable geographic zone, an identifiable destination network, or a particular identifiable node or entity.

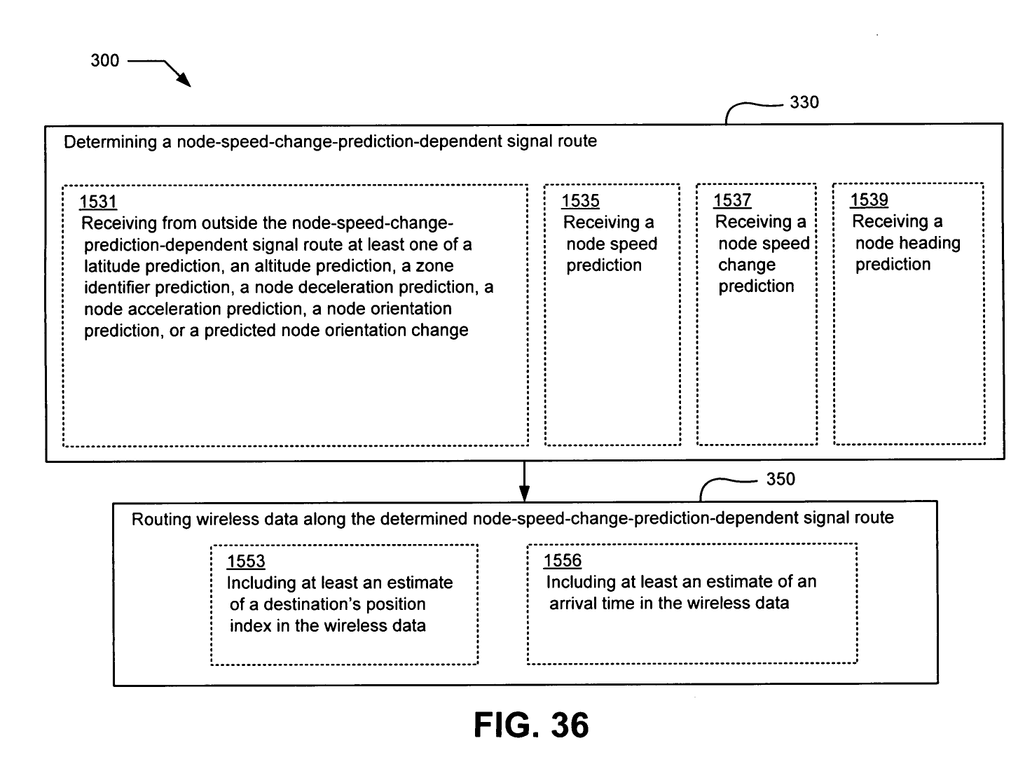

FIG. 36 shows several further illustrative variants and optional features of flow chart 300 of FIGS. 24, 34, and 35. For example, the operation 330 of the flow chart 300 can include one or more of operation 1531, operation 1535, operation 1537, or operation 1539. Certain embodiments of the operation 1531 can include, but does not limited to: receiving from outside the node-speed-change-prediction-dependent signal route at least one of a latitude prediction, an altitude prediction, a zone identifier prediction, a node deceleration prediction, a node acceleration prediction, a node orientation prediction, or a predicted node orientation change. For example, certain embodiments of the received information can include a description of a node that can be a candidate for addition to the node-speed-change-prediction-dependent signal route. Similarly, certain embodiments of the determining operation 330 can include receiving a node speed prediction (by operation 1535, e.g.), receiving a node speed change prediction (by operation 1537, e.g.), or receiving a node heading prediction (by operation 1539, e.g.).

Alternatively or in combination with any of the above-described variants of operation 330 or operation 350, certain embodiments of the routing operation 350 can further comprise including at least an estimate of a destination's position index (by operation 1553, e.g.) or including at least an estimate of an arrival time (by operation 1556, e.g.) in, for example, the wireless data. For example, the position index can include an altitude, a set of coordinates, or an offset distance from some reference point. In certain embodiments, the arrival time may not bge limited exclusively to an arrival time of a signal, but can alternatively be describe as a planned or otherwise approximate arrival of one or more nodes or other physical objects.

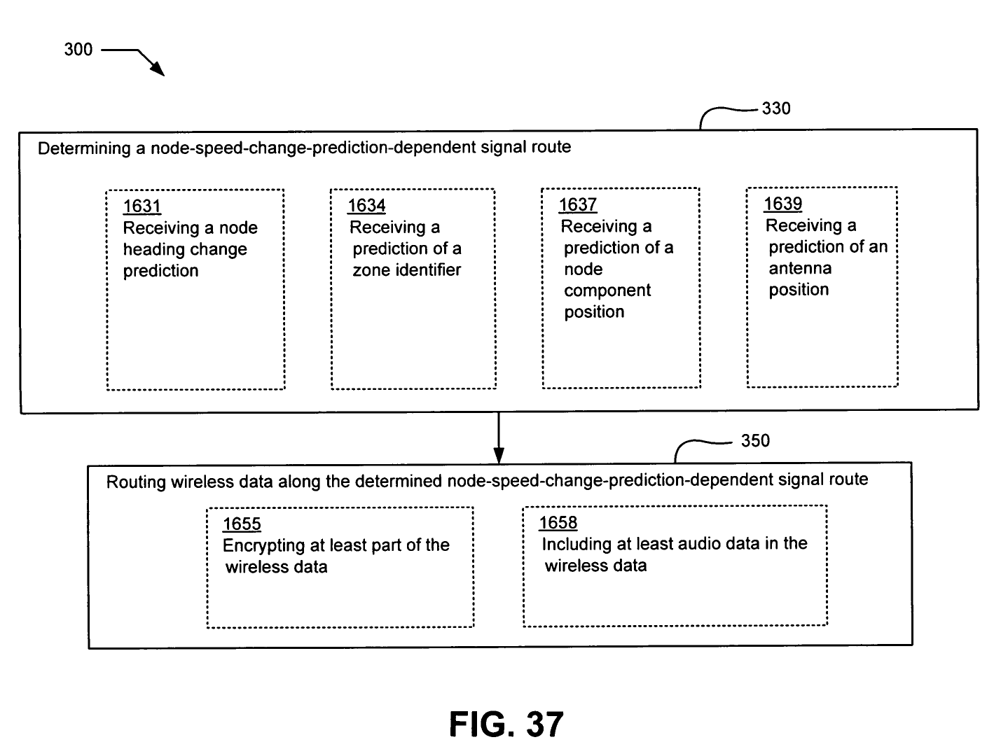

Certain embodiments of the flow chart 300 can be modified, such as to affect the operation of the vehicle 11, as described with respect to FIG. 29. Referring now to FIG. 37, for example, there are shown several further variants and optional features of flow chart 300 as described with respect to FIGS. 24, 34, 35, or 36. For example, one embodiment of the operation 330 of the flow chart 300 can include one or more of operation 1631, operation 1634, operation 1637, or operation 1639. The operation 350 can similarly include one or more of operation 1655 or operation 1658.

For example, referring again to FIG. 22, node 154 can receive a node heading change prediction (by operation 1631, e.g.) or receive a prediction of a zone identifier (by operation 1634, e.g.) that node 154 uses for position or velocity prediction (by operation 330, e.g.). For example, node 154 can be a stationary node that receives one or more predictions bearing upon the availability and suitability of a mobile node, which can be node 156. Certain embodiments of the node 154 can use the one or more predictions to determine the route 180, which route 180 can be amended to include channel 150. Certain embodiments of the node 154 can respond by transmission of wireless information, signals, data, etc. (by operation 350, e.g.), and optionally by encrypting at least part of the wireless data (by operation 1655, e.g.) before completing the routing operation 350.

In another example, the node 156 can receive a prediction of an directional antenna position (by operation 1639, e.g.) or another node component position (by operation 1637, e.g.) in performing the determining operation 330. Certain embodiments of the node 156 can receive a prediction that a component of the node 190 will be in a given position enabling transmission through node 156 at a given time. Cerain embodiments of the node 156 can use this prediction in responding to a routing request broadcast indicating that node 140 has a message for node 197. Certain embodiments of the node 156 can determine a node-speed-change-prediction-dependent signal route (by operation 330, e.g.) at least to the node 190 and route wireless data along the route (by operation 350, e.g.) by transmitting the route to the node 140.

In another example in which the node 140 may be a source node, certain embodiments of the node 140 can perform one of the above-described variants of flow chart 300 in which the routing operation 350 can comprise at least audio data in the wireless data (by operation 1658, e.g.). Audio data can be included by operation 1658, and his not limited to telephonic data but can also include music, speech, or other recordings or artificial sounds. The audio data may be optionally encrypted by node 140 also, such as by operation 1655.

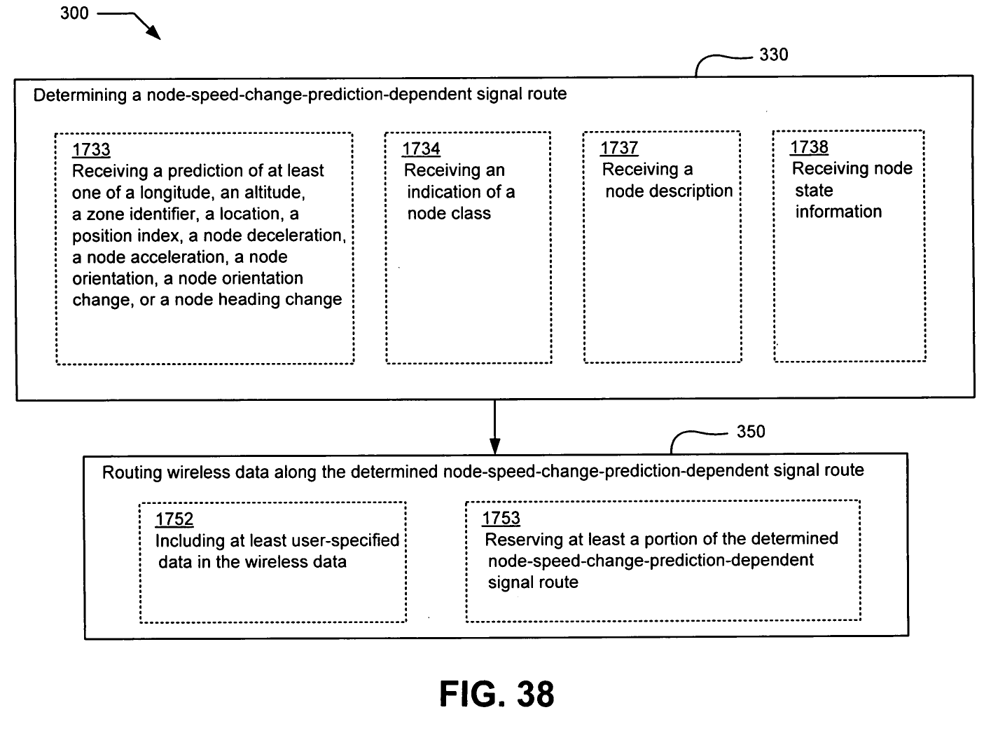

Referring now to FIG. 38, there are shown several further variants and optional features of flow chart 300 of FIG. 24, 34, 35, 36, or 37. For example, one embodiment of the operation 330 of the flow chart 300 can include one or more of operation 1733, operation 1734, operation 1737, or operation 1738. Certain embodiments of the operation 350 can similarly include one or more of operation 1752 or operation 1753. Certain embodiments of the operation 1733 can include receiving a prediction of at least one of a longitude, an altitude, a zone identifier, a location, a position index, a node deceleration, a node acceleration, a node orientation, a node orientation change, or a node heading change. For example, certain embodiments of the source node 212 of FIG. 22 can receive any or all of these in describing mobile node 240. Certain embodiments of the node 212 can use this information in the determining operation 330, and thereupon respond by performing the routing operation 350. Optionally the routing operation 350 can comprise including at least user-specified data in the wireless data (e.g., by operation 1752). Certain embodiments of the routing operation 350 can also include routing one or more types of information or data that can describe one or more remote node (e.g., node 240) to another remote node (e.g., one that includes module 225).

In one example, certain embodiments of the network subsystem 220 can receive a node description (e.g., by operation 1737) in performing the determining operation 330. For example, network subsystem 220 can receive an indication of a node class (e.g, by operation 1734) or can receive node state information (by operation 1738, e.g.) from source node 212. Certain embodiments of the network subsystem 220 can complete the determining operation 330 by determining to route data along a signal route to the mobile node 240. Optionally, certain embodiments of the network subsystem 220 can reserve at least a portion of the determined node-speed-change-prediction-dependent signal route (by operation 350 and including operation 1753, e.g.).

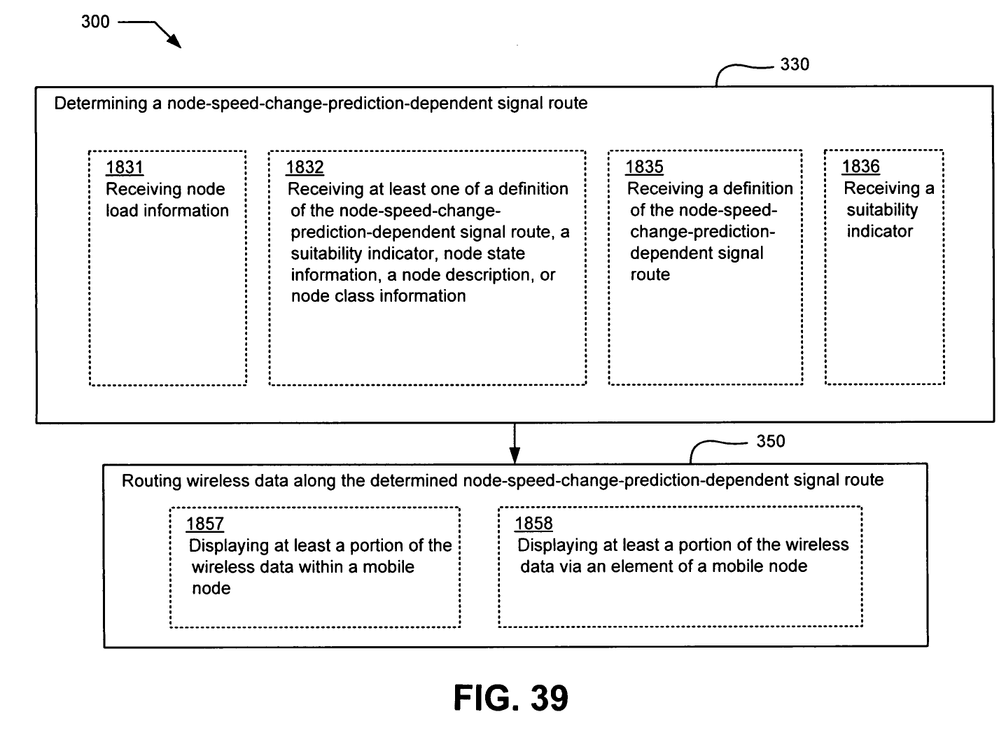

FIG. 39 shows certain embodiments of further variants and optional features of flow chart 300, e.g., of FIG. 24, 34, 35, 36, 37, or 38. For example, certain embodiments of the operation 330 of the flow chart 300 can include one or more of operation 1831, operation 1832, operation 1835, or operation 1836. Certain embodiments of the operation 350 can similarly include one or more operations 1857 and/or 1858. For example, certain embodiments of the module 1150 of FIG. 32 can perform any of these variants of the determining operation 330, including receiving node load information 1831, receiving a definition of the node-speed-change-prediction-dependent signal route 1835, or receiving a suitability indicator 1836. Alternatively or additionally, module 1150 can receive at least one of a definition of the node-speed-change-prediction-dependent signal route, a suitability indicator, node state information, a node description, or node class information 1832.

Certain embodiments of the circuitry 1170 can route wireless data along the signal route determined by the module 1150, such as via a route through mobile node 1181 to tower 1183. Certain embodiments of the circuitry 1170 can also perform operation 1857 by displaying at least a portion of the wireless data within a mobile node (within the subsystem 1100, which may be the vehicle 11, e.g., via medium 1172). If the network subsystem 1100 does not include a vehicle, in certain embodiments the circuitry 1170 can still display at least a portion of the wireless data via an element of a mobile node (by performing displaying operation 1858, e.g., via medium 1172).

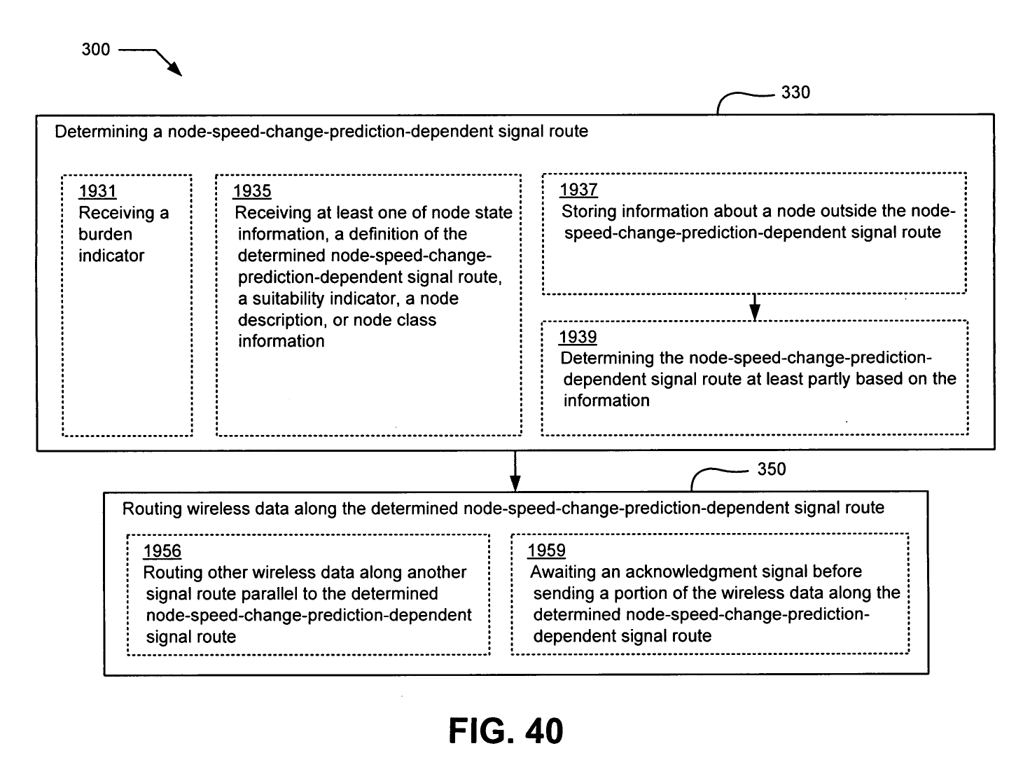

FIG. 40, there are further optional features defining variants of flow chart 300 of FIG. 24, 34, 35, 36, 37, 38, or 39. For example, the operation 330 of the flow chart 300 can include one or more of operation 1931, operation 1935, operation 1937, or operation 1939. For example, network subsystem 800 of FIG. 29 can perform many of these variants. Certain embodiments of the mobile directional antenna 10 or 14 can perform the operation 1931 of receiving a burden indicator, for example, optionally in combination with operation 1537 of receiving a node speed change prediction. Alternatively or additionally, certain embodiments of the mobile directional antenna 10 or 14 can perform the operation 1935 of receiving at least one of node state information, a definition of the determined node-speed-change-prediction-dependent signal route, a suitability indicator, a node description, or node class information.

Similarly, certain embodiments of the controller 834 can perform the operation 1937 of storing information about a node outside the node-speed-change-prediction-dependent signal route and the operation 1939 of determining the node-speed-change-prediction-dependent signal route at least partly based on the information. Certain embodiments of the controller 834 can receive and store node state information and other descriptions from or about nearby nodes, for example, in memory 838. In response to a route request, processor 837 can then use or provide the stored information for the determining operation 1937.

Optionally, the routing operation 350 can include one or more of operation 1956 or operation 1959. Certain embodiments of the communication network 830 can route other wireless data along another signal route parallel to the determined node-speed-change-prediction-dependent signal route (at operation 1956, e.g.). For example, system 830 can determine two or more parallel channels across which to spread received data, such as by code division or time division multiplexing. Alternatively or additionally, communication network 830 can await an acknowledgment signal before sending a portion of the wireless data along the determined node-speed-change-prediction-dependent signal routes (e.g., at operation 1959).

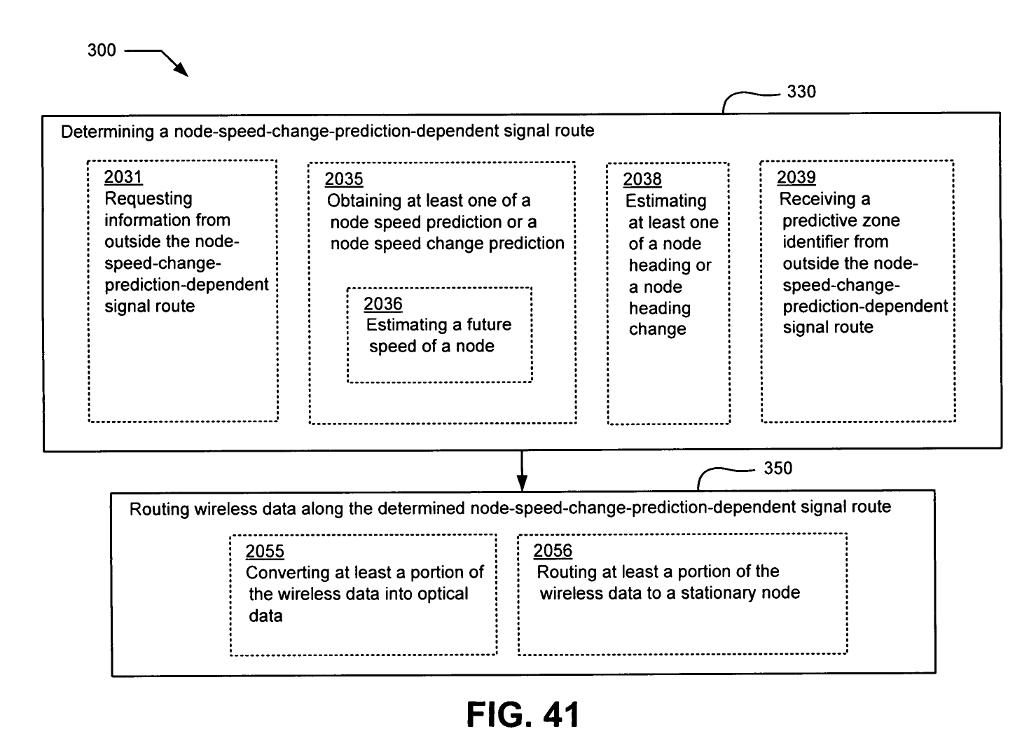

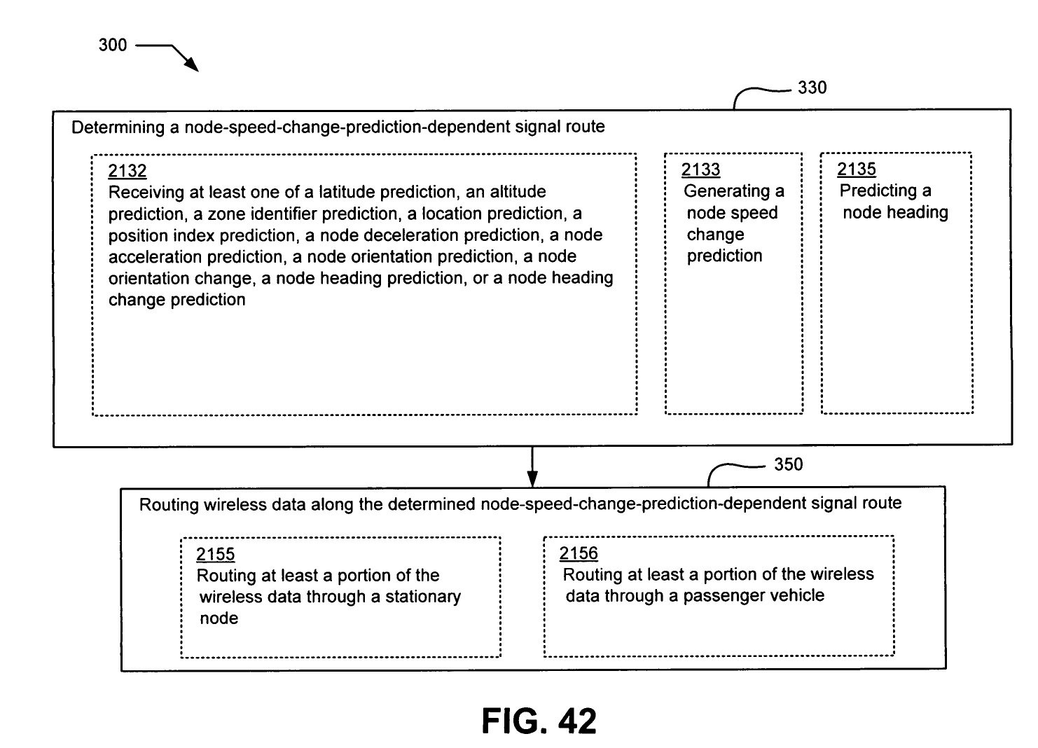

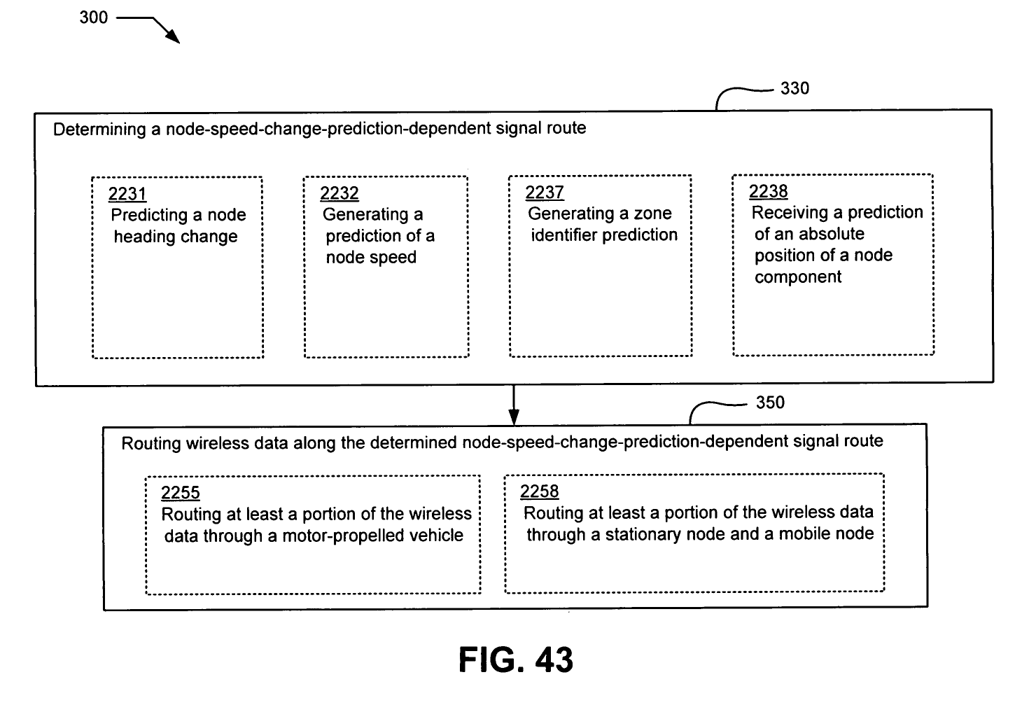

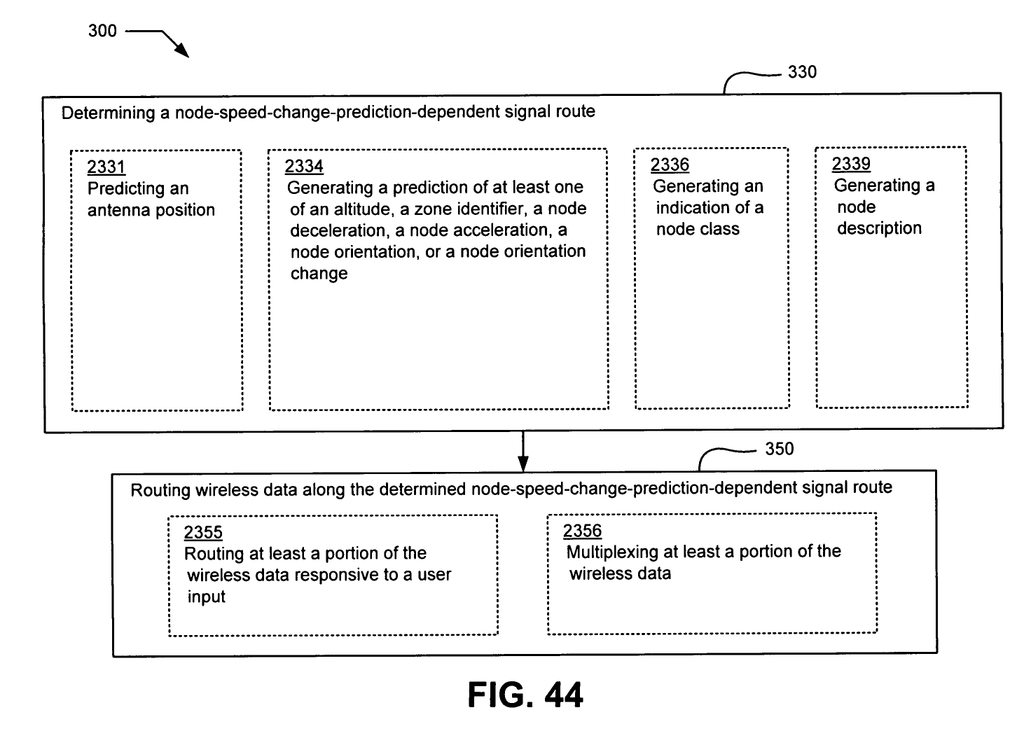

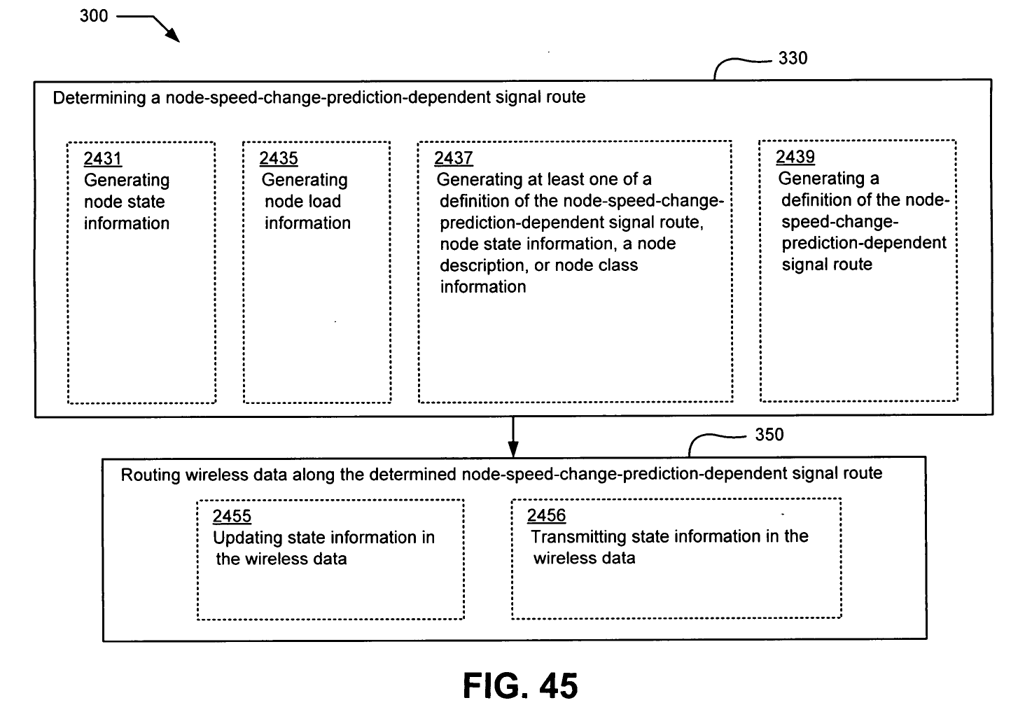

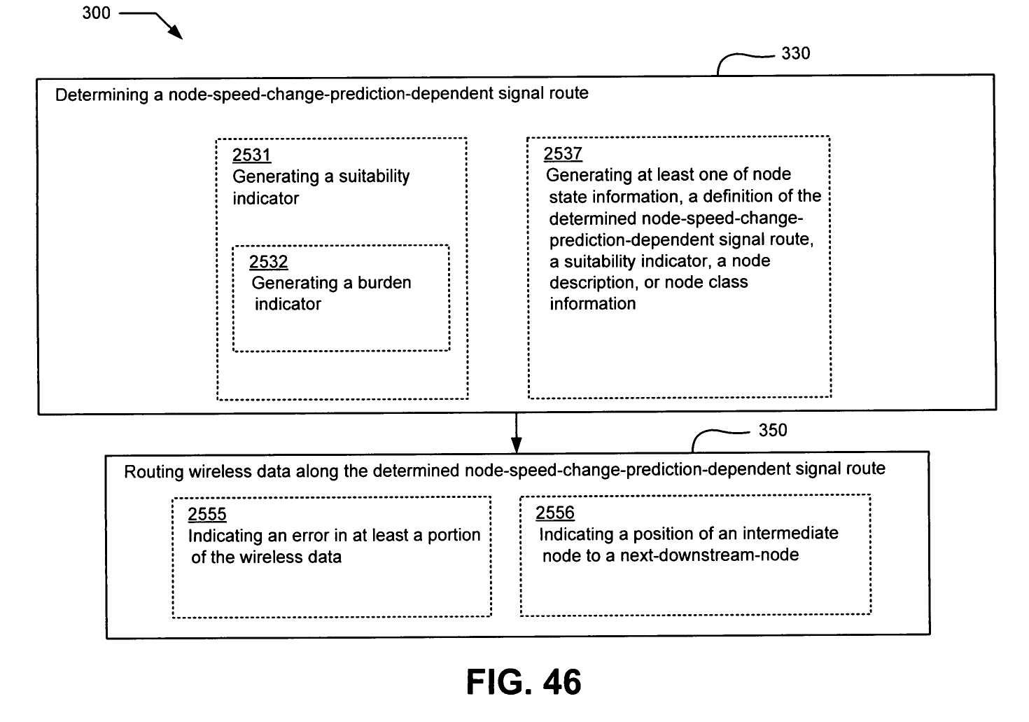

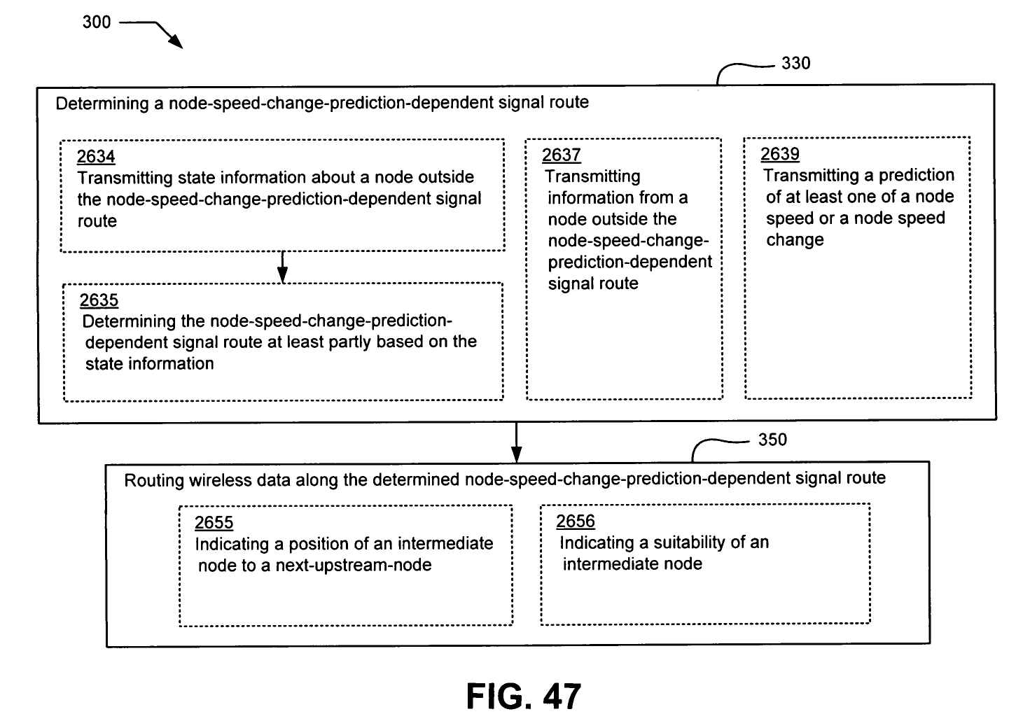

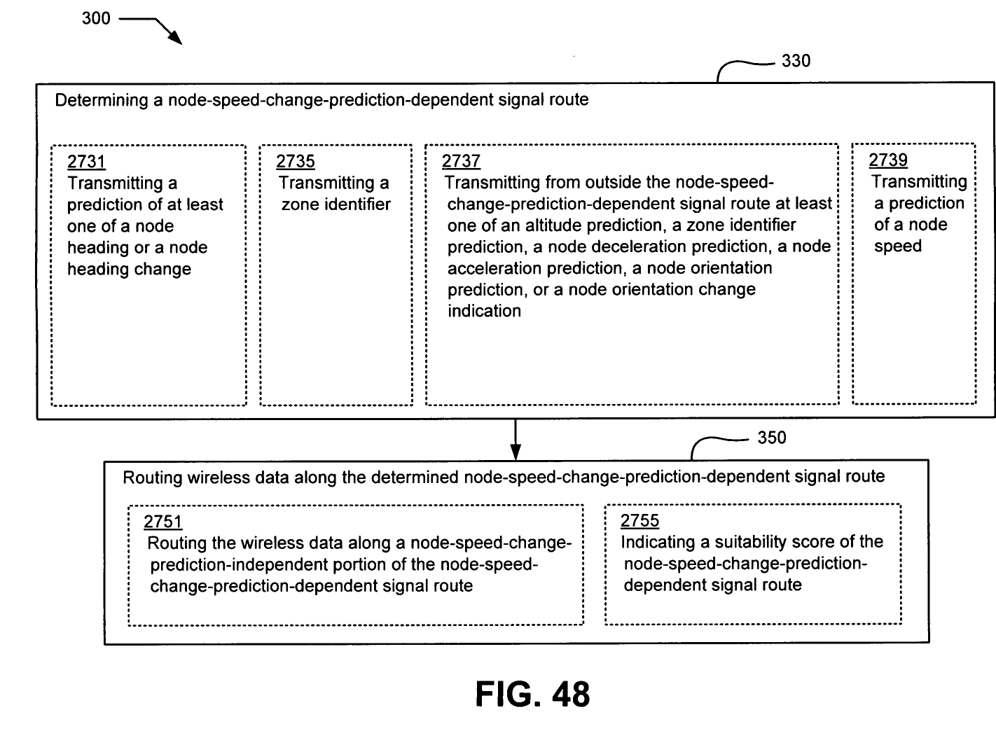

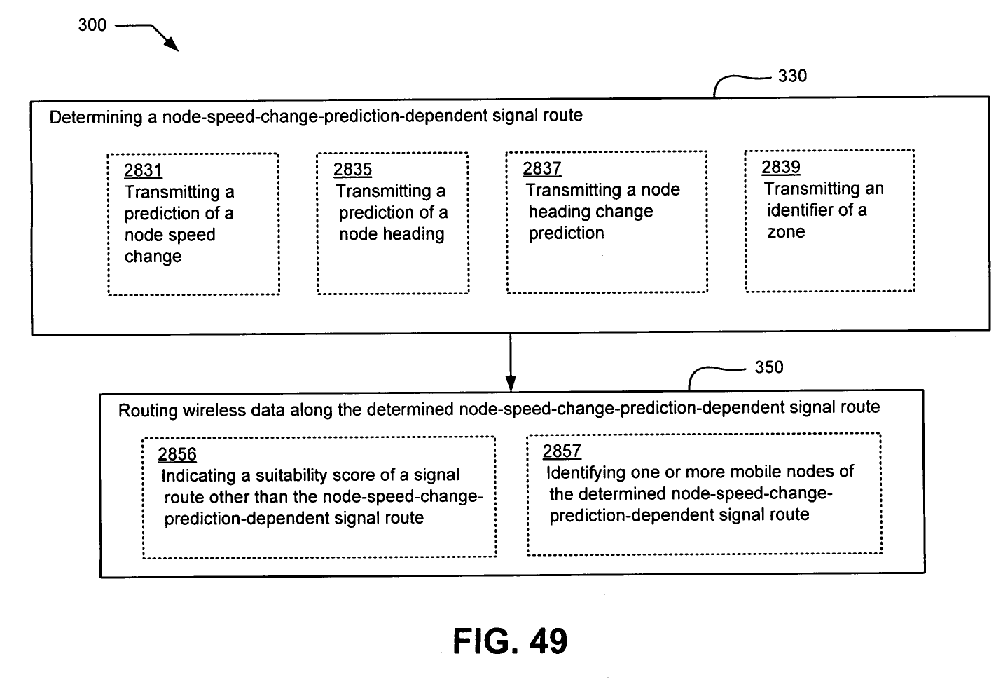

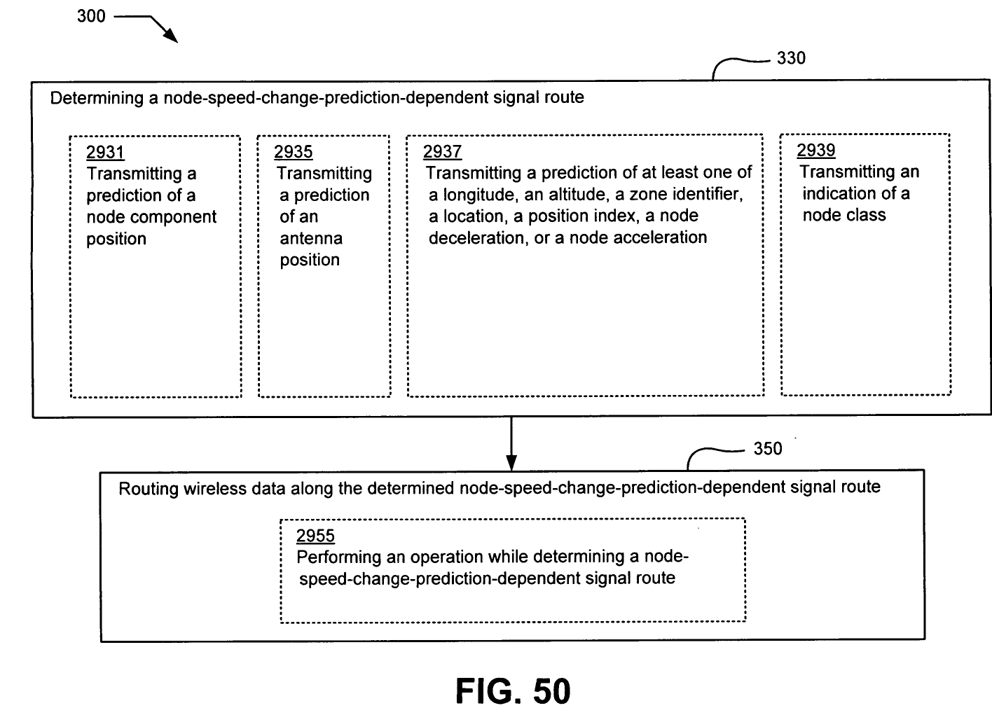

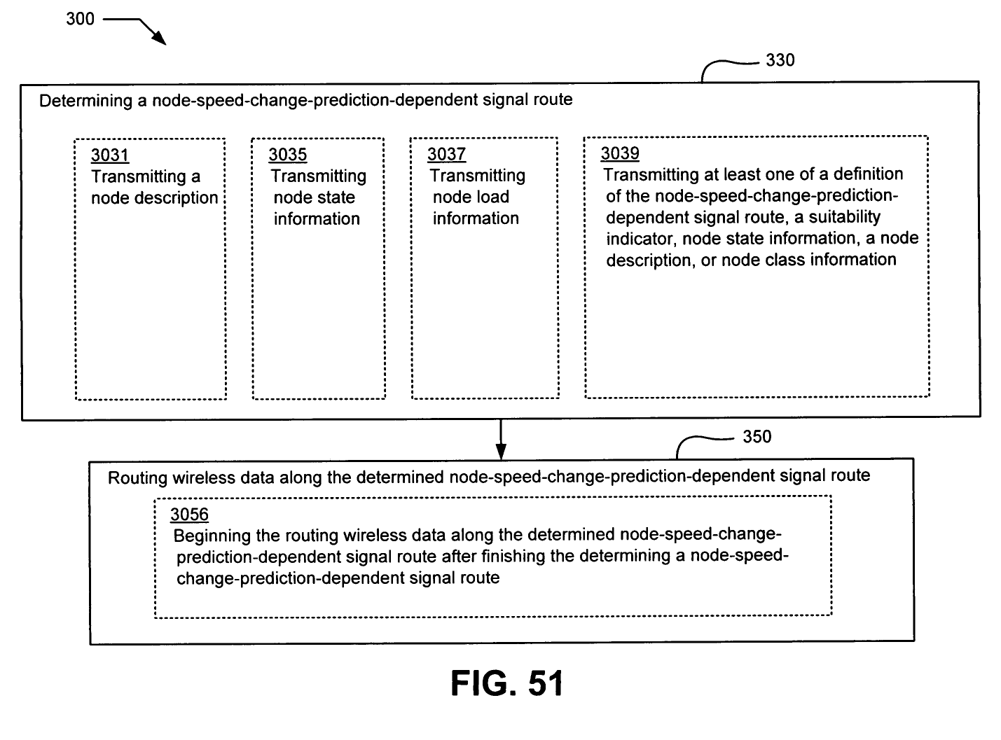

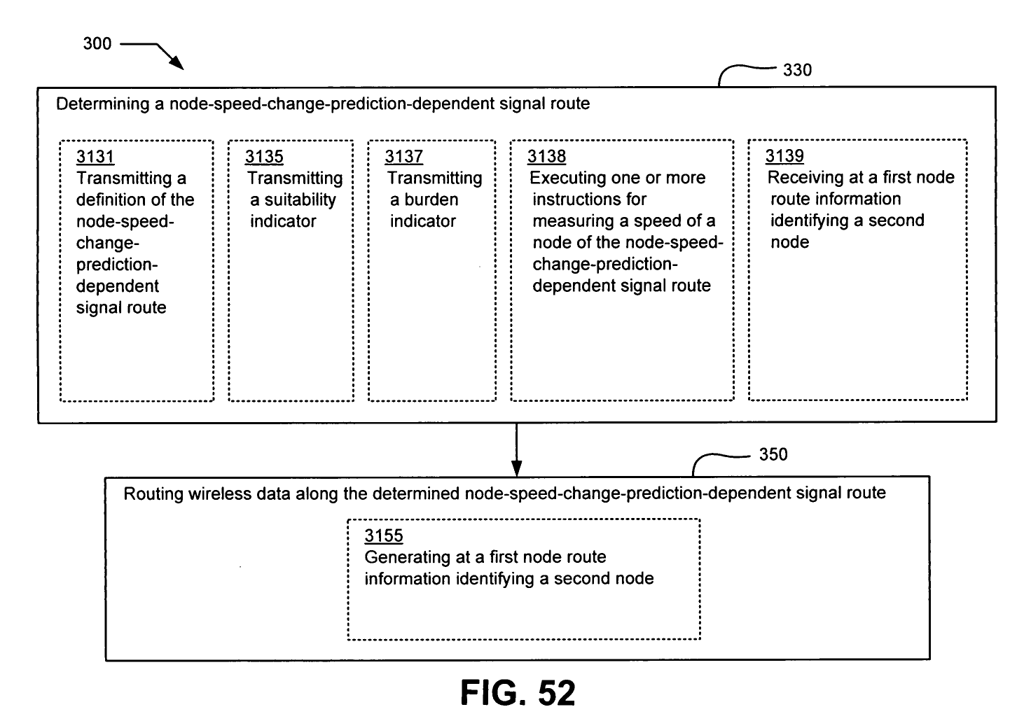

Referring now to FIG. 41, there are further optional features defining variants of flow chart 300 of FIG. 24, 34, 35, 36, 37, 38, 39, or 40. For example, the operation 330 of the flow chart can include one or more of operation 2031, operation 2035, operation 2036, operation 2038, or operation 2039. For example, node 140 of FIG. 22 can be configured as a device 600 that includes a signal bearing medium 650 containing instructions 653. The one or more instructions for performing determining operation 330 can enable node 140 to request information from outside the node-speed-change-prediction-dependent signal route (at operation 2031, e.g.) in performing flow chart 300. Node 140 can poll all nodes within a direct-transmission zone of node 140 for a route table, for example, which includes information about a plurality of channels not yet on a given signal's defined route. These channels can include channel 150, channel 160, and channel 162, for example. Node 140 can use this information in determining the route 180, such as by appending channel 150 to whatever route through which node 140 receives the data.

Node 140 can also perform operation 2035 of obtaining at least one of a node speed prediction or a node speed change prediction, optionally by operation 2036 of estimating a future speed of a node such as node 154. Node 140 can estimate at least one of a node heading or a node heading change 2038 (of node 154, e.g.). Alternatively or additionally, node 140 can perform operation 2039 of receiving a predictive zone identifier from outside the node-speed-change-prediction-dependent signal route. For example, node 140 can receive from node 156 a predictive or other zone identifier describing a past or future location of node 156, and use this information in determining the node-speed-change-prediction-dependent signal route through channel 150. Optionally, the full signal route definition (i.e. all the way from a source node) can be included in a transmission sent to node 154 and node 156.

Optionally, the same network subsystem that performs the determining operation 330 can perform one or both of operation 2055 or operation 2056. Operation 2055 includes converting at least a portion of the wireless data into optical data. For example, in an embodiment in which linkage 195 includes a fiberoptic or other optical communication link, node 190 of the subsystem 110 can perform the converting operation 2055. Node 190 can also perform flow chart 300, alternatively or additionally, by routing at least a portion of the wireless data to a stationary node (to node 197 by operation 2056, e.g.).

Some variants of flow chart 300 can be performed by controller 170, including many that incorporate one or more of executing operation 3138, receiving operation 3139, or generating operation 3155. Executing operation 3138 can be performed by executing one or more instructions for measuring a speed of a node of the node-speed-change-prediction-dependent signal route. For example, the controller 170 can be configured as a device 600, including signal bearing medium 650 containing “one or more instructions for performing determining operation 330” of the instructions 653. The instructions 653 can further include the “one or more instructions for measuring a speed” for execution at operation 3138. Receiving operation 3139 includes receiving at a first node (such as node 140, e.g.) route information identifying a second node (such as a downstream node 154 or an upstream node 133, e.g.). Generating operation 3155 (of routing operation 350) can include generating at a first node (such as node 140, e.g.) route information identifying a second node (such as a node list including node 154 and node 156).

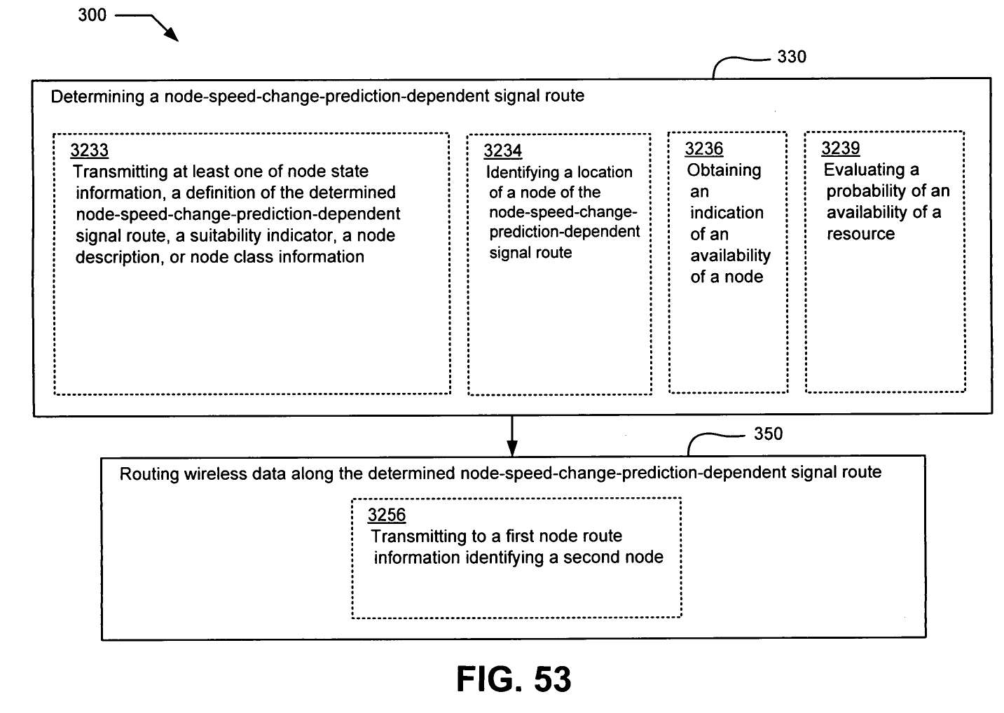

Referring now to FIG. 53, there are further optional features relating to flow chart 300 and its multiple variant flow charts as describe above. For example, the operation 330 can include one or more of operation 3233, operation 3234, operation 3236, or operation 3239. Likewise the routing operation 350 can include a transmitting operation 3256. Any of these optional features can optionally be performed by network subsystem 110 performing flow chart 300. Module 1150 optionally transmits at least one of node state information, a definition of the determined node-speed-change-prediction-dependent signal route, a suitability indicator, a node description, or node class information (by operation 3233). Alternatively or additionally, module 1150 can perform one or more of operation 3239 of evaluating a probability of an availability of a resource or operation 3236 of obtaining an indication of an availability of a node. Module 1150 can optionally be configured to include a signal-bearing medium (such as memory 1159) bearing one or more instructions (such as instructions 653, e.g.) for identifying a location of a node (such as node 1181, e.g.) of the node-speed-change-prediction-dependent signal route (by operation 3234, e.g.). Certain embodiments of the circuitry 1170 can perform operation 3256 of transmitting to a first node route information identifying a second node.

Certain embodiments of the directional antenna 10 or 14 can also broadcasting at least the portion of the signal, data, or information. Including operation 3356 comprises including at least a message length value in a first portion of the signal, data, or information. Certain embodiments of the information used in transmitting or receiving digital signals or data can also include at least a message length value in a header of the signal, data, or information. The travel time can describe a movement of a signal or data set, or a movement to a physical object or system, for example. One or more intermediate nodes can use the estimate in making a routing decision, such as by module 1150 determining the signal route dependent on a destination-node-movement speed.

Certain operation can include transmitting state information with the data or transmitting the data via a free space medium. Certain embodiments of the operations can optionally perform a retry operation, such as by using a different or compound route.

There are shown several additional variants of flow. For example, module 1150 of FIG. 32 can optionally perform operation by which a processor can optionally update state information in the data, indicate a position of an intermediate node to a next-upstream-node, and/or broadcast the load indicator, for example. Certain embodiments of the operation can display at least an indication of the data at the mobile node. Alternatively, certain embodiments of the flow chart can perform the operation of streaming at least a portion of the data.

Alternatively or additionally, certain embodiments of the node can perform one or more operation of indicating a suitability of a signal route (optionally including a suitability of route using an intermediate node). Certain embodiments of the operation can utilize received latitude and/or longitude of the mobile node as position information.

Alternatively or additionally, the node can perform one or more of operation of including at least a destination position index in the data, and/or encrypting at least a portion of the data. Certain embodiments of the operation can include reserving a route. Certain embodiments of the operation can include displaying at least a portion of the data via an element of a mobile node. Certain embodiments of the operation can include awaiting an acknowledgment signal before sending a portion of the data.

Certain embodiments of the operation can include converting at least a portion of the data into an optical signal, which might be expedient if, for example, linkage 195 includes a long haul fiberoptic conduit. Certain embodiments of the operation can include multiplexing at least a portion of the data.

Referring again to FIG. 33, in an alternate embodiment, computer program product 1220 can be configured to include a recordable medium 1246 as the signal-bearing medium 650 of FIG. 27. More particularly the recordable medium 1246 can contain instructions 654 including one or more instructions for performing routing operation 450. The one or more included instructions can optionally comprise: one ore more instructions for performing one or more operations of operations 4251 through 4458. One embodiment, for example, may include a computer program product (product 1220, e.g.) comprising a signal-bearing medium (medium 650, e.g.) bearing at least one of: one or more instructions; and one or more instructions for streaming at least a portion of the data.

VI. Conclusion

Those having skill in the art will recognize that the state of the art has progressed to the point where there may be little distinction left between hardware and software implementations of aspects of systems; the use of hardware or software may generally (but not always, in that in certain contexts the choice between hardware and software can become significant) represent a design choice representing cost vs. efficiency tradeoffs. Those having skill in the art will appreciate that there are various vehicle(s) 11 by which processes and/or systems and/or other technologies described herein can be effected (e.g., hardware, software, and/or firmware), and that the vehicle might vary with the context in which the processes and/or systems and/or other technologies are deployed. For example, if an implementer determines that speed and accuracy are paramount, the implementer may opt for a mainly hardware and/or firmware implementation; alternatively, if flexibility may be a consideration, the implementer may opt for a mainly software implementation; or, yet again alternatively, the implementer may opt for some combination of hardware, software, and/or firmware. Hence, there are several possible vehicles and/or antennas by which the processes and/or devices and/or other technologies described herein may be effected, none of which may be preferred to the other in that the vehicle 11 to be utilized may be a choice dependent upon the context in which the vehicle and/or antennas will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Moreover, “can” and “optionally” and other permissive terms are used herein for describing optional features of various embodiments. These terms likewise describe selectable or configurable features generally, unless the context dictates otherwise.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interactable and/or logically interacting components.

While certain features of the described implementations have been illustrated as disclosed herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
adjusting a directional antenna from a first state to a second state to improve a network operation of the directional antenna relative to a mobile node to at least partially compensate for motion of the mobile node.

2. The method of claim 1, wherein the adjusting a directional antenna from a first state to a second state to improve a network operation of the directional antenna relative to a mobile node to at least partially compensate for motion of the mobile node comprises:
adjusting a direction of the directional antenna from the first state to the second state in an attempt to improve the network operation of the directional antenna relative to the mobile node.

3. The method of claim 1, wherein the adjusting a directional antenna from a first state to a second state to improve a network operation of the directional antenna relative to a mobile node to at least partially compensate for motion of the mobile node comprises:
adjusting a power of the directional antenna from the first state to the second state to improve the network operation of the directional antenna relative to the mobile node.

4. The method of claim 1, wherein the adjusting a directional antenna from a first state to a second state to improve a network operation of the directional antenna relative to a mobile node to at least partially compensate for motion of the mobile node comprises:
adjusting the directional antenna from the first state to the second state to improve a communication ability of the directional antenna relative to the mobile node.

5. The method of claim 1, wherein the adjusting a directional antenna from a first state to a second state to improve a network operation of the directional antenna relative to a mobile node to at least partially compensate for motion of the mobile node comprises:
adjusting the directional antenna from the first state to the second state to improve a S/N Ratio of the directional antenna relative to the mobile node.

6. The method of claim 1, wherein the adjusting a directional antenna from a first state to a second state to improve a network operation of the directional antenna relative to a mobile node to at least partially compensate for motion of the mobile node comprises:
adjusting the directional antenna from the first state to the second state to improve the network operation of the directional antenna relative to the mobile node at least partially considering a position of the mobile node.

7. The method of claim 1, wherein the adjusting a directional antenna from a first state to a second state to improve a network operation of the directional antenna relative to a mobile node to at least partially compensate for motion of the mobile node comprises:
adjusting the directional antenna from the first state to the second state to improve the network operation of the directional antenna relative to the mobile node at least partially considering a movement of the mobile node.

8. The method of claim 1, wherein the adjusting a directional antenna from a first state to a second state to improve a network operation of the directional antenna relative to a mobile node to at least partially compensate for motion of the mobile node comprises:
adjusting the directional antenna from the first state to the second state towards a target state of the directional antenna.

9. The method of claim 1, wherein the directional antenna is secured relative to an at least one other mobile node.

10. The method of claim 1, wherein the directional antenna is secured relative to an at least one other mobile node, and a vehicle at least partially includes the at least one other mobile node.

11. The method of claim 1, wherein a vehicle at least partially includes the mobile node.

12. A method, comprising.
identifying a network operational characteristic;
determining a desired directional antenna configuration to direct a directional antenna at least partially with respect to a first mobile node at least partially according to the network operational characteristic; and
establishing a directional antenna directionality at least partially according to a desired directional antenna direction.

13. The method of claim 12, wherein the identifying a network operational characteristic comprises:
identifying a network transmission parameter.

14. The method of claim 12, wherein the identifying a network operational characteristic comprises:
determining a signal strength.

15. The method of claim 12, wherein the identifying a network operational characteristic comprises:
determining a signal to noise ratio.

16. The method of claim 12, wherein the identifying a network operational characteristic comprises:
determining the network operational characteristic; and
predicting a maximum value of the network operational characteristic.

17. The method of claim 12, wherein the identifying a network operational characteristic comprises:
determining an orientation or position of the first mobile node relative to a fixed node.

18. The method of claim 12, wherein the identifying a network operational characteristic comprises:
determining an orientation or position of the first mobile node relative to a second mobile node.

19. The method of claim 12, wherein the determining a desired directional antenna configuration to direct a directional antenna at least partially with respect to a first mobile node at least partially according to the network operational characteristic comprises:
determining the desired directional antenna direction of the directional antenna at least partially corresponding to a predicted maximum of a transmission parameter.

20. The method of claim 12, wherein the establishing a directional antenna directionality at least partially according to a desired directional antenna direction comprises:
physically repositioning or reorienting the directional antenna at least partially according to the desired directional antenna direction.

21. The method of claim 12, wherein the establishing a directional antenna directionality at least partially according to a desired directional antenna direction comprises:
activating a micro electomechanical system (MEMS) device.

22. The method of claim 12, wherein the establishing a directional antenna directionality at least partially according to a desired directional antenna direction comprises:
altering relative phases or amplitudes of signals at selected components of the directional antenna.

23. The method of claim 12, wherein the establishing a directional antenna directionality at least partially according to a desired directional antenna direction comprises:
optimizing the directional antenna directionality.

24. The method of claim 12, wherein the desired directional antenna configuration is at least partially provided for an active directional antenna.

25. The method of claim 12, wherein the desired directional antenna configuration is at least partially provided for a passive directional antenna.

26. The method of claim 12, wherein the desired directional antenna configuration is at least partially provided for a patch directional antenna.

27. A method, comprising:
directing a directionality of a directional antenna that is at least partially associated with a mobile node from a first position to a second position, in an attempt to achieve a target position by which a network operational characteristic of a communication between the mobile node to at least a node can be improved.

28. The method of claim 27, comprising:
identifying the network operational characteristic, wherein the directing the directionality of the directional antenna can be performed at least partially according to identifying the network operational characteristic.

29. The method of claim 28, wherein the identifying the network operational characteristic further comprises:
identifying a network transmission parameter.

30. The method of claim 27, wherein the directing a directionality of a directional antenna further comprises:
directing a network transmission parameter.

31. The method of claim 27, wherein the directing a directionality of a directional antenna further comprises:
directing the directionality of the directional antenna based at least partially on feedback.

32. The method of claim 27, wherein the directing a directionality of a directional antenna further comprises:
directing the directionality of the directional antenna based at least partially on discovery.

33. The method of claim 27, wherein the directing a directionality of a directional antenna further comprises:
directing the directionality of the directional antenna based on a position information.

34. The method of claim 27, wherein the directing a directionality of a directional antenna further comprises:
directing the directionality of the directional antenna based on a position information as indicating a roadway structure or direction.

35. The method of claim 27, wherein the directing a directionality of a directional antenna further comprises:
directing the directionality of a receiving directional antenna.

36. The method of claim 27, wherein the directing a directionality of a directional antenna further comprises:
directing the directionality of a transmitting directional antenna.

37. The method of claim 27, wherein the directing a directionality of a directional antenna further comprises:
directing the directionality of a transceiving directional antenna.

38. A method, comprising:
directing a directionality of a directional antenna that is at least partially associated with a first mobile node from a first position to a second position, in an attempt to achieve a target position by which a network operational characteristic of at least one communication between the first mobile node to a second mobile node can be improved.

39. The method of claim 38, comprising:
identifying the network operational characteristic, wherein the directing the directionality of the directional antenna can be performed at least partially according to identifying the network operational characteristic.

40. The method of claim 38, wherein the directing a directionality of a directional antenna further comprises:
directing the directionality of the directional antenna based at least partially on feedback.

41. The method of claim 38, wherein the directing a directionality of a directional antenna further comprises:
directing the directionality of the directional antenna based at least partially on discovery.

42. The method of claim 38, wherein the directing a directionality of a directional antenna further comprises:
directing the directionality of the directional antenna based on a position information.

43. The method of claim 38, wherein the directing a directionality of a directional antenna further comprises:
directing the directionality of the directional antenna based on a position information as indicating a roadway structure or direction.

44. The method of claim 38, wherein the directing a directionality of a directional antenna further comprises:
directing the directionality of a receiving directional antenna.

45. The method of claim 38, wherein the directing a directionality of a directional antenna further comprises:
directing the directionality of a transmitting directional antenna.

46. The method of claim 38, wherein the directing a directionality of a directional antenna further comprises:
directing the directionality of a transceiving directional antenna.

47. An apparatus comprising:
at least one mobile node that includes a directional antenna, wherein the directional antenna is operable to be adjusted to improve a network operation of the directional antenna relative to the mobile node by at least partially compensating for motion of the mobile node.

48. An apparatus comprising:
at least one first mobile node that includes a directional antenna, wherein the directional antenna is operable to be adjusted to improve a network operation of the directional antenna relative to an at least one second mobile node by at least partially compensating for motion of the at least one second mobile node.
